(19) United States
(12) Patent Application Publication
(10) Pub. No.: US 2004/0183769 A1
(43) Pub. Date: Sep. 23, 2004

(54) Graphics digitizer

(76) Inventors: Earl Schreyer, Encinita, CA (US); Ken Martin, Toronto (CA); David Johns, Toronto (CA); Raymond Chik, Richmond Hill (CA); Doug Moran, Carlsbad, CA (US)

Correspondence Address: Philip W. Woo, c/o SIDLEY AUSTIN BROWN & WOOD LLP, 555 CALIFORNIA STREET, SUITE 5000, SAN FRANCISCO, CA, 94104-1715, US

(21) Appl. No.: 10/807,525

(22) Filed: Mar. 23, 2004

Related U.S. Application Data
(63) Continuation of application No. 09/658,707, filed on Sep. 8, 2000, now abandoned.

(51) Int. Cl. G09G 3/36

(52) U.S. Cl. 345/99

(57) ABSTRACT

A graphics digitizer having a phase-locked-loop, a timing generator, and at least one channel with a reference and bias voltage generator and an analog-to-digital converter is disclosed. In some embodiments, the phase-locked-loop includes a programmable Div/N circuit so that the output frequency of the signal generated by the phase-locked-loop is programmable. In some embodiments, the timing generator generates a HSOUT video signal in response to the HSYNC video signal by sampling the HSYNC video signal with a phase adaptively chosen in response to a programmable phase between the signal generated by the phase-locked-loop and the HSYNC video signal. In some embodiments of the invention the reference and bias voltage generates a reference voltage determined by a digital-to-analog conversion of a value stored in a programmable gain register and generates a bias voltage proportionally to the reference voltage by a current digital-to-analog conversion of a value stored in a programmable offset register. In some embodiments of the invention, the analog-to-digital converter includes a pre-amp bank which is offset canceled at the end of each line of video signal. In some embodiments of the invention, the analog-to-digital converter includes a pre-amp bank where individual pre-amps are offset canceled randomly with each clock cycle. In some embodiments of the invention, the analog-to-digital converter includes a folding and interpolating circuit having a first folder and a second folder with the first folder utilizing voltage averaging as well as resistive interpolation in order to reduce offsets while the second folder utilizes resistive interpolation. In some embodiments of the invention, the analog-to-digital converter includes a comparator bank where each comparator is followed by an RS latch. In some embodiments of the invention, the analog-to-digital converter includes a digital encoder where the most significant bits are determined by counting the number of a set of course comparator outputs which are at a first level and the least significant bit are determined by counting the number of a set of fine comparator outputs which are at a first level or at a second level, depending on the region of the range of the analog-to-digital converter. In some embodiments of the invention, the analog-to-digital converter includes a digital encoder having error correction. In some embodiments of the invention, the analog-to-digital converter includes a digital encoder having range correction.

A portion of the disclosure of this patent document contains material which is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### CROSS REFERENCE TO MICROFICHE APPENDIX

Appendix A, which is a part of the present disclosure, is a microfiche appendix consisting of 2 sheets of microfiche having 149 frames. Microfiche appendix A includes a circuit diagram for an implementation of a graphics digitizer according to aspects of the present invention.

This and other embodiments are further described below.

### BACKGROUND

1. Field of the Invention

The present invention relates to a graphics digitizer and, in particular, to a graphics digitizer circuit for interfacing analog video signals to a digital display unit such as a flat-panel display and, in particular, to a phase-locked-loop and an analog-to-digital converter that are applicable to a graphics digitizer.

2. Related Art

Many video applications may benefit from the use of flat panel digital displays. Display units are utilized in computer systems to display images and are also utilized in television and other monitoring applications. In many cases, a display unit receives analog input signals, for example in RGB format, and generates the image encoded in the analog input signals. A digital display unit is characterized by displaying the image encoded in the analog input signal on an array of pixels. Each pixel in the array of pixels is actuated to a degree determined by the analog input signal. In a colored digital display unit, each pixel in the array of pixels includes red emitters, green emitters and blue emitters. In RGB format, the red emitters are activated in response to a red analog input signal, the green emitters are activated in response to a green analog input signal, and the blue emitters are activated in response to a blue analog input signal. Typically, the analog input signals received by the display unit also includes control signals for indicating multiple frames and for indicating several lines in each frame. Each frame usually contains the display signals for one image to be displayed. The display unit refreshes the displayed image whenever a new frame of analog signals are received.

A typical display unit utilized with most systems, however, is an analog display unit that receives and processes the analog video signals output from the system (e.g., computer system) to which it is attached. Substitution of a digital display unit, for example a flat panel display, requires that the video signals be digitized. Therefore, a graphics digitizer having an analog-to-digital converter (ADC) is required. The analog RGB signals received by the ADC of the digital display unit must be fast enough to supply appropriate data to individual pixels of the digital display unit. For example, if the digital display unit has an active resolution of 1280 by 1024 pixels and the analog video signals (RGB signals) have a frame refresh rate of 60 Hz, the ADC, in some standards (e.g. with a horizontal sync frequency of 64 KHz and 1688 total pixels in a line) must digitize data at a sampling rate of about 108 MHz. If display 104 is of higher resolution or a higher refresh rate is desired, than a higher digital sampling rate may be needed. Unfortunately, high speed analog-to-digital converters are expensive.

Therefore, there is a need for fast, economical graphics digitizers for converting analog video signals to appropriate digital signals for a digital display unit. The graphics digitizer, in turn, requires fast and economical analog to digital converters for the required analog to digital conversion of the analog video signals. In addition, there is a need for a graphics digitizer capable of adjusting the sampling rate to that required by a particular digital display unit. Also, there is a need for a graphics digitizer that reliably provides video timing signals to a digital display unit.

### SUMMARY

Accordingly, a graphics digitizer for receiving an analog video signal and driving a digital display is presented. The graphics digitizer includes a separate channel for each analog input signal. In some embodiments of the invention, the graphics digitizer includes a red channel, a green channel, and a blue channel. Each channel of the graphics equalizer includes an analog-to-digital converter and a reference and bias voltage generator. Additionally, the graphics digitizer includes a phase-locked-loop which locks onto an HSYNC signal and generates a sampling clock signal. The graphics digitizer also includes a timing generation circuit which generates a horizontal sync output signal HSOUT which is phase shifted from the HSYNC signal to align with output timing signals of the graphics digitizer.

A phase-locked-loop according to some embodiments of the present invention includes a phase detector, a frequency generator, and a programmable Div/N block. The phase detector receives an HSYNC signal and a signal output from the Div/N block, compares the phase, and outputs a control signal to the frequency generator. The frequency generator, in response to the control signal and an inputted PHASE signal, outputs a sampling clock signal SCK. In some embodiments, the PHASE signal is externally programmable. The sampling clock signal SCK is input to the Div/N block which frequency divides the SCK signal by a factor N to provide the signal output from the Div/N block. The Div/N block receives a programmed digital value from a frequency register which controls the value N. As a result, the frequency of clock signal SCK is programmable through the frequency register. As such, clock signal SCK can be programmed for the horizontal resolution of a digital display unit which is coupled to the digital equalizer.

In some embodiments of the invention, the signal HSOUT is generated by the timing generation circuit sampling the HSYNC signal at an adaptively chosen phase indicated by a phase adaptation circuit. In some embodiments, the phase adaptation circuit determines the phase at which HSYNC is sampled in response to the externally programmed PHASE signal. As such, HSYNC is sampled with a phase that reduces jitter in HSOUT.

A reference voltage and bias generator is coupled to the analog-to-digital converter. In some embodiments of the invention, the reference voltage and bias generator includes a programmable gain register GR coupled to a digital-to-analog converter and a programmable offset register OSR coupled to a current digital-to-analog converter. The digital-to-analog converter converts the value stored in the gain register to an analog voltage reference signal V_{REF} which is proportional to a reference voltage V_{BG}. The reference voltage V_{REF} is input to current digital-to-analog converter which then generates a current signal I_{BIAS}+I_{OFFSET}, as indicated by the digital value stored in the offset register OSR, which is proportional to the reference voltage V_{REF}. The current signal I_{BIAS}+I_{OFFSET}, when passed through a resistor, supplies a bias voltage level to the analog-to-digital converter while the reference voltage V_{REF} provides a reference voltage to the analog-to-digital converter. Since the bias voltage V_{BIAS} is set proportionally to and less than the reference voltage V_{REF}, the possibility that the bias voltage input and the reference voltage input being so close together that an analog input to the analog-to-digital converter can not be adequately digitized is reduced. For example, if V_{REF} is 1.0 V and V_{BIAS} is set to ½, i.e. 0.5 V, then there is programmability above and below the bias level. If V_{REF} becomes 0.5 V peak-peak, then V_{Bias} is automatically set by this arrangement to 0.25 V.

The analog-to-digital converter includes a sample-and-hold circuit, a reference generator, a pre-amp bank, a course pre-amp, a folding and interpolating circuit, a comparator bank, and a digital encoder. In some embodiments of the invention, sample-and-hold circuit receives an analog input signal in one clock cycle and couples a differential input signal to the pre-amp bank in the next following clock cycle. The reference generator receives the reference voltage V_{REF} and generates a set of differential reference levels.

The pre-amp bank receives the set of differential reference levels from the reference generator and the differential input signal from the sample-and-hold circuit and outputs a set of differential output signals related to comparisons between the differential input signal and the set of differential reference signals. The differential output signals corresponding to differential reference signals well below the differential input signal will be saturated at one extreme and those corresponding to differential reference signals well above the differential input signal will be saturated at the opposite extreme. The differential output signals corresponding to differential reference voltages around the differential input signal will be at monotonically varying values intermediate between the two saturation extremes.

The pre-amp bank includes differential amplifiers which compare the differential input signal with each of the set of differential reference signals. These differential amplifiers are periodically offset canceled and reset (i.e. blanked) to a corresponding one of the set of differential reference signals. In some embodiments of the invention, the differential amplifiers are blanked at the end of each line of input video signal, which can be determined by the HSYNC signal. Blanking at the end of each line can be advantageous because any resulting flashing of video output will then occur outside of the visible portion of the video display. In other embodiments of the invention, the differential amplifiers are blanked in a random fashion. This embodiment can be better suited for non-video applications of an analog-to-digital converter according to the present invention. For example, the pre-amp bank can include a random number generator which determines which amplifier or group of amplifiers are blanked at any given sampling clock cycle. With a random blanking process, flashing is held at a minimum since there is no definable period between blankings for any given ampifier. In some embodiments, the output signals from the amplifiers are input to a multiplexer which outputs the differential output signals only from non-blanked amplifiers.

The set of differential output signals output from the pre-amp bank are input to folding and interpolation circuitry. The folding and interpolation circuitry folds the set of differential output signals, providing a set of folded signals. As the differential input signal is varied through the range of the analog-to-digital converter, each signal in the set of folded signals provides a number of zero crossings determined by the amount of folding. The areas of zero crossings define a set of regions in the valid range of differential input levels. The set of folded signals generated by the folding and interpolating circuit, by determining which of them are above zero and which are below zero, can be utilized to locate the value of the differential input signal with a region, although the particular region is not determinable by this circuit. In one embodiment, for example, there are 32 folded signals resulting from a 9X folding process where ½ fold on each extreme is discarded, providing for 8 zero crossings in 8 regions of the range. In each region, the 32 folded signals indicate a zero crossing, providing for a fine discrimination in each of eight regions of the range of values for the differential input signal.

A selected number of the differential output signals are input to a course pre-amp. The selected differential output signals are chosen to indicate in which region of the range in which the differential input signal lies. Course pre-amp receives the selected differential output signals and provides an appropriate gain.

In some embodiments of the invention, the folding and interpolating circuits includes a first folder coupled to a second folder. The first folder includes active signal averaging as well as resistive interpolation in order to reduce offsets from manufacturing or temperature variations in the semiconductor devices. In some embodiments, the averaging is realized by having amplifiers with multiple inputs that are connected to adjacent outputs of the pre-amp bank. The second folder includes resistive interpolation but not voltage averaging.

The set of differential folded signals from the folding circuitry and the selected differential output signals are input to a comparator bank. The comparator bank includes a fine comparator bank and a course comparator bank, each of which includes an array of strobed comparators. Each of the array of strobed comparators of the fine comparator bank receives one of the set of differential folded signals and, when strobed by the sampling clock signal, outputs a first logic value (e.g., high) if the differential signal is positive and a second logic value (e.g., low) if the differential signal is negative. Each of the array of strobed comparators of the course comparator bank receives one of the selected set of output signals and, when strobed by the sampling clock signal, outputs the first logic value if the differential signal is positive and the second logic value if the differential signal is negative. Therefore, the comparator bank outputs a set of digitized fine values and a set of digitized course values.

In some embodiments of the invention, each of the array of strobed comparators of the course comparator bank and each of the array of strobed comparators of the fine comparator bank is followed by an RS latch. Each RS latch receives an output signal and the complement of the output signal from the corresponding strobed comparator. If the output signal is low and the complement is high the RS latch resets and outputs a low. If the output signal is high and the complement is low the RS latch sets and outputs a high. However, if the comparator is unable to make a decision because the differential input to the comparator is too close to 0, then the output signal and the complement will both be low and the RS latch will remain at whatever output value it had attained in the previous clock cycle. This arrangement has the advantage of preventing the strobed comparator from freezing or providing spurious outputs.

The digitized fine and course values from the comparator bank are input to the digital encoder. The digital encoder includes a course decoder which receives the digitized course values and a fine decoder which receives the digitized fine values. In some embodiments of the invention, the course decoder determines the most significant digits of the analog to digital output value by determining the number of digitized course inputs which are at a first logic level (e.g., 1). The number of digitized course inputs which are at a first logic level indicate which region of the range of the digital-to-analog converter corresponds to the differential input signal. Additionally, in some embodiments of the invention the fine decoder determines how many of the digitized fine values are at the first logic level for regions having one sense of the folded signals (i.e., rising with increasing values of differential input signal) or at the second logic level for regions having the opposite sense of the folded signals (i.e., falling with increasing values of differential input signal) to determine a bit value. In some embodiments, the sense of the folded signals is determined by a voting system which looks at the extreme values of the digitized fine values (e.g., at the 0^{th} and highest ones). In one embodiment there are 32 digitized fine values and the voting system determines the sense of the folded signals from the 0^{th}, 30^{th}, and 31^{st} digitized fine value. By counting the number of fine signals positioned lower than the zero crossing, a fine determination of the value of differential input signal is made. Additionally, by counting bits in the digitized fine and course values, the problem of spurious “bubbles” is automatically addressed. In other embodiments, the determination of the sense of the region can be accomplished by other methods.

In some embodiments, the most significant bits and the bit value are input to an error correction circuit. In some embodiments, the error correction circuit corrects for errors by detecting discrepancies between various ways of determining the region (e.g., by comparing the voting method described above with the region as determined by the digitized course values) and correcting accordingly.

In some embodiments, the digitized output signal from the error correction circuit is input to a range correction circuit. The range correction circuit determines whether the digitized output signal is over range or under range by comparing the most significant bit of the digitized output signal with values of the digitized course values near the extreme of the range. If an over range is detected, all bits of the digitized output signal is set high and if an under range is detected all bits of the digitized output signal are set to low.

These embodiments and others are further discussed below along with the following figures.

### BRIEF DESCRIPTION OF THE FIGURES

FIG. 1 shows a typical system having a digital display unit according to the present invention.

FIG. 2a shows a block diagram of an embodiment of a graphics digitizer according to the present invention.

FIG. 2b shows a block diagram of one channel of the graphics digitizer shown in FIG. 2a.

FIGS. 2c, 2d, 2e and 2f show various timing diagrams for signal processing in the graphics digitizer shown in FIG. 2a.

FIG. 2g shows a block diagram of an embodiment of the phase-locked-loop shown in FIG. 2a according to an aspect of the present invention.

FIG. 2h shows a block diagram of an embodiment of the programmable Div/N circuit of the phase-locked-loop shown in FIG. 2g.

FIG. 2i shows a block diagram of a phase adaptation circuit of the phase-locked loop shown in FIG. 2a according to an aspect of the present invention.

FIGS. 2j and 2k show clock diagrams illustrating the phase adaptation in the phase-locked-loop of FIG. 2g.

FIG. 3a shows a block diagram of an analog-to-digital converter according to the present invention.

FIG. 3b shows a circuit diagram for generating a reference signal and a bias signal according to the present invention.

FIG. 4a shows a block diagram of an analog-to-digital converter according to the present invention.

FIG. 4b shows a circuit diagram for an embodiment of the reference generator shown in FIG. 4a.

FIG. 5 shows a simplified diagram of an embodiment of the sample and hold circuit of the analog-to-digital converter shown in FIG. 4.

FIG. 6a shows a block diagram of an embodiment of an offset cancelled pre-amp portion of the analog-to-digital converter according to the present invention.

FIG. 6b shows a circuit diagram of an embodiment of a differential amplifier of the offset cancelled pre-amp shown in FIG. 6a.

FIG. 6c shows a block diagram of an embodiment of the offset cancelled pre-amp shown in FIG. 6a illustrating one embodiment of the offset cancellation.

FIG. 6d shows a block diagram of an embodiment of the offset cancelled pre-amp shown in FIG. 6a illustrating a second embodiment of the offset cancellation.

FIG. 6e shows graphically the output signals from the pre-amps in the pre-amp array of FIG. 6a with increasing values of differential input signal.

FIG. 7a shows a circuit diagram of an embodiment of a sub-block for a first folding block with active signal averaging and resistive interpolation and averaging according to the present invention.

FIG. 7b shows a circuit diagram of an embodiment of a sub-block for a second folding block with resistive interpolation according to the present invention.

FIG. 7c shows an embodiment of the first folding block having sub-blocks shown in FIG. 7a and the second folding block having sub-blocks shown in FIG. 7b.

FIG. 7d shows a set of 9X folded signal resulting from an embodiment of the first folding stage and second folding stage shown in FIG. 7c with ½ a fold neglected at both edges.

FIG. 8 shows a block diagram of an embodiment of a course pre-amp of FIG. 4 according to the present invention.

FIG. 9 shows a block diagram of an embodiment of the comparator array of FIG. 4 according to an aspect of the present invention.

FIG. 10a shows a block diagram of an embodiment of the digital encoder according to the present invention.

FIG. 10b shows a block diagram of an embodiment of the digital encoder according to aspects of the present invention.

In the figures, elements having the same identifiers in different figures have the same or similar functions.

### DETAILED DESCRIPTION

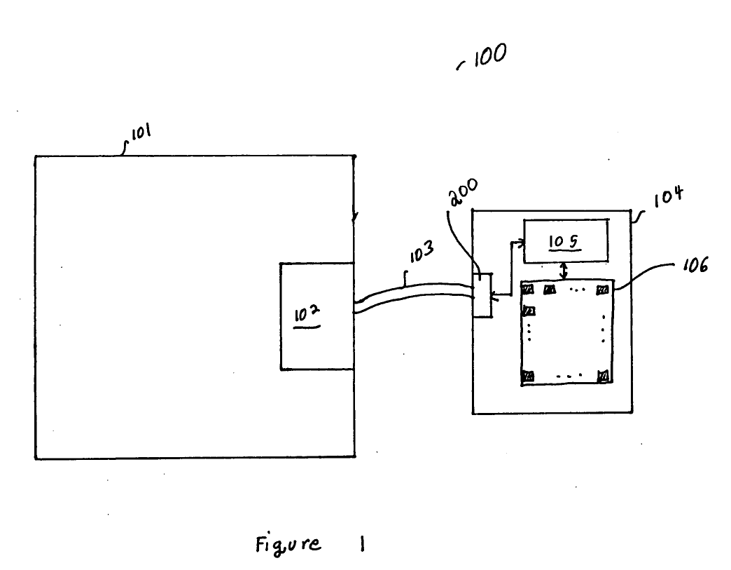

FIG. 1 shows an example of a computer system 100 having a digital display unit 104 with a graphics digitizer 200 according to the present invention and a computer 101. Digital display unit 104 is typically coupled to computer 101 through cable 103 and interface card 102. Digital display unit 104 receives analog signals usually including a red signal, a green signal, and a blue signal for RGB format. Additionally, a VSYNC (vertical sync) signal and a HSYNC (horizontal sync) signal is usually included. One or more of the VSYNC and HSYNC signals may be embedded in the RGB signals (e.g., sync on green format). The VSYNC and HSYNC signals define a frame and lines within the frame, respectively. The timing signal VSYNC indicates the beginning and end of a frame while the timing signal HSYNC indicates the beginning and end of lines in the frame.

Digital display unit 104 can be any digital display (e.g., a flat panel digital display). Digital display unit includes an array of pixels 106 coupled to graphics digitizer 200 through a digital pixel controller 105. Array of pixels 106 can include red, green, and blue emitters arranged to create a colored image. Alternatively, array of pixels 106 can include emitters of all the same color for monochromatic image displays. Digital controller 105 receives digital signals and timing signals from graphics digitizer 200 and, in response, controls the optical output of individual pixels in array of pixels 106. In some embodiments, digital controller 105 can also set operating parameters of graphics digitizer 200.

Analog input signals received by graphics digitizer 200 need to be digitized at a rate consistent with the refresh rate of the frame and with the pixel resolution of array of pixels 106. In some embodiments, graphics digitizer 200 may output data to digital controller in one of several formats depending on control signals input to graphics digitizer from digital controller. Array of pixels 106 can have any resolution. For example, a resolution of 1280 by 1024 pixels is not uncommon.

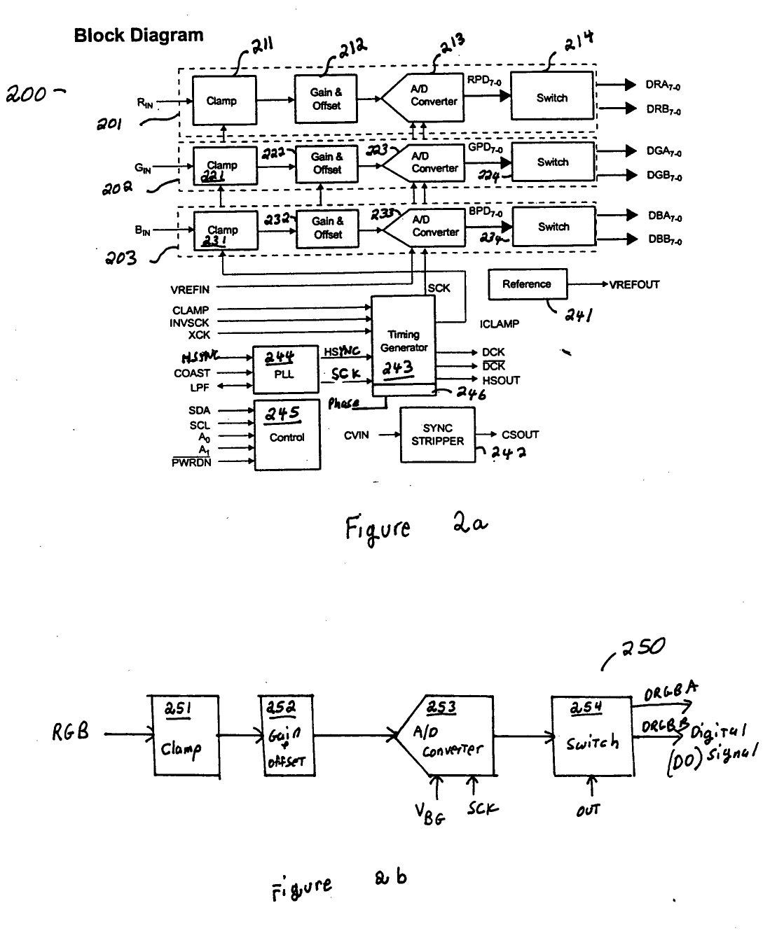

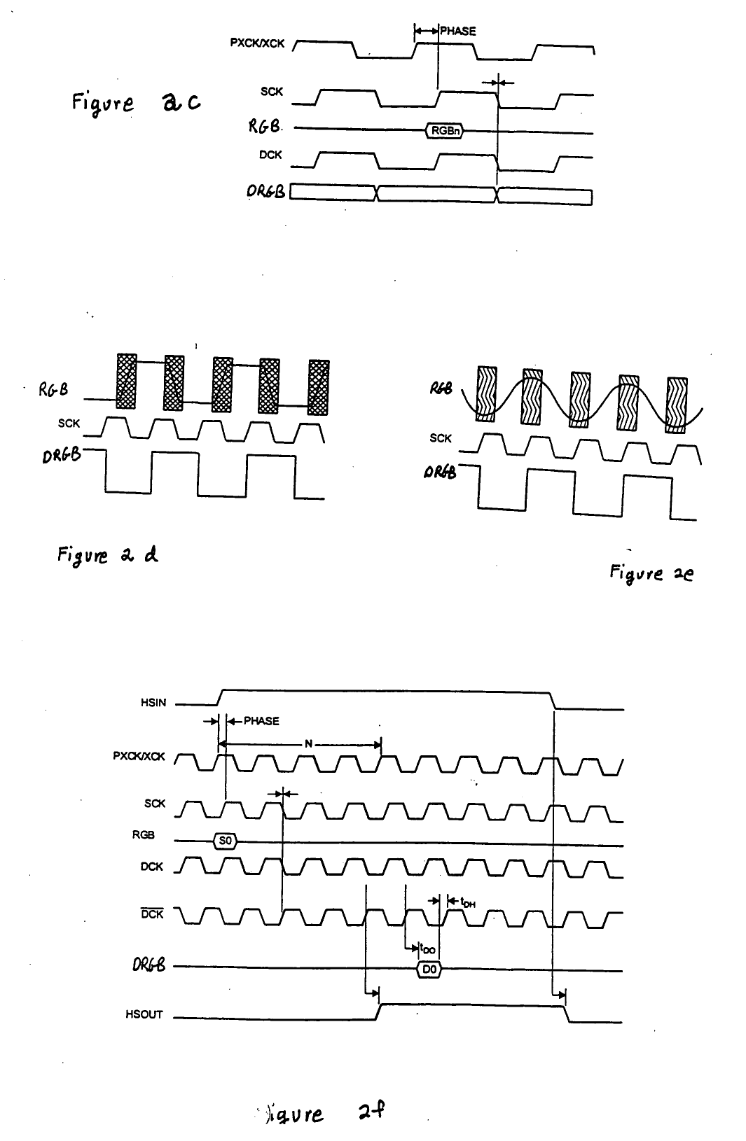

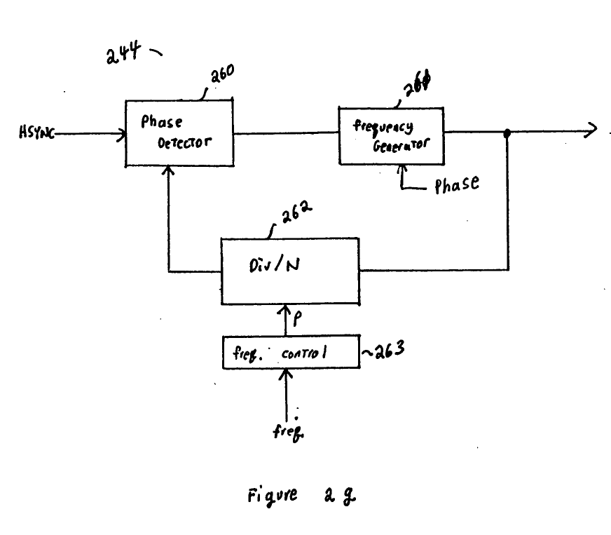

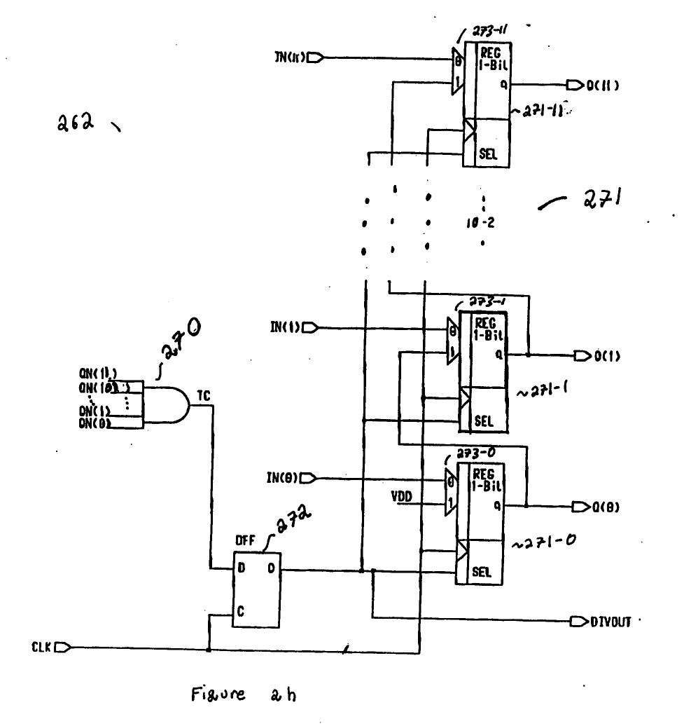

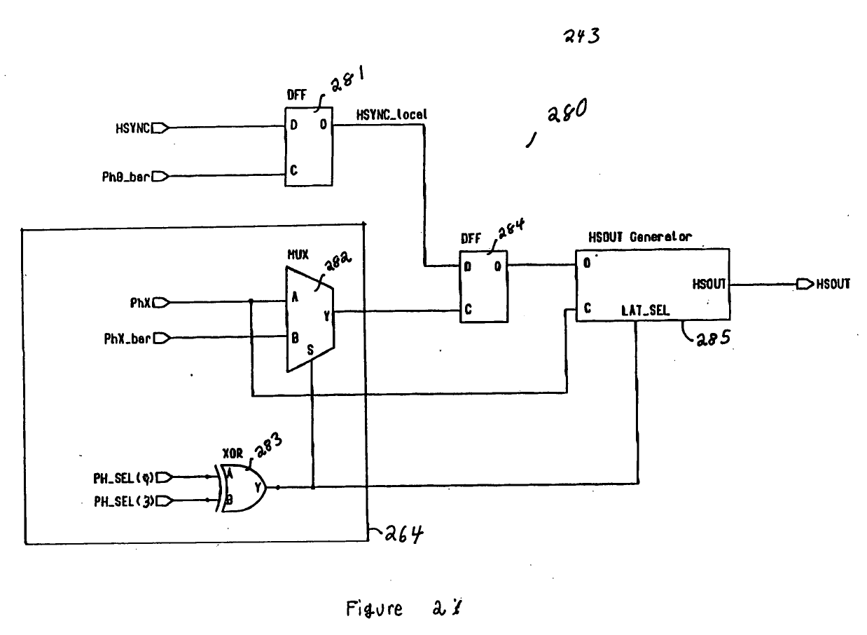

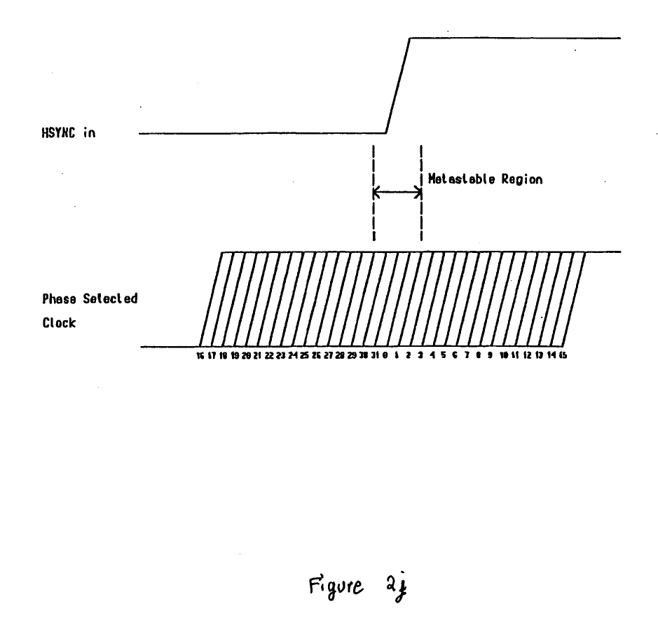

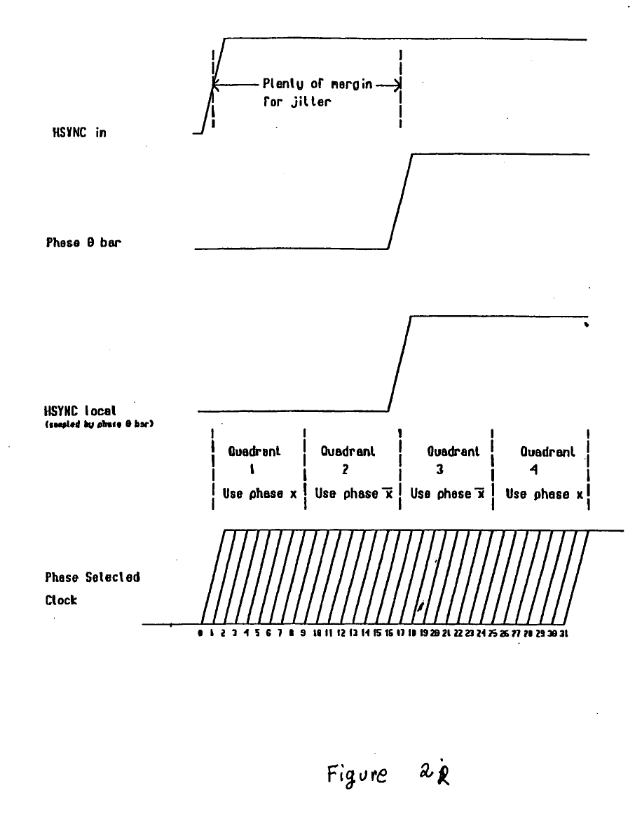

FIG. 2a shows a block diagram of an embodiment of a graphics digitizer 200 according to the present invention. Digitizer 200 receives analog video signals RIN, GIN, and BrN and outputs digital signals DRA, DRB, DGA, DGB, DBA, and DBB to, for example, digital controller 105 of digital display unit 104. Each of the three RGB analog video signal is received in a separate channel. In FIG. 2a, analog signal R_{IN} is received in channel 201, analog signal G_{IN} is received in channel 202, and analog signal B_{IN} is received in channel 203. Channels 201, 202 and 203 are similar channels. Channel 201 includes, coupled in series, a clamp circuit 211, a gain and offset circuit 212, an analog-to-digital converter 213, and a switch 214. Channel 212 includes, coupled in series, a clamp circuit 221, a gain and offset circuit 222, an analog-to-digital converter 223, and a switch 224. Channel 203 includes, coupled in series, a clamp circuit 231, a gain and offset circuit 232, an analog-to-digital converter 233, and a switch 234.

The embodiment of graphics digitizer shown in FIG. 2a, graphics digitizer 200, operates with RGB formated analog video signals. One skilled in the art will recognize that a graphics digitizer according to the present invention may be utilized with other video standards as well. Accordingly, graphics digitizer 200 may have any number of input channels.

Graphics digitizer 200 further includes phase-locked-loop (PLL) 244, timing generator circuit 243, control circuit 245 and SYNC stripper 242. PLL 244 inputs the HSYNC signal and outputs a high-frequency sampling clock signal SCK. The actual frequency of the SCK signal can be set by an externally programmable register in PLL 244. The frequency of sampling signal SCK corresponds to the number of pixels in a line of pixel array 106 (i.e., the analog input signals are sampled once for each pixel in the line). Alternatively to PLL 244, the SCK signal may be input from an external source (e.g. digital display unit 104) directly to timing generator 243. In some embodiments, the phase of clock signal SCK is set by a programmable phase register.

FIG. 2g shows an embodiment of phase-locked loop 244 according to aspects of the present invention. Phase-locked-loop 244 includes phase detector 260, frequency generator 261, and Div/N block 262. Frequency generator 261 is a broad-band generator which outputs a clock signal SCK of frequency f in response to a control signal output from phase detector 260 (e.g., a voltage-controlled oscillator). Clock signal SCK, in addition to being the output signal of phase-locked-loop 244, is also input to Div/N block 262. Div/N block 262 outputs a signal with frequency f/N to phase detector 260. Phase detector 260 compares the signal output from Div/N block 262 with the received HSYNC signal and outputs the control signal, which is related to the phase between the HSYNC signal and the output signal from Div/N block 262, to frequency generator 261. The value of N for Div/N block 262 is controlled through programmable register 263. Register 263 holds the value N, and therefore controls the frequency of the clock signal SCK. The frequency of the signal HSYNC is multiplied by a value stored in register 263. The value in register 263 should be the number of pixels per horizontal line the digital display unit 104 (i.e. the number of horizontal pixels in pixel array 106) including active and blanked sections. Typically blanking is 20-30% of active pixels. Therefore, the signals SCK, DCK, and \overline{DCK} are at a frequency that is higher than the frequency of HSYNC by a factor of the value stored in register 263.

FIG. 2h shows an embodiment of Div/N block 262. Div/N block 262 receives digital signal IN(0:11) from register 263 (FIG. 2g) and the clock signal SCK. Counter 271 is an incremental counter that counts down from an initial starting value determined by digital signal IN(0:11) when clocked with the clock signal SCK. Counter 271 includes an array of bit registers 271-0 through 271-11 with inputs multiplexed by multiplexers 273-0 through 273-11, respectively. Multiplexers 273-0 through 273-11 are coupled to receive bits of digital signal IN(0:11), respectively, and are also coupled to the outputs of other ones of bit registers 271-0 through 271-11 so that a counting function can be implemented. The output from register bits 271-0 through 271-11, Q(0:11), respectively, is input to circuit 270. When counter 271 reaches 0, circuit 270 outputs a logic high which is clocked into flip-flop 272. Flip-flop 272 outputs a signal which is high if the output signal from circuit 270 is high and zero otherwise. A high signal from flip-flop 272 is held for one cycle of clock signal SCK. The output signal from flip-flop 272 is the output signal from Div/N circuit 262 and also controls multiplexers 273-0 through 273-11 so that when counter 271 reaches zero, counter 271 is reloaded with digital signal IN(0:11). The counting and resetting process continues so long as Div/N circuit receives clock signal SCK. Additionally, if a new digital value IN(0:11) is loaded into register 263 then Div/N will count down from the new digital value starting with the following clock cycle of clock signal SCK. Div/N circuit 262, then, effectively implements a divide by N function where N is the digital value programmed into register 263.

FIG. 2i shows an embodiment of a portion 280 of timing generator 243 for generating an HSOUT signal. In some embodiments, the HSYNC is sampled with a phase adaptively chosen by a phase adaptor circuit 264 in order to generate the HSOUT signal. Phase-locked-loop 244 locks on to the horizontal sync signal (HSYNC) and generates a sampling clock signal SCK in order to digitize the pixels across a line, as described above. As shown in FIG. 2a, timing generator 243 inputs the SCK signal from PLL 244. Timing generator 243 outputs a sampling frequency signal SCK to A/D converters 213, 223, and 233. The phase of the SCK signal relative to HSYNC is programmable by inputting a PHASE signal to frequency generator 261 (FIG. 2g). In one embodiment, the phase of SCK can be adjusted in thirty-two 11.25 degree phase increments using an externally programmable PHASE register 246, which stores a digital value Ph_Sel. Timing generator 243 can also output clock signal DCK, and its complement \overline{DCK}. Additionally, the signal HSYNC is output, synchronized with the digital data signal DRGB (i.e., DR, DG and DB) as signal HSOUT in FIG. 2a. Output clock signal DCK and \overline{DCK} and horizontal sync HSOUT are supplied for synchronizing data transfer from graphics digitizer 200.

Although signals SCK, DCK, and \overline{DCK} are easily phase shifted from the HSYNC signal, the HSOUT signal is not easily shifted accordingly. The problem is a result of the fact that HSYNC is the input reference frequency to PLL 244, thereby defining zero phase, but at some point the HSYNC signal needs to be phase adjusted in order to synchronize HSOUT with the other clock signals for output. When the sampling phase is in close proximity to the HSYNC phase, pixel clock jitter combined with set-up and hold time violations can cause metastable timing for the HSOUT signal. The HSOUT signal, then, may vary by one cycle of clock signal SCK between lines of signal outputs. Display unit 104, however, uses HSOUT to denote start of line and therefore any noise in HSOUT is visible on the image formed by display unit 104, causing a possible visible jitter in the lines of the video output. FIG. 2j shows how the sampling phases can pass through the HSYNC edge, resulting in jitter when sampling is accomplished with particularly phased clock signals.

Phase adaptor circuit 264 solves this problem by changing the sampling time of the HSYNC input based on the externally selected phase indicated by digital value Ph_Sel in PHASE register 246. The metastable regions can then be avoided, producing a reliable and consistent HSOUT signal aligned with other timing signals (e.g. SCK). FIG. 2k illustrates a method of reliably producing the desired HSOUT signal. The HSYNC signal is first sampled by a “phase 0 bar” signal. Since “phase 0” is locked to the HSYNC rising edge, the “phase 0 bar” signal yields a ½ sampling clock cycle SCK of margin for jitter. This reliably samples HSYNC into the system, but does not adjust the phase to create HSOUT. However, the “phase 0 bar” sampled HSYNC signal, HSYNC_local, can in turn be sampled with the phase adjusted clock (phase x) or phase adjusted clock bar (phase \overline{x}) depending on which phase is selected in register 246. When the phase selected in register 246 comes within ¼ cycle of the “phase-0 bar” sampled HSYNC signal, adaptor circuit 264 samples with the opposite phase to avoid the metastable region. In some embodiments, an XOR function between the most significant bits of register 246 can determine which quadrant is selected and then adapter circuit 264 can choose the phase accordingly to sample the “phase-0 bar” sampled HSYNC signal. The resulting change in position of the HSOUT signal can be accounted for in further pipeline delay stages and a one sampling cycle jump can be added or subtracted to the latency of HSOUT accordingly.

FIG. 2i shows an embodiment of portion 280 of timing generator 243 for generating the synchronized horizontal sync signal HSOUT. The horizontal sync signal HSYNC is sampled into D-flip flop 281 with signal “phase-0 bar” (Ph0_bar) to generate the “phase_{—}0 bar” sampled signal HSOUT_local with ½ a sampling clock (SCK) cycle of margin for jitter. Phase adapter circuit 264 includes an XOR gate 283 that determines whether the selected phase stored in register 246, determined by the digital value Ph_Sel, is in the first or fourth quadrant of the cycle or in the second or third quadrant of the cycle. In an embodiment having 32 phase settings, as described above, and with Ph_Sel being a 5-bit digital number, the two most significant bits of Ph_Sel (Ph_Sel(3) and Ph_-Sel(4)) are the same in the first and fourth and final fourth of the 32 possible codes and differ in the second and third quarters of the 32 possible codes. In FIG. 2i, the two most significant bits of Ph_Sel are input to XOR 283, which will then output a 0 if Ph_Sel indicates a phase in the first or fourth quadrant and a 1 if Ph_Sel indicates a phase in the second or third quadrant. The output signal from XOR 283 is input to multiplexer 282. Multiplexer 282 is chooses between a signal PhX and its inverse PhX_bar depending on the output signal from XOR 283. Signal PhX is a clock signal having the same phase as signal clock signal SCK.

The output signal from multiplexer 282 is coupled to D-flip-flop 284 along with the HSYNC_local signal from D flip-flop 281. If the selected phase indicated by Ph_Sel is in the first or the fourth quadrant, then the output from multiplexer 282 is PhX and HSYNC_local is sampled by signal PhX in D flip-flop 284, allowing at least ¼ cycle of margin. If the selected phase indicated by Ph_Sel is in the second or third quadrant, then the output from multiplexer 282 is PhX_bar and HSYNC_local is sampled by signal PhX_bar in D flip-flop 284, again allowing at least ¼ cycle of margin with the metastable region. After HSYNC_local has been aligned with the phase adjusted clock, PhX is used thereafter to clock HSOUT through a predefined number of pipeline delays to match the latency of ADC 253. The change in phase (PhX or PhX_bar) can be accounted for in an HSOUT generator 285 by adding or subtracting a clock cycle of latency to HSOUT such that it is transparent to the outside world.

Control circuit 245 (FIG. 2a) controls operation of graphics digitzer 200. For example, the PWRDN signal controls whether graphics digitzer 200 is operating in power saver mode. Furthermore, the SDA, SCL, A0 and A1 signals control a serial output port for outputting digitized data DRA, DRB, DGA, DGB, DBA, and DBB. In one embodiment, registers in graphics digitizer 200 are accessed through an I²C/SMBus compatible serial port, although embodiments of graphics digitizer 200 can have input and output ports with any interface protocol.

Sync Stripper circuit 242 retrieves a vertical sync signal (VSYNC) and outputs it as signal CSOUT. Some video signals included embedded composite sync rather than separate horizontal and vertical sync signals. For example, it is not uncommon for the VSYNC signal or the HSYNC signal to be combined with the analog signal G_{IN} (sync on green). Alternatively, a separate VSYNC signal may be input directly as the CVIN signal. In either case, Sync Stripper circuit 242 retrieves a VSYNC signal (labeled CSOUT in FIG. 2a).

In the embodiment shown in FIG. 2a, two clock signals originate from PLL 244 and timing generator 243, data clock signals DCK and \overline{DCK} and internal sampling clock signal SCK. Signals DCK and \overline{DCK} are utilized to strobe data output from channels 201, 202 and 203 to following digital circuits (e.g. in digital controller 105 of digital display unit 104). Signal SCK is the sampling clock for analog-to-digital converters (ADC) 213, 223, and 233. The phase of SCK can be controlled through PHASE register 246. The phase of timing signals DCK and \overline{DCK} are aligned with that of clock signal SCK. The reference signal for PLL 244 is the horizontal sync input signal HSYNC with polarity selected by a control bit, HSPOL.

FIG. 2b shows a block diagram of a channel 250 which can be any one of channels 201, 202 or 203. Channel 250 includes a clamp circuit 251, a gain and offset circuit 252, an analog-to-digital converter 253 and a switch 254. Typical RGB graphics signals, (i.e., analog R_{IN}, G_{IN}, and B_{IN} signals) are ground referenced typically with a 700 mV amplitude. If a sync signal is embedded then the usual format is sync on green with the sync tip at ground, the black level elevated to 300 mV and peak green at 1000 mV.

DC-coupled input signals can be passed directly to A/D converter 253. AC coupled input signals are level shifted to establish the lower level of the conversion range by clamping to the black level. Clamp pulses are derived from internal Timing and Control logic or from an external CLAMP input signal. The A/D conversion range of A/D converter 253 can be matched to the amplitude of the incoming video signal by programming a gain registers GR and an offset register OSR in Gain and Offset circuit 252. In one embodiment, registers GR, GG and GB vary sensitivity (LSB/volt) for example over a 2:1 range. In some embodiments, incoming RGB signals varying from 0.5 to 1.0 volts can be accommodated. In some embodiments, input offset voltage of each A/D converter 253 is programmable in 1 LSB steps through a 6-bit OSR register in a range equivalent to −31 to 32 LSB.

If the incoming analog signal RGB is not ground referenced, clamp 251 sets the incoming signal range relative to ground. Clamp 251 allows a capacitively coupled input signal to be referenced to the low reference voltage of A/D converter 253 when the clamp pulse is active. In some embodiments, position and width of the internal clamp pulse can be programed through storage registers in clamp 251. An external clamp input can be selected. In some embodiments, clamp 251 can be disabled for DC coupled inputs.

Best performance will be achieved with the clamp set active for most of the black signal level interval between the trailing edge of horizontal sync and the start of active video. Insufficient clamping can cause brightness changes at the top of a resulting image and slow recovery from large changes in average picture level.

Switch 254 includes a commutating switch for dual port operation. Switch 254 provides programmable interfacing of digital data from A/D converter 253 to digital controller 104. Such interfacing can be accomplished with any interface protocol.

The input horizontal sync signal HSYNC and outgoing digitized data from channel 250 are resynchronized to the delayed sample clock signal SCK. Output timing characteristics for channel 250 are shown in FIG. 2c. The latency of the first pixel, N, varies according to mode (e.g., single or dual output, interleaved or parallel output, and 1 pixel or 2 pixel output). Timing is referenced to the leading edge of the HSYNC signal when the first sample is taken at the rising edge of SCK. The status of a register bit OUT determines if even samples are directed to an A-port (DRGBA) and odd samples are directed to a B-port (DRGBB).

A/D converter 253, in one embodiment, digitizes the analog input signal RGB into 8-bit data words. Latency is 5-6.5 clock cycles, depending upon the output data format. A/D converter 253 receives a sampling signal SCK from timing generator 243 (FIG. 2a) and a reference voltage V_{BG}. Signal V_{BG} can be coupled to either the internal bandgap voltage or an external voltage.

FIG. 2c shows a timing diagram indicating the PHASE between clock signal PXCK and SCK and the receipt of an analog RGB signal. The analog RGB signal is sampled by the rising edge of clock signal SCK after a delay of PHASE from the rising edge of PXCK. As has been previously discussed, in some embodiments PHASE is set by a phase register 246. In some embodiments, PHASE has one of 32 values separated by 11.25°. Output data DRGB, and signals DCK, and \overline{DCK} are delayed with SCK relative to PXCK. In some embodiments, there is a 5 to a 5½ clock latency between the capture of analog signal RGB and the output of data DRGB from channel 250.

FIGS. 2d and 2e show the desired timing for capture of an analog RGB signal by A/D converter 253. Ideally, incoming analog RGB signals would be trapezoidal with fast rise-times relative to the sampling edge of signal SCK. As shown in FIG. 2d, the rising edge of SCK is positioned along the level section of the analog RGB signal waveform. There is a narrow zone of uncertainty where sampling during the pixel rise time of analog RGB signals causes an error in the resulting digital output signal DRGB. In practice, high-resolution pixels have long rise times, as is shown in FIG. 2e. There are narrow zones of serendipity when the amplitude of the analog RGB signal corresponding to a pixel is level. Therefore, A/D converter 253 needs to sample the analog RGB signal during these zones of serendipity.

FIG. 2f shows an overall timing diagram for output timing. Input horizontal sync, HSYNC, and outgoing digital data DRGB are resynchronized to the delayed sample clock SCK. In one embodiment, the latency of the pixel (i.e., the number of clock cycles between input of the analog RGB signal and digital DRGB signal) varies according to whether channel 250 is operating in single or dual output mode, interleaved or parallel output mode, or 1-pixel or 2-pixel output mode. Embodiments of the invention may operate such that several modes of data output are obtained, including: even pixel data to a port A and odd pixel data to a port B; alternate sampling of odd and even pixels (i.e., digitizing the odd pixels from a first frame and the even pixels from the next frame) outputting even pixels to port A and odd pixels to port B; alternate sampling of odd and even pixels and outputting the results on a single port; and various other combinations.

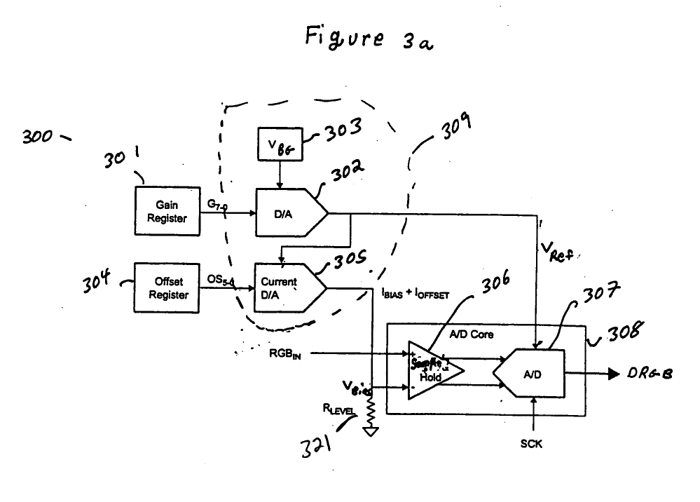

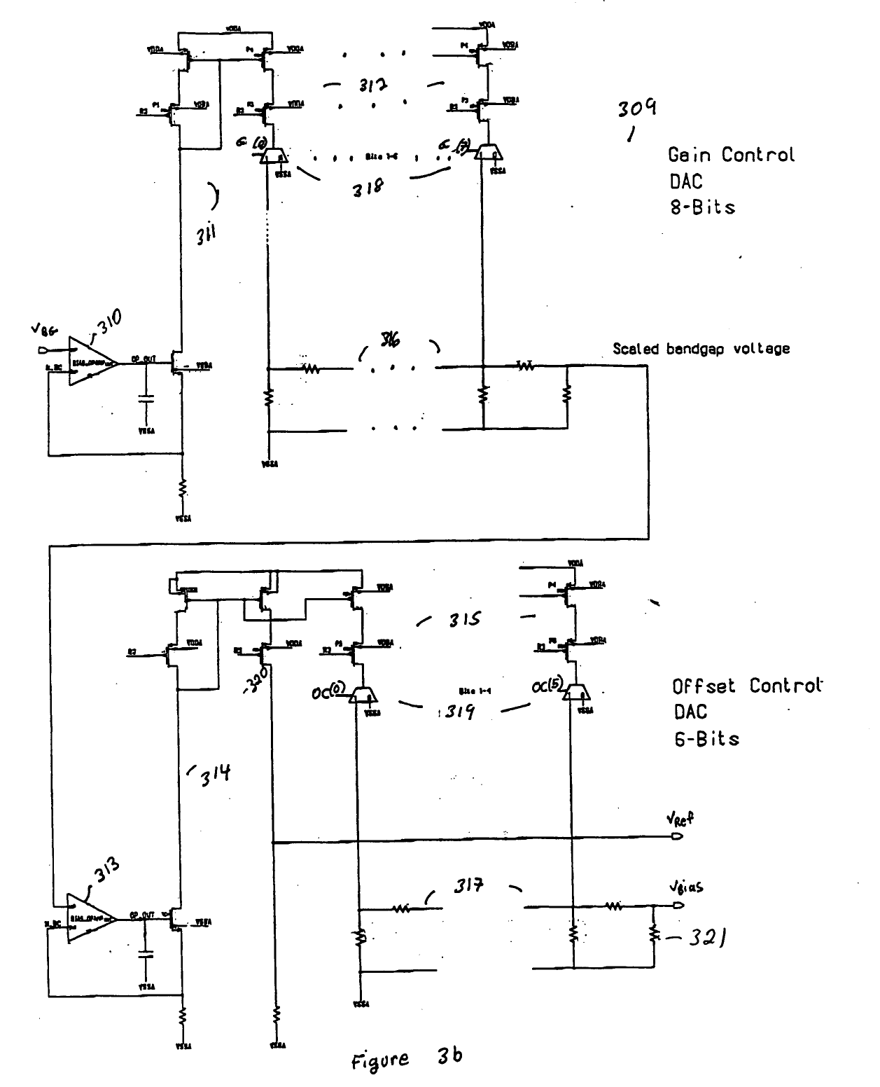

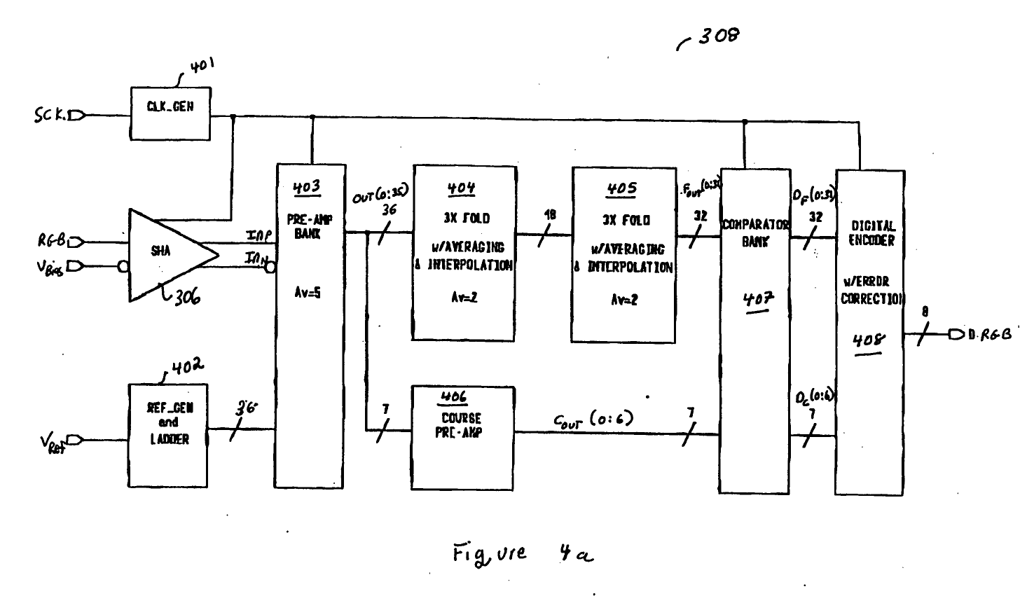

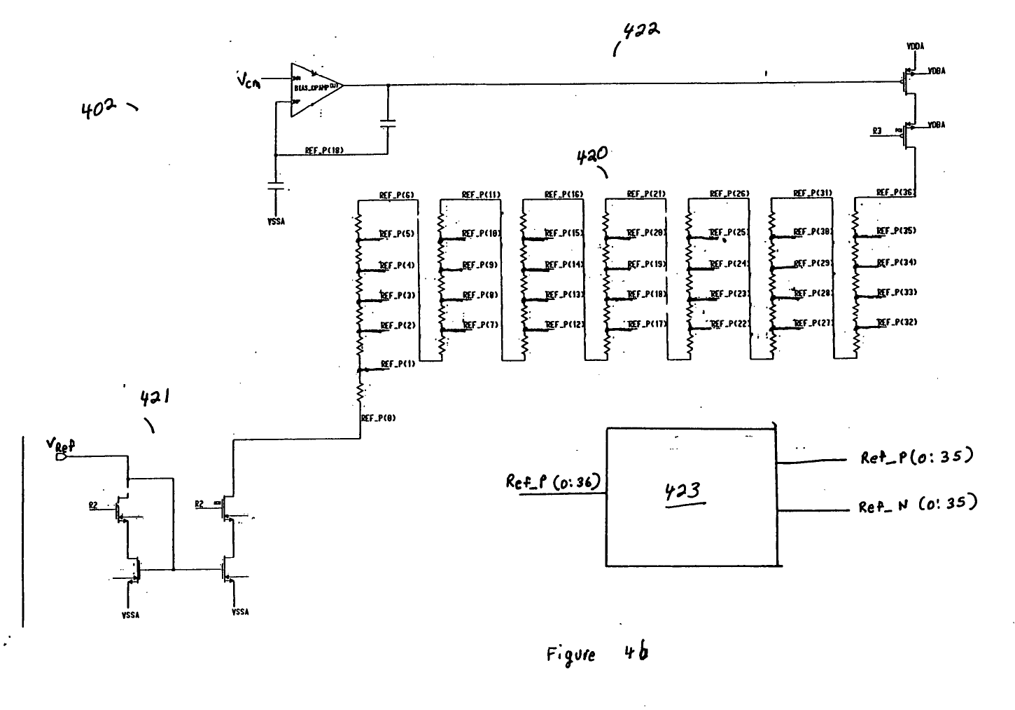

FIG. 3a shows a block diagram of a combination 300 of gain and offset 252 with analog-to-digital converter 243 according to the present invention. Combination 300 includes a gain register (GR) 301 coupled to a digital-to-analog converter 302 and an offset register (OSR) 304 coupled to current-digital-to-analog converter 305. Gain register 301 and offset register 304 can be externally programmed. A voltage reference 303 provides a reference voltage to digital-to-analog converter 302. In some embodiments, the reference voltage is a band-gap reference with V_{BG} approximately 1.25 V. The output signal from digital-to-analog converter 302 is a reference voltage V_{REF} which is input to analog-to-digital converter 307 inside ADC 308. Digital-to-analog converter 302 utilizes V_{BG} as the maximum reference voltage and therefore V_{REF} is less than V_{B}G. In some embodiments, the value of V_{REF} is programmable through gain register 301 in a range from V_{BG} down to about ½ V_{BG}.

The reference voltage V_{REF} is also input to current digital-to-analog converter 302 to scale the current output I_{Bias}+I_{offset}. The output signal from current digital-to-analog converter 302 is programmable through offset register 304. The bias levels V_{BIAS} is linked to the reference voltage V_{REF} so that there is always programmability between V_{REF} and V_{Bias}. For example, if V_{REF} is at 1.0 V peak-to-peak and the offset is at 0.5 V, then there is programmability above and below the offset voltage V_{BIAS}. If V_{REF} is programmed to 0.5V, then V_{BIAS} can be reset to 0.25V. The bias voltage, V_{BIAS}, then scales with reference voltage V_{REF}. In some embodiments, the gain and offset in each of channels 201, 202 and 203 of graphics digitizer 200 (FIG. 2a) can be independently adjusted.

In some embodiments, gain register 301 is an 8-bit register and offset register 304 is a 6-bit register. The full-scale voltage of ADC 308, for example, can be varied from 1.0 V, peak-to-peak, down to 0.5 V, peak-to-peak, which results in effectively a 2:1 gain control. For example, assume that RGB intput signal is 0.25V applied to ADC 308 with a full scale range, determined by V_{Ref}, of 1.0 V, peak-to-peak. The digital output DRGB from ADC 308, then, would be at ¼ scale, or 256/4=64 if ADC 308 is an 8-bit converter. If the same 0.25 V signal was applied to ADC 308 where V_{Ref} is adjusted so that full scale range is 0.5 V, peak-to-peak, digital output DRGB would be ½ scale, or 128 if ADC 308 is an 8-bit converter. The value stored in gain register 301 can adjust the full scale range from 1.0V to 0.5 V linearly and if register 301 is an 8-bit register the full scale range can be adjusted with a granularity of 256 steps. With a 6-bit offset register 304, a 64 LSB step adjustment range can be realized. Code 32, for example, can correspond to zero offset with 32 codes below and 31 codes above the zero offset. The least significant bit (LSB) of offset is determined by the value V_{Ref} generated by digital-to-analog converter 302.

The output current signal from current digital-to-analog converter 305 is input to one input terminal of differential sample-and-hold circuit 306 of A/D 308. The input RGB signal is received at a second input terminal of sample-and-hold 306. Differential analog-to-digital converter 307 is coupled to receive output signals from track-and-hold 306 and provides a digitized output signal DRGB indicating the voltage level of the RGB signal input to analog-to-digital converter 253.

Setting a value at gain register 301 establishes the reference voltage for differential A/D converter 307. Increasing the value of gain register 301 reduces the contrast of a resulting video image since the number of output codes from A/D converter 253 is reduced. Setting an offset value in offset register 304 translates the ground referenced input signal RGB to a differential voltage centered around an offset from the common mode bias voltage. The output signal from current D/A converter 305 includes a bias current (reflecting the common mode bias voltage) plus an offset current. Increasing the offset of a video signal increases the brightness of the resulting image.

FIG. 3b shows an embodiment of a circuit corresponding to portion 309 of combination 300 in FIG. 3a. Portion 309 generates the Vref and Vbias signals in response to the gain value and offset value stored in gain register 301 and offset register 304, respectively. Digital-to-analog converter 302 receives the bandgap voltage V_{BG} in amplifier 310. The bandgap voltage V_{BG} is converted to a current signal for the circuit in circuit 311. The current signal is mirrored, in some embodiments eight (8) times, in current mirrors 312. Multiplexers 318 are coupled to current mirrors 312 and, for each current mirror in current mirrors 312, make a decision to steer the current into ground (VSSA) or into resister ladder 316 based on the binary input of the gain value, in some embodiments G(0:8), in gain register 301. In some embodiments, resistor ladder 316 is an R2R ladder. The number of current sources steered into resistor ladder 316 and the nature of the resistor ladder network combine to generate a scaled bandgap voltage, V_{Ref}, proportional to gain value stored in gain register 301. The scaled bandgap voltage, which in some embodiments supplies the reference voltage V_{Ref}, is then input to amplifier 313. The output signal from amplifier 313 is converted back into a current signal by circuit 314. This current signal is then mirrored through current mirrors 315. The offset value, in some embodiments OC(0:5), stored in offset register 304 is coupled to multiplexers 318 which, based on the offset value, steer the current from current mirrors 315 to ground (VSSA) or to resistor ladder 317. Resistor 321, shown both in FIG. 3a and FIG. 3b, converts the current signal from resistor ladder 317 to the bias voltage V_{Bias}. In some embodiments, resistor ladder 317 is an R2R ladder. The bias voltage V_{Bias} is the output voltage from resistor ladder 317. The output voltage V_{Bias}, then, is then proportional to both the gain value G(0:7) stored in gain register 301 and offset value OS(0:5) stored in offset register 304. In the embodiment shown in FIG. 3b, the reference voltage V_{Ref} is taken from a current mirror 320 following circuit 314. This V_{Ref} voltage is adjusted to be substantially the same as the scaled bandgap voltage output from resistor ladder 316, with the advantage that any mismatches that might occur in the circuitry are minimized.

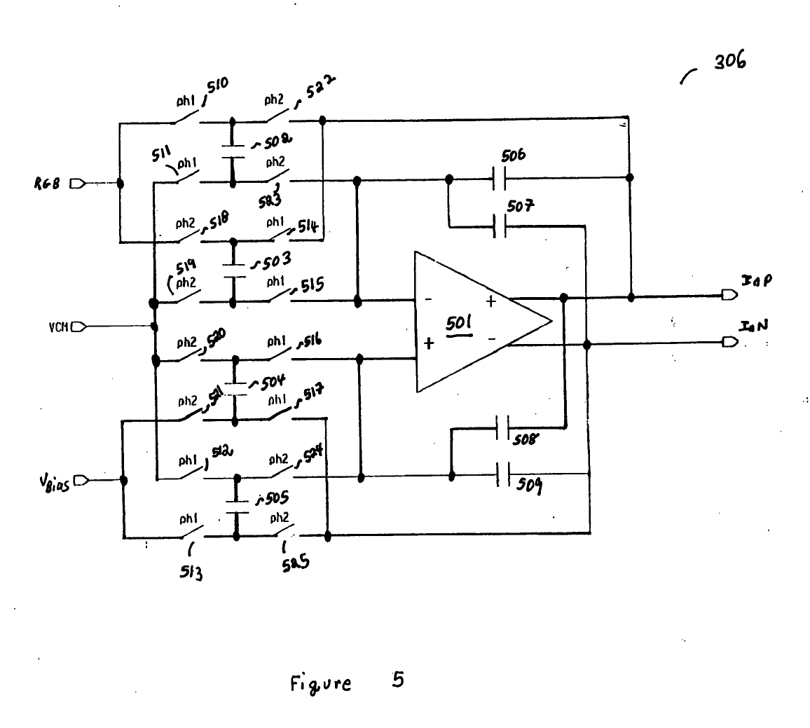

FIG. 4a shows a block diagram of an embodiment of analog to digital converter 308 (FIG. 3) according to an aspect of the present invention. In some embodiments of the invention, analog-to-digital converter 308 is a 3.3 V 200 MHz 8-bit Folding and Interpolating analog-to-digital converter (ADC) designed in 0.35 μm CMOS. One application for such an analog-to-digital converter 308 (FIG. 4) is for flat panel display monitors that digitize RGB graphics signals from personal computers and workstations. The 200 MHz encode rate allows digitizing of display resolutions up to 1600 by 1200 (UXGA) at a refresh rate of 75 Hz. Some embodiments of ADC converter 308, which can be designed in a 0.35 μm CMOS process, can be economically integrated into a full triple graphics digitizer such as graphics digitizer 200 of FIG. 2a. Some embodiment of ADC converter 308 can be optimized specifically for the embedded graphics digitizer application, namely: high pixel rate (200 MHz), wide bandwidth (500 MHz), excellent power supply/noise rejection (4 mV LSB, single ended), low power (250 mW), small size (0.35 μm CMOS), and low voltage (3.3 V).

Analog-to-digital converters according to the present invention may have further high-speed applications outside of the application to graphics digitizers as well. Additionally, even though an 8-bit analog-to-digital converter is specifically described in this disclosure, one skilled in the art will recognize that analog-to-digital converters according to the present invention can have any resolution (e.g., 10 or 12 bits).

ADC 308 shown in FIG. 4a includes a dedicated input sample-and-hold amplifier (SHA) 306, a reference generator and ladder 402, a pre-amp bank 403, 3X folds 404 and 405, a course pre-amp 406, a comparator bank 407, and a digital encoder 408. Clock signal SCK is input to Clock generator 401. Clock generator 401 outputs and distributes the clock signal SCK throughout ADC 308.

The analog RGB signal and a bias/offset signal are received by sample-and-hold amplifier (SHA) 306 (FIG. 3), which outputs a differential input signal. The differential input signal from SHA 306, In (collectively labeled InN and InP), is input to sub-ranging pre-amp bank 403 along with a set of N differential reference levels generated by reference generator 402. Pre-amp bank 403 can be a bank of offset canceled differential amplifiers. The differential reference levels from reference generator 402 are derived from input reference voltage V_{REF} (see FIG. 3).

Pre-amp bank 403 compares the differential input signal In (InN and InP) with each of the differential levels in the set of differential levels and outputs N differential output signals. As the differential input signal In is increased from a low value to a high value, different ones of the output signals from pre-amp bank 403 will transition from one saturation level (e.g., saturated low) to the opposite saturation level (e.g. saturated high). Therefore, for an intermediate value of differential input signal In, for example, output signals from pre-amp bank 403 resulting from comparisons with reference signals well below signal In will be at one saturation level, output signals resulting from comparison with reference signals well above signal In will be at the opposite saturation level, and output signals resulting from comparisons with reference signals close to signal In will have intermediate values.

The differential output signals from pre-amp bank 403, labeled collectively OUT(0:N−1), drive both a course and a fine converter, e.g. course pre-amp 406 and folders 404 and 405, respectively. The fine converter, in some embodiments, is a folding and interpolating circuit. In some embodiments, as shown in FIG. 4, the folding and interpolating circuit includes folders 404 and 405. In some embodiments, folders 404 and 405 provides two cascaded 3X folding blocks that create a 9X folding factor. However, one complete fold (½ on each side) of over range can be discarded to eliminate non-linear edge effects. The result is an active folding factor of 8X through the linear range of ADC 308. In one embodiment, the analog full-scale voltage for ADC 308 is 1.0V p-p (1LSB=4 mV). Thirty-two differential signals are folded 8 times through the linear transfer function of ADC 308 in folders 404 and 405, producing 256 discrete zero crossings as differential input signal In varies through the range of ADC 308. Folding block 404 includes voltage averaging and resistive interpolation while folding block 405 includes resistive interpolation.

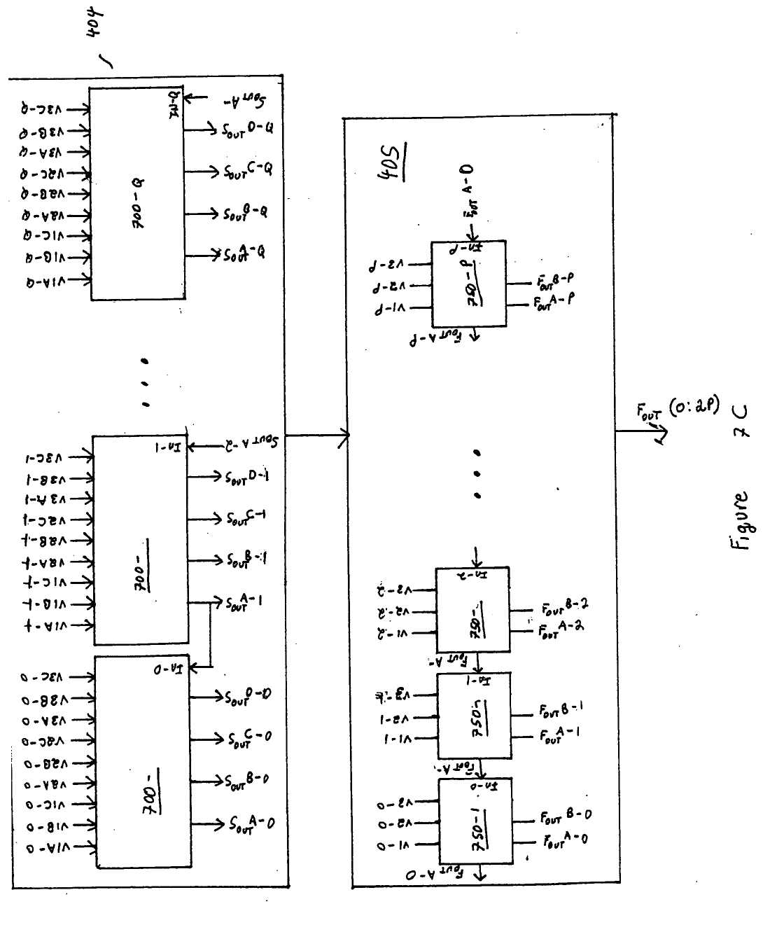

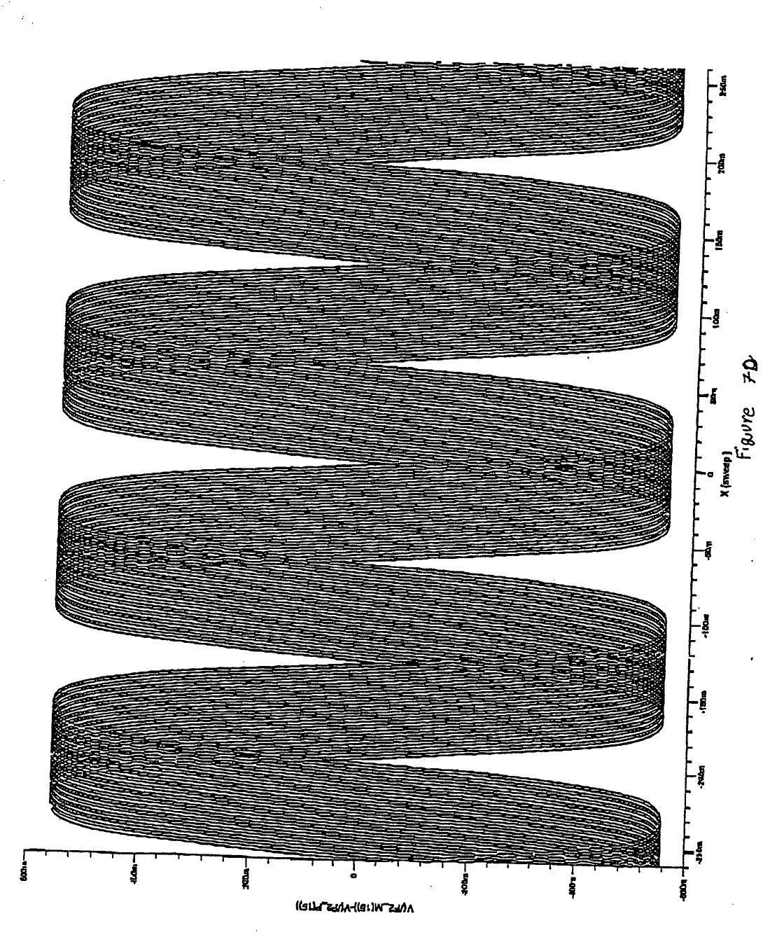

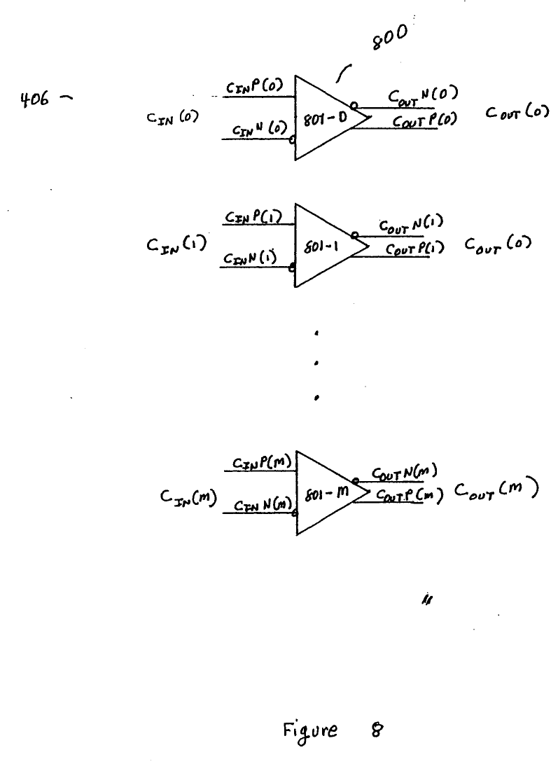

The fine zero crossings through the linear range of an 8-bit embodiment of ADC 308 is shown in FIG. 7d. Folders 404 and 405, by appropriately averaging and folding the N output signals from pre-amp bank 403, creates a series of signals having multiple zero crossings from which a determination of the digital output can be more accurately made.

Folder 404 receives the N differential output signals OUT(0:N−1) from pre-amp bank 403 and generates (Q+1)J output signals where Q+1 is the number of folding sub-blocks in folder 404 and J−1 is the number of resistive interpolations in each of the folding sub-blocks. In some embodiments, Q is 11 and J is 4 so that folder 404 outputs 48 folded signals. Each folding sub-block of folder 404 includes a number of amplifier sections each voltage averaging at least one of the N output signals from pre-amp bank 403. Voltage averaging at each amplifier section helps to reduce offsets between nominally identical circuit elements which, through manufacturing and thermal variations, differ from one another. In some embodiments, three amplifier elements per sub-block provides 3X folding and three sequential ones of the N output signals from pre-amp bank 403 are averaged at each amplifier stage.

The output signals from folder 404 are input to folder 405. Folder 405 does not utilize active voltage interpolation at the signal input terminals of the folding sub-blocks, but does utilize resistive interpolation. Folder 405 includes P+1 sub-blocks having K−1 resistive interpolations resulting in (P+1)K output signals. In some embodiments, P is 15 and K is 2, resulting in 32 folded output signals. Therefore, if folder 404 provides 48 output signals to folder 405, folder 405 folds the 48 output signals from folder 404 into 32 signals. In some embodiments, each sub-block of folder 405 can have three amplifier sections which, when combined with the 3X folding of an embodiment of folder 404, results in 9X folded output signals. In one embodiment folder 404 outputs 32, 9X folded output signals. Therefore, each of the 32 output signals has 9 zero crossings as the differential input signal In is varied through the range of ADC 308. However, a ½ fold on each extreme side of the fold can be discarded due to edge effects, resulting in 32 8X folded signal having a total resolution of 256 zero crossings, which is appropriate for an 8-bit converter.

Course pre-amp 406 inputs a selected set of the N output signals from pre-amp bank 403. The selected set of output signals corresponds to the folds of the folded signals output from folder 405 so that a later determination of which fold corresponds to the input signal can be made. In one embodiment, where N is 36 and output signals OUT(0:35) are output from pre-amp bank 403, signals OUT(4), OUT(10), OUT(14), OUT(18), OUT(22), OUT(26), and OUT(30) are input to pre-amp 406. Pre-amp 406 provides signals appropriate for comparator bank 407.

Comparator 407, then, includes a bank of fine strobed comparators and a bank of course strobed comparators. The bank of fine comparators receives the folded output signals from folder 405 and the bank of course comparators receives the output signals from course pre-amp 406. In some embodiments, the fine comparator bank receives 32 folded signals from folding block 405 and course comparator bank receives 7 signals from course pre-amp 406, respectively. Comparator bank 407 converts the differential zero crossings into CMOS logic levels to be processed by digital encoder 408. For example, each comparator in comparator 407 may output a logic 1 if its input signal is positive and a logic 0 if its input signal is negative.

Digital encoder 408 converts the thermometer code logic level information received from comparator bank 407 into 8-bit binary output, which is the digital signal DRGB. Digital encoder 408 may include error correction to prevent discrepancies between course and fine information. In some embodiments, ADC 308 has four (4) clock cycles of latency.

FIG. 4b shows an embodiment of reference generator 402. Reference generator 402 in FIG. 4b includes a polysilicon resistor ladder 420 coupled so that a top terminal has voltage labeled REF_P(36), and a bottom terminal has voltage labeled REF_P(0). Polysilicon resistor ladder 420 outputs a series of differential reference signals REF(0:N−1) for use in a thermometer code. In general, any number of voltage levels between REF_P(36) and REF_P(0) can be generated. In the embodiment shown in FIG. 4b, polysilicon resistor ladder 420 generates 37 ladder voltage levels labeled REF_P(0) through REF_P(36) (REF_P(0:36)), however in general N+1 ladder voltage levels can be generated where N is a selected integer. The single-ended voltage input V_{REF} generated by digital-to-analog converter 302 (FIG. 3) is input to circuit 421 in reference generator 402. Circuit 421 is coupled to the bottom terminal of polysilicon resistor ladder 420. A common mode voltage V_{CM} is coupled to circuit 422. Circuit 422, in turn, is coupled to the top terminal of polysilicon resistor ladder 420. The common-mode voltage can be generated using a diode connected transistor coupled to the negative supply resulting in an approximate voltage of 1 volt. Circuits 422, 421 and 420 are arranged so that REF_P(18) corresponds to V_{CM}. In general, voltage level N/2 will correspond to the common mode voltage V_{CM}.

For each of the N levels in the series of voltage levels that determine the thermometer code, a voltage REF_P^{(j)} and its complement around the common mode voltage REF_N^{(j)} are generated, where j indicates one of the voltage differences in the series. In FIG. 4b, the reference levels REF_P(0:36) (denoting collectively signals REF_P(0) through REF_P(36)) are input to circuit 423. Circuit 423 generates differential voltage levels REF_P(0:35) and REF_N(0:35). In the embodiment shown in FIG. 4b, REF_N(0)=REF_P(36) and REF_N(35)=REF_N(1). The differential signals are formed from complementary pairs around REF_P(18) (i.e., REF_N(17)=REF_P(19); REF_N(16)=REF_P(20); REF_N(0)=REF_P(36-j)) The differential reference signals REF(0:N−1) are output by reference generator 402.

In general, the average of REF_P^{(j)} and REF_N^{(j)} is V_{CM}, the common mode voltage. In some embodiments, for example, V_{REF} is about 1.0 volts and V_{CM} is about 1.5 V. With N being about 36, then the 250 mV difference between 1.5V and 1.75 volts is divided into about 14.0 mV levels. The 36 differential levels range from about −250 mV to about 250 mV with REF_P(0)-REF_N(0)=−250 mV and REF_P(35)-REF_N(35)=250 mV. Additionally, REF_P(18)-REF_P(18)=0 mV.

FIG. 5 shows a simplified sample and hold amplifier (SHA) 306. SHA 306 can accept either a fully differential or pseudo differential input signal. Utilization in a graphics digitizer dictates a single ended input. However, as was previously discussed, V_{Bias} is generated to provide complimentary pseudo differential input and to enable an offset adjustment. The embodiment of SHA 306 shown in FIG. 5 is a non-reset phase SHA design. The non-reset design lends itself to high-speed performance since in a non-reset phase design, the differential output slews between successive sampled levels during the entire clock period. Therefore, preamp bank 403 (FIG. 4) and the folded signals from folds 404 and 405 have one complete clock cycle to settle before they are latched by strobed comparators in comparator bank 407. As a result, some embodiments of SHA 306 allow greater than 8-bits of linearity for analog input frequencies through the baseband (Fs/2=100 MHz) and has a typical analog full power bandwidth of 500 MHz.

The embodiment of sample-and-hold block 306 shown in FIG. 5 includes operational amplifier 501 and inputs the analog signals RGB and V_{Bias}. Additionally, a common mode signal V_{CM} may be received in order to keep the RGB and V_{Bias} signals from floating. The signal V_{CM} can be an internally generated bias voltage and determines the average voltage at the input to SHM 306. In one embodiment, V_{CM} is approximately 1.0 V, depending on power supply voltage and temperature. In some embodiments, the common mode voltage V_{CM} is the same as the common mode voltage of reference generator 402.

During a first clock cycle, switches 510-517 are closed and switches 518-525 are open. Capacitor 502, then, averages the difference between the RGB and V_{CM} signals and capacitor 505 averages the difference between the V_{CM} and V_{Bias} signals. Additionally, the signal stored on capacitor 502 is coupled to the negative input terminal of operational amplifier 501 and the signal stored on capacitor 503 is coupled to the positive input terminal of operational amplifier 501.

During the next clock cycle, switches 510-517 are open and switches 518-525 are closed. Then, capacitor 503 averages the difference between the RGB and V_{CM} signals and capacitor 504 averages the difference between the V_{CM} and V_{Bias} signals. Additionally, the signal stored on capacitor 502 is coupled to the negative input of differential amplifier 501 and the signal stored on capacitor 505 is coupled to the positive terminal of operational amplifier 501.

Sample-and-hold block 306 introduces a latency of one clock cycle (i.e., signals received during a first clock cycle are presented to amplifier 501 during the next following clock cycle). As capacitors 502 and 505 are sampling a signal, signals stored on capacitors 503 and 504 are input to operational amplifier 501. Conversely, as capacitors 503 and 504 are sampling a signal, signals stored on capacitors 502 and 505 are input to operational amplifier 501. Capacitors 506 through 509 are coupled to provide feedback for operational amplifier 501. Additionally, from the time the signal is sampled by one set of capacitors (i.e., capacitors 502 and 505 or by capacitors 503 and 504) to the time that comparators in comparator bank 407 makes a decision is one cycle. The differential output of operational amplifier 501, InN and InP, collectively referred to as differential input signal In, is input to pre-amp bank 403 (FIG. 4).

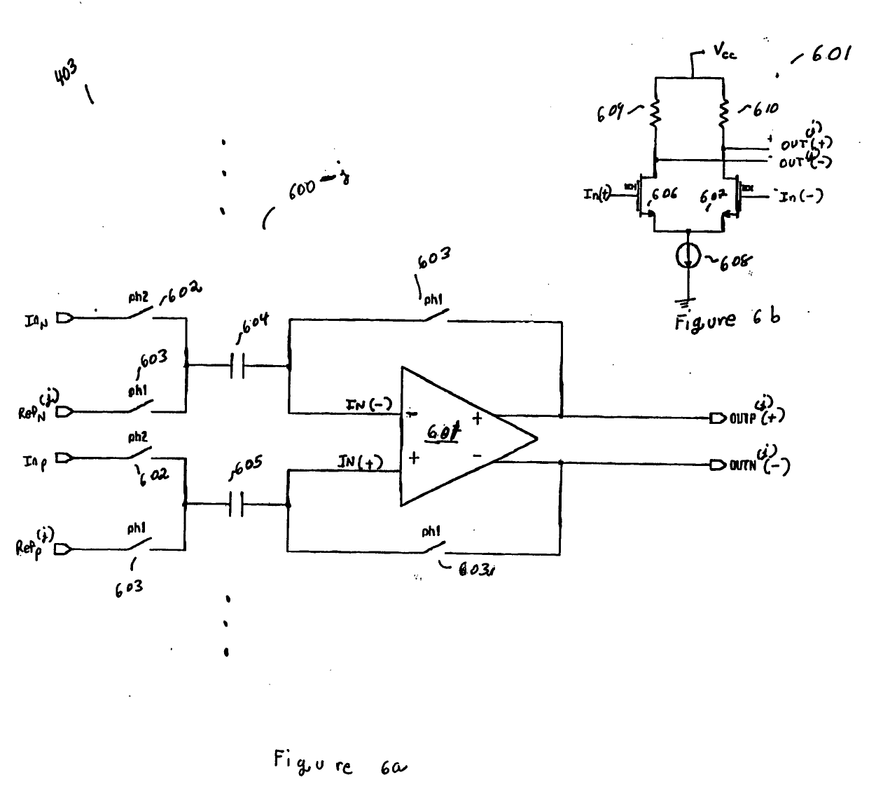

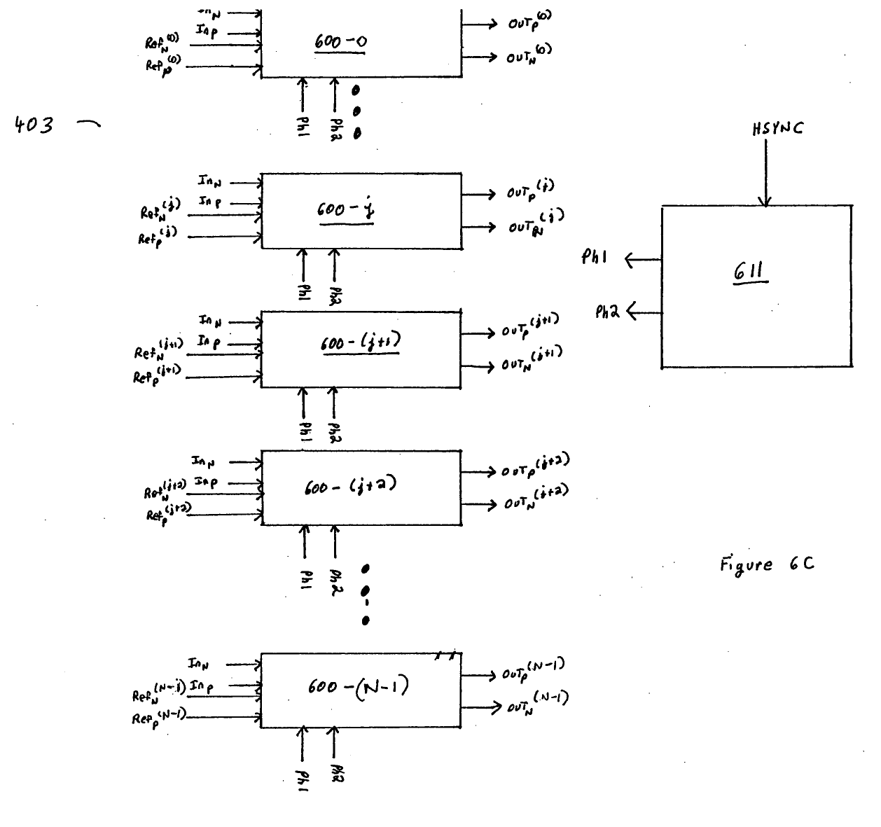

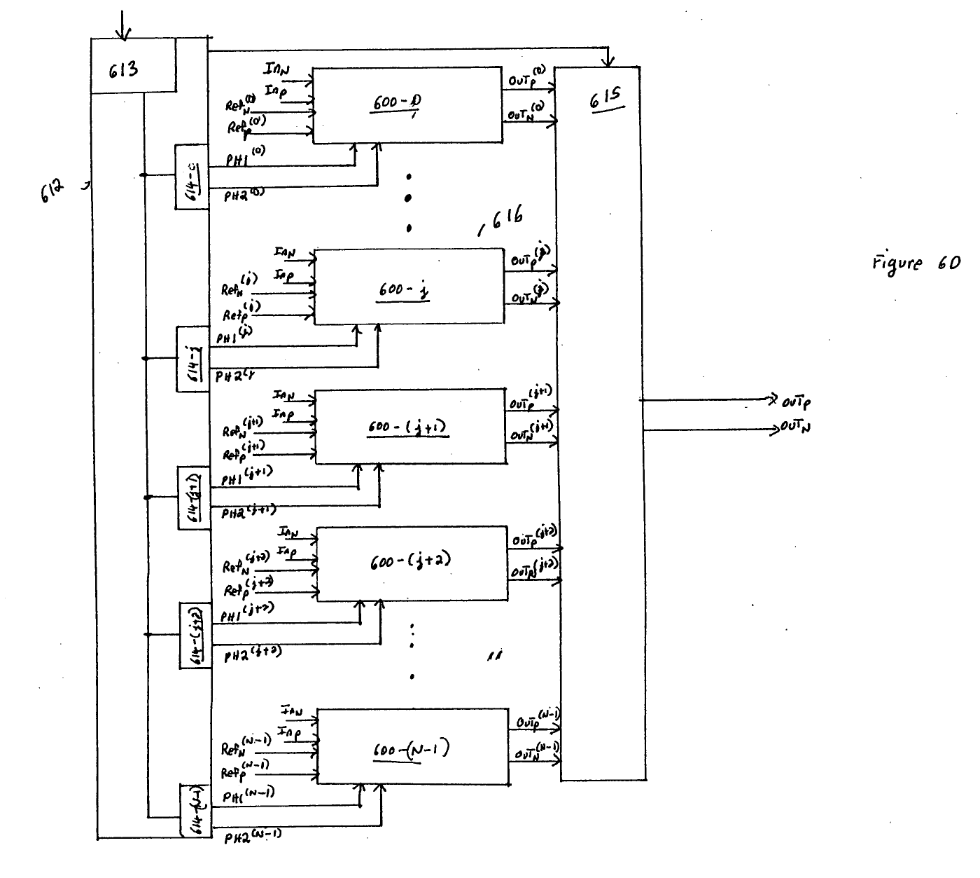

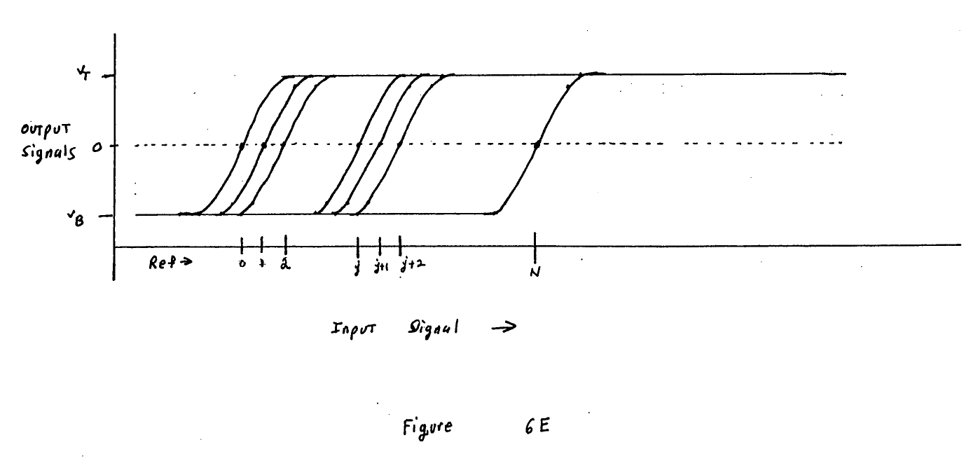

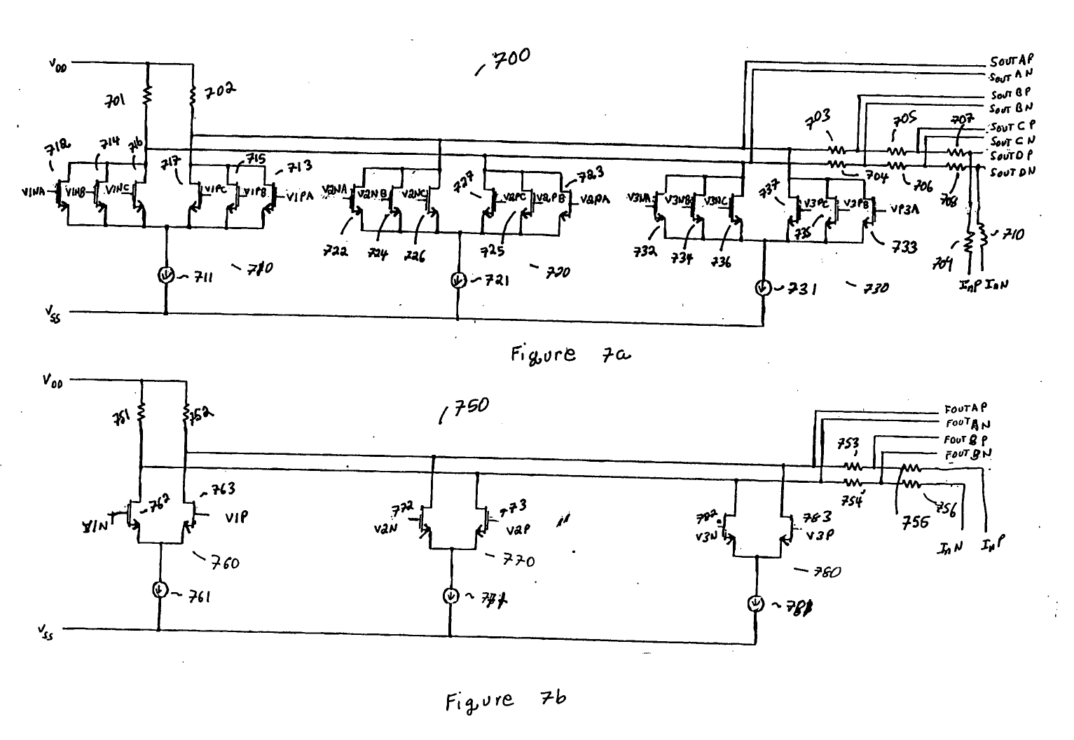

The amplifiers in offset canceled subranging pre-amp bank 403 can be implemented using simple open loop resistively loaded differential amplifiers and switch capacitor techniques that are well known to one skilled in the art. FIG. 6a shows a simplified schematic of pre-amp cell 600-j, which is the jth pre-amp cell of pre-amp bank 403 where 1≦j≦N where N is the total number of pre-amp cells in bank 403 and the number of reference level differential signals supplied by reference generator 402. In one embodiment, N=36.

In FIG. 6a, when switches 602 are closed (and switches 603 are open), input signals InN and Inp are presented to a differential amplifier 601. When switches 603 are closed (and switches 602 are open), differential reference signal REF(j) is presented to the output terminals of differential amplifiers 601. Differential input signal In (In_{N} and In_{P}) and differential reference signal REF^{(j)} (REF_N^{(j)}, and REF_P^{(j)}) are AC coupled to the input terminals of differential amplifier 601 through capacitors 604 and 605.

FIG. 6b shows an embodiment of differential amplifier 601. In FIG. 6b, differential amplifier 601 includes two matched transistors 606 and 607 with drains coupled through a constant current source 608 to a ground voltage and sources coupled through resistors 609 and 610, respectively, with a supply voltage V_{cc}. The gates of transistors 606 and 607 provide the positive and negative inputs of differential amplifier 601. Additionally, the sources of transistors 606 and 607 provide the negative and positive outputs of differential amplifier 601.

In some embodiments, pre-amp bank 403 is offset canceled (i.e., blanked) by shorting differential amplifier 601 (FIG. 6a) feedback and coupling the inputs to a respective differential reference voltage REF^{(j)} by closing switches 603. A differential reference voltage is then created across capacitors 604 and 605. Any offsets resulting from transistor mismatch or resistor mismatch in differential amplifier 601 is then added or subtracted from the stored differential reference level accordingly, and therefore canceled during a subsequent compare/amplify mode (i.e. opening switches 603 and closing switches 602). The effective offset is reduced by a factor equal to the gain of differential amplifier 601. In one embodiment, the gain of differential amplifier 601 is 5. In that embodiment, the effective offset is equivalent to that of an input device 25 times larger. Another advantage of this offset cancellation technique is that it allows the differential reference voltages REF^{(j)} to be developed across the capacitors, eliminating the need for continuous time differential difference amplifiers.

The offset cancellation is undertaken periodically by opening switches 602 (PH2) and by closing switches 603 (PH1). FIG. 6C shows a block diagram of pre-amp bank 403 with one embodiment of offset cancellation and reset. As shown in FIG. 6A, pre-amp bank 403 includes N pre-amps 600-0 through 600-(N−1). Each of pre-amps 600-0 through 600-(N−1) inputs a PH1 and PH2 signal which controls whether switches 603 of pre-amps 600-0 through 600-(N−1) or switches 602 of pre-amps 600-0 through 600-(N−1) are closed. For example, if the PH1 signal is active switches 603 of pre-amps 600-0 through 600-(N−1) are closed and if the PH2 signal is active switches 602 of pre-amps 600-0 through 600-(N−1) are closed. A block 611 in FIG. 6C determines the signals PH1 and PH2. In FIG. 6C, pre-amps 600-0 through 600-(N−1) are reset (i.e., PH2 is inactive and PH1 is active) at the end of each line. Therefore, PH1 is set active and PH2 is set inactive in response to the HSYNC signal indicating the end of the line. Resetting pre-amps 600-0 through 600-(N−1) at the end of each line avoids the problem of video flashing when pre-amps are reset during the visible portion of the data display.

FIG. 6D shows a block diagram of pre-amp bank 403 having an alternative embodiment for resetting pre-amps 600-0 through 600-(N−1). The embodiment shown in FIG. 6d is more adaptable to applications of ADC 308 outside that of a graphics digitizer. Each of pre-amps 600-0 through 600-(N−1) receives signals PH1⁽⁰⁾ and PH2⁽⁰⁾ through PH1(N−1) and PH2(N−1), respectively. Individual signals PH1⁽⁰⁾ through PH1^{(N-1)} and PH2⁽⁰⁾ through PH2(N−1) are determined by a control block 612. Control block 612 resets individual ones of pre-amps 600-0 through 600-(N−1) at random intervals. Additionally, not all of pre-amps 600-0 through 600-(N−1) are being reset at the same time. Also, each of pre-amps 600-0 through 600-(N−1) are not reset with any readily identifiable frequency or pattern. In some embodiments, control block 612 includes a random number generator 613 and determination blocks 614-0 through 614-(N−1). Determination blocks 614-0 through 614-(N−1) receive a random number from random number generator and, depending on the random number, determines the values of signals PH1⁽⁰⁾ and PH2⁽⁰⁾ through PH1^{(N-1)} through PH2^{(N-)}, respectively. In one example, the range of random numbers may be divided into N or more sub-ranges and each of determination blocks 614-0 through 614-(N−1) may reset its respective pre-amp 600-0 through 600-(N−1), respectively, if the random number generated by random number generator 613 falls within that range. In some embodiments, random number generator 613 generates a new random number on each SCK clock signal. The random resetting of various ones of pre-amps 600-0 through 600-(N−1) lessens the visible effects of pre-amp blanking on a digital display. In general, the output signals from pre-amps 600-0 through 600-(N−1) can be coupled to a multiplexer 615 so that only pre-amps which are coupled to receive input signals InN and Inp are coupled to provide output signals of pre-amp array bank 403. For example, if during a clock cycle k pre-amp 600-j is being blanked (i.e., PH1^{(j)} is active and PH2^{(j)} is inactive) while the remaining pre-amps are coupled to the inputs In_{N} and In_{P} then the output signal from pre-amp 600-j is not output from pre-amp bank 403. In general, any number of pre-amps 600-0 through 600-(N−1) can be blanked during any clock cycle. The output signals OUTP(0) and OUTN(0) through OUTP(N−1) and OUTN(N−1) are input to multiplexer 615. Multiplexer 615 outputs signals from active ones of pre-amps 600-0 through 600-(N−1), i.e. those that are not being blanked during the clock cycle.

In some embodiments, pre-amps 600-0 through 600-(N−1) may be grouped with a first number of pre-amps in the group being reset and the remaining pre-amps in the group being coupled to the input signals In_{N} and In_{P}. In FIG. 6D, for example, pre-amps 600-j, 600-(j+1) and 600-(j+2) may form one group of three pre-amps 616. In general, a group of pre-amps may include any number of pre-amps. In this arrangement, each of pre-amps 600-0 through 600-(N−1) belongs to one group of pre-amps. Controller 612 arranges that selected pre-amps from each group are blanked during any given clock cycle. For example, in group 616 during a clock cycle k pre-amp 600-(j+1) may be blanked while pre-amps 600-j and 600-0+2) are active. In that case, signals out_{P} and out_{N} from multiplexer 615 includes output signals from pre-amps 600-j and 600-0+2) but not from pre-amp 600-0+1).

The differential output signals from pre-amps 600-0 through 600-(N−1), OUT(0:N−1), respectively, which are input to the remainder of the analog-to-digital converter, indicate the level of the input signals In_{N} and In_{P}. For a differential input signal In (collectively In_{N} and In_{P}) within a central portion (i.e. not at the edge) of the range of reference signals REF(0:N−1) (collectively REF_{N}⁽⁰⁾ and REF_{P}⁽⁰⁾ through REF_{N}^{(N-1)} and REF_{N}^{(N-1)}, some of pre-amps 600-0 through 600-(N−1) have a saturated negative output, some of pre-amps 600-0 through 600-(N−1) have a saturated positive output. Where differential input signal In is close to differential signal REF^{(j)}, the output signals from pre-amps around pre-amp 600-j will have intermediate values. For an arbitrary differential input signal In within the range of analog-to-digital converter 308, pre-amps 600-0 through 600-(N−1) having reference levels REF(0:N−1) outside of a range around signal In will be saturated either positive or negative depending on whether the pre-amp represents reference levels above or below the input levels and a number of pre-amps having reference levels near the signal In will have roughly monotonically varying values between the positive and negative saturation levels.

FIG. 6E shows graphically the output signals OUT(0:N−1) from pre-amps 600-0 through 600-(N−1) as the differential input signal, In, increases through the reference signals REF⁽⁰⁾ through REF^{(N-1)}. As the differential input signal In increase, sequential ones of the output signals from pre-amps 600-0 through 600-(N−1), OUT(0:N−1), respectively, pass through the intermediate range having varying values between the negative and positive saturation levels, indicating a narrowing of the range of possible values for differential input signal In. Pre-amps 600-0 through 600-(N−1), in turn, make transitions from a lower saturation level V_{B} to an upper saturation level V_{T}, although several pre-amps at any location have output signals intermediate between a saturated low and a saturated high. A zero-crossing analysis of signals from pre-amps 600-0 through 600-(N−1) yielding intermediate results is then utilized to focus the value of the input signal In.

FIG. 7a shows an embodiment of one sub-block 700 of folding block 404 (FIG. 4). Block 404 includes any number of sub-blocks such as sub-block 700, for example in some embodiments folding block 404 may include twelve (12) of sub-block 700. Sub-block 700 includes amplifiers 710, 720 and 730 coupled between power supply voltage VDD and ground V_{SS} through resistors 701 and 702. Amplifier 710 includes transistor pairs 712 and 713, 714 and 715, and 716 and 717. Transistors 712, 714 and 716 each have a source coupled through resistor 701 to supply voltage V_{DD} and a drain coupled through constant current source 711 to ground V_{SS}. Transistors 713, 715 and 717 have a source coupled through resistor 702 to supply voltage V_{DD} and a drain coupled through constant current source 711 to ground V_{SS}. The gates of each pair of transistors is coupled to receive a differential signal from pre-amp array 403: Differential signal V1A (collectively V1NA and V1PA) is coupled to the gates of transistors 712 and 713, respectively; Differential signal V1B (collectively V1NB and V1PB) is coupled to the gates of transistors 714 and 715, respectively; and Differential signal V1C (collectively V1NC and V1PC) is coupled to the gates of transistors 716 and 717, respectively. Differential signals V1A, V1B and V1C are then voltage averaged by amplifier section 710.

Amplifier element 720 includes three pairs of transistors 722 and 723, 724 and 725, and 726 and 727, each pair coupled to receive a differential input signal: Signal V2A (collectively V2NA and V2PA) is coupled to the gates of transistors 722 and 723, respectively; Signal V2B (collectively V2NB and V2PB) is coupled to the gates of transistors 724 and 725, respectively; and Signal V2C (collectively V2NC and V2PC) is coupled to the gates of transistors 726 and 727, respectively. The sources of transistors 722, 724 and 726 are coupled to the sources of transistors 713, 715 and 717, the sources of transistors 723, 725 and 727 are coupled to the sources of transistors 712, 714 and 716, and the drains of transistors 722, 723, 724, 725, 726 and 727 are coupled through constant current source 721 to ground V_{SS}. Signals V2A, V2B and V2C are averaged by amplifier section 720 and folded into the average of V1A, V1B and V1C.

Amplifier section 730 includes transistor pairs 732 and 733, 734 and 735, and 736 and 737, each pair coupled to receive a differential input signal: Signal V3A (collectively V3NA and V3PA) is received at the gates of transistors 732 and 733, respectively; Signal V3B (collectively V3NB and V3PB) is received at the gates of transistors 734 and 735, respectively; and Signal V3C (collectively V3NC and V3PC) is received at the gates of transistors 736 and 737, respectively. The sources of transistors 732, 734 and 736 are coupled to the sources of transistors 712, 714 and 716, the sources of transistors 733, 735 and 737 are coupled to the sources of transistors 713, 715 and 717, and the drains of transistors 732, 733, 734, 735, 736 and 737 are coupled through constant current source 731 to ground V_{SS}. Signals V3A, V3B and V3C are therefore averaged and the result is folded into the folding from amplifier elements 710 and 720.

Folding sub-block 700, in some embodiments, can output four differential signals, Sₒᵤₜ,A (collectively SₒᵤₜAP and SₒᵤₜAN), SₒᵤₜB (collectively SₒᵤₜBP and SₒᵤₜBN), SₒᵤₜC (collectively SₒᵤₜCP and SₒᵤₜCN) and SₒᵤₜD (collectively SₒᵤₜDP and SₒᵤₜDN). These signals include a signal from active voltage interpolation, SₒᵤₜA, plus three signals from resistive interpolation. Signal SₒᵤₜA represents the averaging and folding from amplifiers 710, 720 and 730 described above. The interpolating resistors also serve as averaging to further reduce offset effects. Signal SₒᵤₜAP is the signal at the sources of transistors 713, 715 and 717 and signal SₒᵤₜAN is the signal at the sources of transistors 712, 714 and 716. A first terminal of resistor 703 is coupled to the sources of transistors 713, 715 and 717 and a first terminal of resistors 704 is coupled to the sources of transistors 712, 714 and 716. Signal SₒᵤₜBP is the signal at the second terminal of resistors 703 and the signal SₒᵤₜBN is the signal at the second terminal of resistor 704. A first terminal of resistor 705 is coupled to the second terminal of transistor 703 and a first terminal of resistor 706 is coupled to the second terminal of resistor 704. Signal SₒᵤₜCP is the signal at the second terminal of resistor 705 and signal SₒᵤₜCN is the signal at the second terminal of resistor 706. Furthermore, a first terminal of resistor 707 is coupled to the second terminal of resistor 705 and a first terminal of resistor 708 is coupled to the second terminal of resistor 706. Signal SₒᵤₜDP is the signal at the second terminal of resistor 707 and signal SₒᵤₜDN is the signal at the second terminal of resistor 708.

One skilled in the art will recognize that further signals can be generated by cascading further resistors with resistors 703, 705 and 707 and with resistors 704, 706 and 708. Furthermore, amplifier sections 710, 720 and 730 may include any number of pairs of transistors and therefore may input any number of differential input signals.

A first terminal of resistor 709 is coupled to the second terminal of resistor 707 and a first terminal of resistor 710 is coupled the second terminal of resistor 708. The second terminals of resistors 709 and 710 forms a differential interconnect terminal of sub-block 700 which is coupled to receive on of the differential output signals (e.g. SₒᵤₜA) of one of the other sub-blocks in folder 404.

Folding sub-block 700 includes voltage averaging of input signals. In one embodiment, three adjacent levels of signals from pre-amp array 403 are shared by one differential amplifier element in folding sub-block 700, creating active interpolation on the input. This results in effectively averaging the offsets of the three paralleled amplifier elements 710, 720 and 730.

FIG. 7C shows folding block 404 coupled to folding block 405. Folding block 404 includes Q folding sub-blocks 700-0 through 700-Q, each of folding sub-blocks 700-0 through 700-Q being similar to folding sub-block 700 of FIG. 7A. Folding sub-blocks 700-0 through 700-Q input differential signals V1A-0, V1B-0, V1C-0, V2A-0, V2B-0, V2C-0, V3A-0, V3B-0, and V3C-0 through V1A-Q, V1B-Q, V1C-Q, V2A-Q, V2B-Q, V2C-Q, V3A-Q, V3B-Q, and V3C-Q, respectively. Additionally, folding sub-blocks 700-0 through 700-Q provides output signals SₒᵤₜA-0, SₒᵤₜB-0, SₒᵤₜC-0, and SₒᵤₜD-0 through SₒᵤₜA-Q, SₒᵤₜB-Q, SₒᵤₜC-Q, and SₒᵤₜD-Q, respectively.

In one embodiment, Q is eleven (11) and folding block 404 has twelve (12), 3×sub-blocks staggered by 1/12 across the transfer function. The four output signals from each of sub-blocks 700-0 through 700-11 provides 48 differential 3X folding signals from folding block 404. In some embodiments, folding block 404 provides an additional 2X gain to the fine LSB levels. Additionally, since there are nine differential inputs for each of the twelve folding sub-blocks, there are 108 input signals to sub-blocks 700-0 through 700-11 of folding block 404. Pre-amp array 403, in some embodiments, provides 36 differential signals (signals OUT(0:35)). In some embodiments, each amplifier array 710, 720 and 730 (see FIG. 7A) inputs sequential ones of the 36 differential signals from pre-amp array 403, which are staggered across sub-blocks 700-0 through 700-11. Table 1 shows a mapping of one embodiment of the 36 signal inputs (signals OUT(0:35)) from an embodiment of pre-amp array 403 to sub-blocks 700-0 through 700-11 of folding block 404. The signal inputs to V1A-0, V1B3-0, V1C-0 and V3A-11, V3B-11, and V3C-11 are arranged to mitigate edge effects.

TABLE 1

| | V1A | V1B | V1C | V2A | V2B | V2C | V3A | V3B | V3C |
|---|---|---|---|---|---|---|---|---|---|
| 700-0 | 0 | 0 | 1 | 11 | 12 | 13 | 23 | 24 | 25 |
| 700-1 | 0 | 1 | 2 | 12 | 13 | 14 | 24 | 25 | 26 |
| 700-2 | 1 | 2 | 3 | 13 | 14 | 15 | 25 | 26 | 27 |
| 700-3 | 2 | 3 | 4 | 14 | 15 | 16 | 26 | 27 | 28 |
| 700-4 | 3 | 4 | 5 | 15 | 16 | 17 | 27 | 28 | 29 |
| 700-5 | 4 | 5 | 6 | 16 | 17 | 18 | 28 | 29 | 30 |
| 700-6 | 5 | 6 | 7 | 17 | 18 | 19 | 29 | 30 | 31 |
| 700-7 | 6 | 7 | 8 | 18 | 19 | 20 | 30 | 31 | 32 |
| 700-8 | 7 | 8 | 9 | 19 | 20 | 21 | 31 | 32 | 33 |
| 700-9 | 8 | 9 | 10 | 20 | 21 | 22 | 32 | 33 | 34 |
| 700-10 | 9 | 10 | 11 | 21 | 22 | 23 | 33 | 34 | 35 |
| 700-11 | 10 | 11 | 12 | 22 | 23 | 24 | 34 | 35 | 35 |

As can be seen from Table 1, in sub-block 700-1, for example, signals OUT(0), OUT(1) and OUT(2) are averaged and folded into the negative of the average of signals OUT(12), OUT(13) and OUT(14) and folded into the average of signals OUT(24), OUT(25), and OUT(26). The output signals of pre-amp 403 OUT(0:35) are similarly cycled through the other ones of sub-blocks 700-0 through 700-11.

FIG. 7b shows a block diagram of an embodiment of one sub-block 750 of a second folding block 405. Folding sub-block 750 does not use active voltage interpolation on its input and relies on resistive interpolation. Folding sub-block 750 includes three amplifier elements 760, 770 and 780. Each of the three amplifier elements includes one pair of transistors: amplifier element 760 includes transistors 762 and 763; amplifier element 770 includes transistors 772 and 773; and amplifier element 780 includes transistors 782 and 783. Each pair of transistors is coupled to receive a differential signal: signal V1N is received at the gate of transistors 762 and signal V1P is received at the gate of transistor 763; signal V2N is received at the gate of transistor 772 and signal V2P is received at the gate of transistor 773; and signal V3N is received at the gate of transistor 782 and signal V3P is received at the gate of transistor 783. As such, transistor pair 762 and 763 receives the differential signal V1 (collectively V1N and V1P), transistor pair 772 and 773 receives the differential signal V2 (collectively V2N and V2P), and transistor pair 782 and 783 receives the differential signal V3 (collectively V3N and V3P).

The sources of transistors 762, 772 and 782 are coupled through resistor 751 to a power supply voltage V_{DD}. The sources of transistors 763, 773 and 783 are coupled through resistor 752 to power supply voltage V_{DD}. The drains of transistors 762 and 763 are coupled through constant current source 761 to a ground voltage V_{SS}. Similarly, the drains of transistors 772 and 773 are coupled through constant current source 771 to the ground voltage V_{SS} and the drains of transistors 782 and 783 are coupled through constant current source 781 to the ground voltage V_{SS}.

Sub-block 750 provides two differential outputs FₒᵤₜA (collectively FₒᵤₜAN and FₒᵤₜAP) and FₒᵤₜB (collectively FₒᵤₜBN and FₒᵤₜBP). Signal FₒᵤₜAP is the signal at the sources of transistors 763, 773 and 783 and FₒᵤₜAN is the signal at the sources of transistors 762, 772 and 782. A first terminal of resistor 753 is coupled to the sources of transistors 763, 772 and 783 and a first terminal of resistor 754 is coupled to the sources of transistors 762, 773 and 782. Signal FₒᵤₜBP is the signal at the second terminal of resistor 753 and signal FₒᵤₜBN is the signal at the second terminal of resistor 754. A first terminal of resistor 755 is coupled to the second terminal of resistor 753 and a first terminal of resistor 756 is coupled to the second terminal of resistor 754. The second terminals of resistors 755 and 756 form an interconnect coupling terminal for receiving an input signal corresponding to an output signal from one of the other sub-blocks in folder 405. Again, the resistive interpolation also serves as averaging to reduce offsets referred back to the input of the second 3X folding block.

One skilled in the art will recognize that sub-block 750 may have any number of amplifier elements (i.e., may be any integer folder) and a 3X folder is shown here for example only. Additionally, any number of resistively interpolated folding signals can be provided by sub-block 750 by continuously cascading further resistors.

FIG. 7C shows a folding block 405 having folding sub-blocks 750-0 through 750-P. In some embodiments, each of sub-blocks 750-0 through 750-P is sub-block 750 shown in FIG. 7B. The input signals to sub-blocks 750-0 through 750-P—V1-0, V2-0, and V3-0 through V1-P, V2-P, and V3-P, respectively—are derived from the output signals of sub-blocks 700-1 through 700-Q—SₒᵤₜA-1, SₒᵤₜB-1, SₒᵤₜC-1, and SₒᵤₜD-1 through SₒᵤₜA-Q, SₒᵤₜB-Q, SₒᵤₜC-Q, and SₒᵤₜD-Q, respectively. Sub-blocks 760-0 through 750-P output signals FₒᵤₜA-0 and FₒᵤₜB-0 through FₒᵤₜA-P and FₒᵤₜB-P in embodiments with two outputs per sub-block. In some embodiments, more output signals may be generated by sub-blocks 760-0 through 750-P. These output signals can be relabeled Fₒᵤₜ(0:2P+1) where each of the signals F_{OUT}(0:2P+1) corresponds to one of the output signals of sub-blocks 760-0 through 750-P.

In some embodiments, P is 15 so that folding block 405 has 16 sub-blocks staggered by 1/16 across the transfer function. Each of the 16 sub-blocks 750-0 through 750-11 outputs one output from the amplifier sections FₒᵤₜA-0 through FₒᵤₜA-11, respectively, and one output from the resistive interpolations FₒᵤₜB-0 through FₒᵤₜB-11, respectively, providing for 32 output signals. The 32 output signals can be labeled F_{OUT}(0:31) with F_{OUT}(2k) being F₀utA-k and F_{OUT}(2k+1) being FₒᵤₜB-k for k=0 to 11. The input signals to each of sub-blocks 750-0 through 750-15 are obtained from the output signals of folding sub-blocks 700-0 through 700-11 of folding block 404 as indicated in Table 2.

TABLE 2

| sub-block | V1 | V2 | V3 |
|---|---|---|---|
| 750-0 | SₒᵤₜA-0 | SₒᵤₜA-4 | SₒᵤₜA-8 |
| 750-1 | SₒᵤₜB-0 | SₒᵤₜB-4 | SₒᵤₜB-8 |
| 750-2 | SₒᵤₜC-0 | SₒᵤₜC-4 | SₒᵤₜC-8 |
| 750-3 | SₒᵤₜD-0 | SₒᵤₜD-4 | SₒᵤₜD-8 |
| 750-4 | SₒᵤₜA-1 | SₒᵤₜA-5 | SₒᵤₜA-9 |
| 750-5 | SₒᵤₜB-1 | SₒᵤₜB-5 | SₒᵤₜB-9 |
| 750-6 | SₒᵤₜC-1 | SₒᵤₜC-5 | SₒᵤₜC-9 |
| 750-7 | SₒᵤₜD-1 | SₒᵤₜD-5 | SₒᵤₜD-9 |
| 750-8 | SₒᵤₜA-2 | SₒᵤₜA-6 | SₒᵤₜA-10 |
| 750-9 | SₒᵤₜB-2 | SₒᵤₜB-6 | SₒᵤₜB-10 |
| 750-10 | SₒᵤₜC-2 | SₒᵤₜC-6 | SₒᵤₜC-10 |
| 750-11 | SₒᵤₜD-2 | SₒᵤₜD-6 | SₒᵤₜD-10 |
| 750-12 | SₒᵤₜA-3 | SₒᵤₜA-7 | SₒᵤₜA-11 |
| 750-13 | SₒᵤₜB-3 | SₒᵤₜB-7 | SₒᵤₜB-11 |
| 750-14 | SₒᵤₜC-3 | SₒᵤₜC-7 | SₒᵤₜC-11 |
| 750-15 | SₒᵤₜD-3 | SₒᵤₜD-7 | SₒᵤₜD-11 |

In some embodiments, the output of folding block 405, therefore, is 32, 9X folding signals which are presented to comparator bank 407 (FIG. 4) as the fine information. In some embodiments, folding block 405 provides an additional 2X gain to the fine LSB levels. The total gain, combining a 2X gain of one embodiment of folding block 404 and a 5×gain of one embodiment of pre-amp array 403, is 20. Therefore the 4 mV LSB is gained up to 80 mV by the time it is presented to strobed comparator block 407. The 32 folded signals output (labeled Fₒᵤₜt(0:31)) from folding block 405 in embodiments where Q=11 and P=15 are shown in FIG. 7d.

FIG. 7d shows a plot of the 32 folded output signals from folding block 405 for an embodiment where Q=1 and P=15 as a function of increasing values of the differential input signal In through the range of ADC 308. The output signals are 8X folded and therefore have 8 zero crossings, each defining a region in the range of ADC 308. Given a particular set of 32 folded output signals corresponding to one differential input signal In, a subsequent comparator can determine which of the folded output signals are above or below zero, locating signal In within a region, but can not necessarily determine which region of the range is currently being measured. As can be seen from FIG. 4a, a number of output signals from pre-amp 403 are input to course pre-amp 406. The output signals from course pre-amp 406 can be later utilized to determine which region of the range is active.

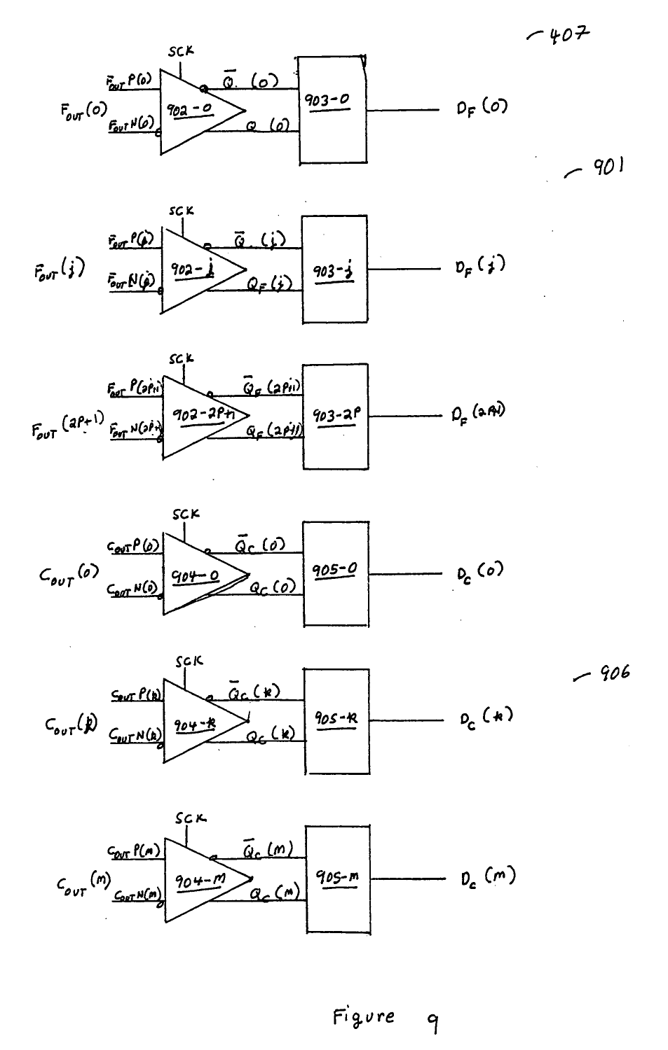

FIG. 8 shows an embodiment of course pre-amp 406. Pre-amp 406 includes pre-amp array 800 having differential amplifiers 801-0 through 801-M. Each of differential amplifiers 801-0 through 801-M inputs differential signals C_{IN}(0) (collectively C_{IN}P(0) and C_{IN}(0)) through C_{IN}(M) (collectively (C_{IN}P(M) and C_{IN}(M)), respectively, and outputs an amplified differential signal C_{OUT}(0) (collectively C_{OUT}N(0) and C_{OUT}P(0)) through C_{OUT}(M) (collectively (C_{OUT}N(M) and C_{OUT}P(M)), respectively. The input signals C_{IN}(0) through C_{IN}(M) correspond to selected ones of the output signals OUT(0:35) from pre-amp bank 403. In one embodiment, M is 7 and C_{IN}(0) through C_{IN}(7) correspond to output signals OUT(6), OUT(10), OUT(14), OUT(18), OUT(22), OUT(26), and OUT(30), respectively, which correspond to one differential reference signal within each region of the range of ADC 308.

In some embodiments, course pre-amp 406 of FIG. 4, uses a straightforward flash implementation. The seven level differential thermometer information is taken directly from preamp bank 403 (every fourth preamp, for example) evenly dividing the full-scale range into eight regions. One additional preamp gain stage is inserted before the differential zero crossing information is latched into the strobed comparators of comparator bank 407. The seven digital logic levels are passed into digital encoder 408 for processing.

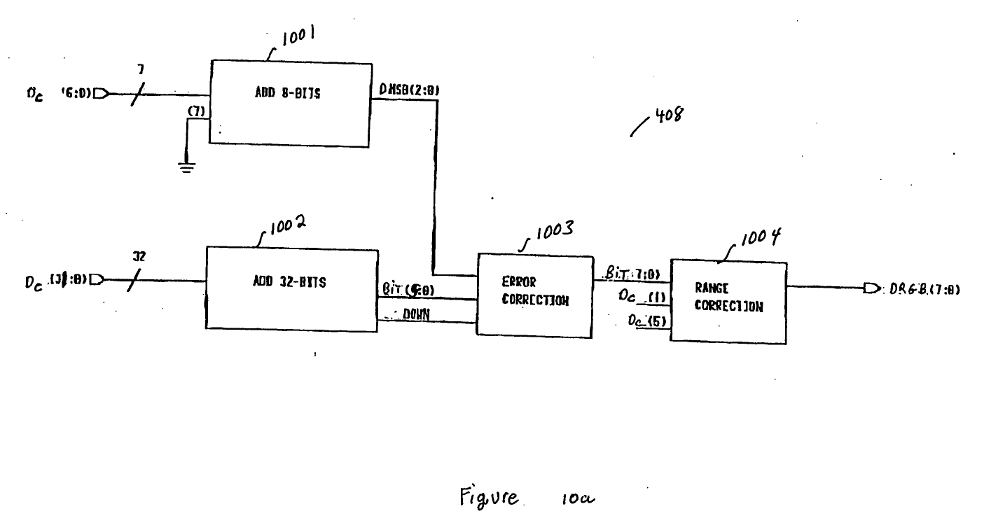

FIG. 9 shows an embodiment of camparator 407. Comparator 407 includes a fine portion 901 and a course portion 906. Fine portion 901 includes strobed comparators 902-0 through 902-(2P+1), where each of sub-blocks 760-0 through 760-P generates two output signals. Each of comparators 902-0 through 902-(2P+1) receives one of differential signals F_{OUT}(0:2P+1) from folding block 405 (FIG. 4). Each of comparators 902-0 through 902-(2P+1), in response to the SCK clock signal, outputs a value Q_{F}(0) through Q_{F}(2P+1), respectively, and its complement \overline{Q}_{F}(0) through \overline{Q}_{F}(2P+1), respectively. In some embodiments, value Q_{F}(j), which is an arbitrary one of values Q_{F}(0) thorugh Q_{F}(2P+1), is a logic high if differential signal Fₒᵤₜ(j) is positive (i.e., Fₒᵤₜ(j) is greater than Fₒᵤₜ(j)) and is a logic low if differential signal Fₒᵤₜ(j) is negative (i.e., Fₒᵤₜ(j) is less than Fₒᵤₜ(j)). The output values Q_{F}(0) through Q_{F}(2P+1), then, indicate which of folded signals Fₒᵤₜ(0) through Fₒᵤₜ(2P+1) are positive side and which of signals Fₒᵤₜ(0) through Fₒᵤₜ(2P+1) are negative (see, e.g., FIG. 7d).

However, if signal Fₒᵤₜ(j) is near 0, then comparator 902-j may be in a metastable state (i.e., neither high or low). In some cases, comparator 902-j may freeze because it is unable to make a decision. Therefore, in some embodiments, the output signals Q_{F}(0:2P+1) and \overline{Q}_{F}(0:2P+1) are input to RS latches 903-0 through 903-(2P+1), respectively. RS latches 903-0 through 903(2P+1) output digital signals D_{F}(0:2P+1) indicating a state of input signals Fₒᵤₜ(0:2P+1), respectively. In embodiments that do not include RS latches 903-0 through 903-(2P+1), fine digital signals D_{F}(0:2P+1) corresponds to the values Q_{F}(0:2P+1), respectively.

RS latches 903-j, an arbitrary one of latches 903-0 through 903-(2P+1), is coupled to receive Q_{F}(j) and \overline{Q}_{F}(j). If comparitor 902(j) is unable to make a decision when strobed by the SCK clock signal, then Q_{F}(j) and \overline{Q}_{F}(j) will both remain low, otherwise one of Q_{F}(j) or \overline{Q}_{F}(j) is high and the other one of Q_{F}(j) or \overline{Q}_{F}(j) is low. In that case, RS latch 903-j does not change state and the output signal from latch 903-j, D_{F}(j), remains the same as it was during the previous clock cycle. Therefore, in the event that comparator 902-j can not decide whether an input Fₒᵤₜ(j) is positive or negative, the previously obtained value is utilized. If Q_{F}(j) is high and \overline{Q}_{F}(j) is low, then RS latch 903-j resets and outputs a logic 0. If Q_{F}(j) is low and \overline{Q}_{F}(j) is high, then RS latch 903-j sets and outputs a logic 1. The possibility of Q_{F}(j) being high while \overline{Q}_{F}(j) is high, an illegal operation in RS latch 903, does not occur.

In one embodiment, P is 15 so that there are 32 comparators 902-0 through 902-31 for receiving the folded signals Fₒᵤₜ(0:31). Additionally, RS latches 903-0 through 903-31 are coupled to receive the output signals Q_{F}(0:31) and Q_{F}(0:31) from comparators 902-0 through 902-31. RS latches 903-0 through 903-31 output digital signals D_{F}(0:31) which digitally indicate the state of input levels Fₒᵤₜ(0:31), respectively.

Course comparator section 906 includes strobed comparators 904-0 through 904-M coupled to latches 905-0 through 905-M, respectively. Each of comparators 904-0 through 904-M receives input signals Cₒᵤₜ(0:M), respectively, from course pre-amp 406 (FIG. 4). When strobed by clock signal SCK, comparators 904-0 through 904-M output signals Q_{C}(0) and its complement \overline{Q}_{C}(0) through Q_{C}(M) and its complement \overline{Q}_{C}(M). The output signal Q_{C}(k) from comparator 904-k, an arbitrary one of comparators 904-0 through 904-M, outputs a logic high if signal Cₒᵤₜ(k) is positive, a logic low if signal Cₒᵤₜ(k) is negative. Additionally, the complement signal \overline{Q}_{C}(k) is a logic low if Q_{C}(k) is high and a logic high if \overline{Q}_{C}(k) is low. Again, if signal Cₒᵤₜ(k) is close to zero and comparator 904-k is unable to make a decision, both Q_{C}(k) and \overline{Q}_{C}(k) will be low. RS latches 905-0 through 905-M are coupled to receive the output signals Q_{C}(0:M) and \overline{Q}_{C}(0:M), respectively, from comparators 904-0 through 904-M, respectively and outputs digital signals D_{C}(0:M), respectively. Again, if Q_{C}(k) and \overline{Q}_{C}(k) are high and low, respectively, then RS latch 904-k resets, making D_{C}(k) a logic low. If Q_{C}(k) and \overline{Q}_{C}(k) are low and high, respectively, then RS latch 904 sets, making D_{C}(k) a logic high. If comparator 904-k is unable to make a decision and Q_{C}(k) and \overline{Q}_{C}(k) are both low, then the output signal D_{C}(k) retains the value that it had in the previous clock cycle. In one embodiment, M is 6. In embodiments with RS latches 905-0 through 905-M, the digital output course signals D_{C}(0:M) correspond to signals Q_{C}(0:M), respectively.

The output signals from comparator 407, D_{F}(0:2P+1) and D_{C}(0:M), are input to digital decoder 408. In some embodiments, with P=15 and M=6, there are 32 fine digital signals and 7 course digital signals. From FIG. 7d, showing 32 folded signals Fₒᵤₜ(0:35) output from folder 405 as differential input signal In is varied through the range of ADC 308, logic signals D_{F}(0:31) indicate those signals below zero and those above zero. In other words, if x is the one of Fₒᵤₜ(0:35) closest to 0, D_{F}(0:x−1) is one logic level depending on the polarity of the changing signals Fₒᵤₜ(0:35) in the region of interest (i.e., wither the signals are decreasing or increasing with increasing In), and D_{F}(x+1:35) is the opposite logic level. D_{F}(X) can be either high or low if a decision is made or is set to be high or low depending on the previous decision for D_{F}(X). The region of interest is determined by the course determination D_{C}(0:6), which also is a thermometer output having D_{C}(0:y−1) being a logic low and D_{C}(y+1:7) being a logic high, with D_{C}(y) being either high or low as described above.

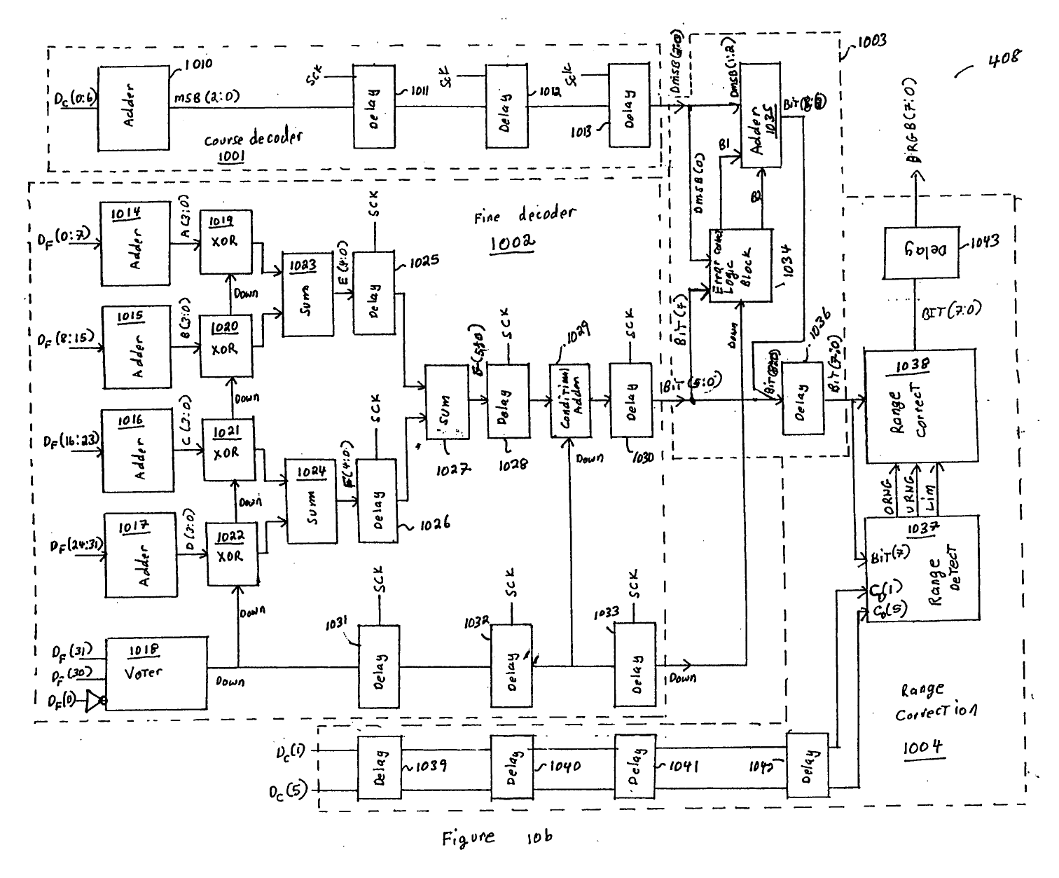

FIG. 10 shows a block diagram of digital decoder 408 according to the present invention. Digital encoder 408 receives fine comparison signals D_{F}(0:2P+1) and course comparison signals D_{C}(0:M) from comparator bank 407. Some embodiments of digital encoder 408 shown in FIG. 10 receives 32 digital fine signals D_{F}(0:31) and 7 digital course signals D_{C}(0:6) and outputs an 8-bit digital word. One skilled in the art will recognize from this disclosure that a digital encoder according to the present invention can input any number of fine signals and any number if course signals and can output any number of bits of resolution.

Encoder 408 converts the thermometer code information from the course and fine signals, D_{C}(0:M) and D_{F}(0:2P+1), respectively, into binary format and performs any necessary error correction. Digital encoder 408 includes a course decoder 1001 in parallel with a fine decoder 1002. Ideally the most significant bit of the output signal of fine decoder 1002 is the same as the least significant bit of the course decoder 1001. In reality, those two bits often differ. Error correction 1003 inputs the output signals from decoder 1001 and the output signals from decoder 1002 and outputs the most significant bit of fine decoder 1002 and will also correct the most significant two bits of course decoder 1001 by adding or subtracting a one. In addition, the output from error correction 1003 is input to range correction 1004. Range detection 1004 detects over-range input signals (i.e. all input signals are 1) or under-range input signals (i.e. all input signals are 0).

In some embodiments, fine decoder 1002 can correct for “bubbles.” A “bubble” occurs when the fine comparator output changes in a non-monotonic manner. For example, in an embodiment with P=15 and M=6, assume that a differential input signal In is such that the output of comparator 407 is such that D_{F}(0:12) should all be high and D_{F}(13:31) should all be low. Further, assume that D_{F}(12) is high (i.e. D_{F}(12)=1) and D_{F}(13) is low (i.e. D_{F}(13)=0). Then a bubble is defined where any of signals D_{F}(0:11) are low, or any of signals D_{F}(14:31) are high. Bubbles may occur due to non-matched signal delays or clock delays. Bubbles can often cause decoder circuits to output totally incorrect signals. According to an aspect of the present invention, decoder 1002 prevents bubbles from seriously affecting the digitized output signal D_{C}(7:0) because decoder 1002 adds the number of fine comparator outputs D_{F}(0:31) which are high in a rising segment of the folded signals (See FIG. 7d) or low in a falling segment of the folded signals. This is an extremely robust method in that it corrects for more than one bubble or for large bubbles in the signals D_{F}(0:31).

The determination of whether differential input signal In lies in a region of the range of ADC 308 where the folded signals are rising or are falling can be accomplished through a voting scheme. In some embodiments, the voting scheme looks at the inverted least significant fine comparator output (i.e., D_{F}(0)) and the two most significant fine comparator outputs (i.e., D_{F}(31) and D_{F}(30)). The majority, in other words 2 out of 3 of these signals, determines whether the folder is in an up-going or down-going segment. For example, if D_{F}(0) is low and D_{F}(30) and D_{F}(31) are high, then the signal In is in a rising segment of the folded signals. Alternatively, if D_{F}(30) and D_{F}(31) are low and D_{F}(0) is high, then signal In is in a falling segment of the folded signals. One skilled in the art will recognize other indications based on the fine output signals D_{F}(0:31) and the course output signals DC(0:6) for determining whether the signal In falls in a rising or falling segment of the folded signals (see FIG. 7d).

Fine adder 1002 determines the number, signals D_{F}(0:31) which are high or the number of signals D_{F}(0:31) which are low, depending on whether the signal In is in a rising or falling region of the folded signals. In one embodiment, if signal In is in a falling portion of the folded signals, then fine decoder 1002 outputs the number of signals D_{F}(0:31) which are 0 and if signal In is in a rising portion of the folded signals, then fine decoder 1002 outputs the number of signals D_{F}(0:31) which are 1.

The course adder 1001 determines the three most significant bits and the fine adder 1002 determines the least significant bits for the binary equivalent of the input signal RBG. The adders utilized in fine decoder 1002 and course decoder 1001 are carry-save adders, which fast enough for the speed requirements of a graphics digitizer. One skilled in the art will recognize that other embodiments can utilize other adders. By using an adder to determine the least significant bits complicates decoder 408, but the advantage of the robust bubble-correction scheme that automatically results far outweighs the disadvantages of increased complexity.

Error correction 1003 looks at the most significant bit of the output from fine decoder 1002, e.g., BIT(4), the up/down signal, DOWN, and the least significant bit from the course decoder DMSB(0) and looks for inconsistencies between them. An error occurs according to the logic function

Error=\overline{BIT(4)} AND \overline{DOWN} AND DMSB(0) OR BIT(4) AND DOWN AND \overline{DMSB(0)}.

For example, the least significant bit from course decoder DMSB(0) can indicate whether the differential input signal In is in a rising or falling region (e.g., if DMSB(0) is 1 then In is in a rising region and if DMSB(0) is 0 then In is in a falling region). Additionally, the most significant bit from the fine decoder, BIT(4) in some embodiments should also be consistent with a rising or falling region. In one embodiment, Error correction 1003 adds one to bits DMSB(2:1) if signal DOWN is high, DMSB(0) is low, and BIT(4) is high or if signal DOWN is low, DMSB(0) is high, and BIT(4) is low. In addition, a binary 2 is added if DOWN is high, DMSB(0) is low, and bit(4) is high.

Range correction 1004 detects an out-of-range condition and outputs either all ones or all zeros on that condition. In other words, when an out-of-range condition is detected, DRGB(7:0) will be all zeros or all ones depending on whether range correction 1004 detects an over range or under range condition. In some embodiments, for example with P=15 and M=6, range correction 1004 the over range condition is indicated when D_{C}(5) indicates a large value of signal In and the most significant bit from the A/D converter is a 0 (i.e., BIT(7)=0). The under range condition is indicated when D_{C}(1) indicates a small value of signal In and the most significant bit from the converter is a 1 (i.e., BIT(7)=1).

FIG. 10b shows a more detailed block diagram of an embodiment of digital encoder 408 according to the present invention. The embodiment shown in FIG. 10b inputs seven course comparator signals, 32 fine comparator signals, and outputs an 8-bit digital signal. One skilled in the art will recognize that digital encoders according to the present invention can be included in an analog-to-digital converter having any number of bits of resolution. As also shown in FIG. 10a, digital encoder includes course decoder 1001, fine decoder 1002, error correction circuit 1003, and range correction circuit 1004.

Course decoder 1001 includes adder 1010 and delays 1011, 1012, and 1013. Adder 1010 inputs the output from the course comparators of comparator circuit 407, D_{C}(0:6) and outputs a digital number MSB(2:0) indicating how many of signals D_{C}(0:6) are high. MSB(2:0), for the case where there are seven course comparator values DC(0:6), can be a 3-bit digital value. The digital value MSB(2:0) is delayed through one-cycle delays 1011, 1012 and 1013 to produce digital value DMSB(2:0) three clock cycles after the cycle in which D_{C}(0:6) is presented to course decoder 1001. Note that by determining the number of signals D_{C}(0:6) which are high, a bubble in DC(0:6) will result in a high or low value for DMSB(2:0), which later may create an error in the most significant bits of the digitized output value DRGB(7:0).

Fine decoder 1002 receives the fine comparator output signals D_{F}(0:31) and outputs the least significant bits, BIT(5:0), which indicate the digitized output value DRGB(7:0). Fine decoder 1002 includes adders 1014, 1015, 1016 and 1017 which receive signals D_{F}(0:7), D_{F}(8:15), D_{F}(16:23), and D_{F}(24:31), respectively. Adders 1014, 1015, 1016, and 1017 output a 4-bit digital value A(3:0), B(3:0), C(3:0), and D(3:0), respectively, indicating the number of signals D_{F}(0:7), D_{F}(8:15), D_{F}(16:23), and D_{F}(24:31), respectively, are high.

Fine decoder 1002 also includes a voter 1018 which determines whether the differential input signal In is in region having rising folded signals with increasing signal In (a rising section) or whether the differential input signal In is in a region having falling folded signals with increasing signal In (a falling section), as indicated in the graph of the folded signals shown in FIG. 7d. In the embodiment of voter 1018 shown in FIG. 10b, signals D_{F}(0), D_{F}(30) and D_{F}(31) are utilized in this determination. If D_{F}(0) is low and D_{F}(30) and D_{F}(31) are high, then voter 1018 indicates a rising section (e.g., signal DOWN is set high). If D_{F}(0) is high and D_{F}(30) and D_{F}(31) are low, then voter 1018 indicates a falling section (e.g., signal DOWN is set low). In some embodiments, voter 1018 takes a 2/3 vote of the complement of D_{F}(0) and D_{F}(30) and D_{F}(31) to determine the signal DOWN (i.e., DOWN=(D_{F}(30) AND D_{F}(31) OR (D_{F}(30) AND \overline{D}_{F}(0)) OR (D_{F}(31) AND \overline{D}_{F}(0)))). Other embodiment may utilize other determinations of signal DOWN. For example whether or not signal MSB(2:0) from adder 1010 is even or odd (as indicated by MSB(0)) is an indication of whether the signal In is in a rising or falling portion of the folded signals.

The signal DOWN, which is high for an indication of a rising portion of the folded signals and low for an indication of a falling portion of the folded signals, is bit-wise XORed with the digital values A(3:0), B(3:0), C(3:0), and D(3:0) in XOR blocks 1019, 1020, 1021, and 1022, respectively. If DOWN is low (indicating a falling portion of the folded signals) then the values A(3:0), B(3:0), C(3:0), and D(3:0) remain unchanged. Note that in this case, the values of D_{F}(0:X) will all be one while the values of D_{F}(X+1:31) will be 0, where x indicates the zero-crossing point, so that the determination of the output bits is in the correct sense. If DOWN is high (indicating a rising region of the folded signals), then D_{F}(0:X) will all be zero while the values of D_{F}(X+1:31) will be 1. In that case, the least significant bits of the digitized value will be determined by the number of lows in D_{F}(0:31) instead of the number of highs. If DOWN is high, then, XOR blocks 1019, 1020, 1021 and 1022 have the effect of taking the one's-complement of digital values A(3:0), B(3:0), C(3:0), and D(3:0), respectively.

The digital output values from XOR blocks 1019 and 1020 are digitally summed in summer 1023 to generate a four-bit digital value E(4:0). Similarly, the digital output values from XOR blocks 1021 and 1022 are digitally summed in summer 1024 to generate a four-bit digital value F(4:0). Value E(4:0) is delayed by one clock cycle in delay 1025 and value F(4:0) is delayed by one clock cycle in delay 1026. Value F(4:0) and value E(4:0) are then digitally summed in summer 1027 to generate 5-bit digital value G(5:0). Digital value G(5:0) is delayed by one cycle in delay 1028 and then input to conditional adder 1029.

Digital value G(5:0), in the case where DOWN is low (a falling section), indicates the number of ones in signals D_{F}(0:31). In the case where DOWN is high (a rising section), G(5:0) indicates the addition of the one's complement of the number of high bits in sections D_{F}(0:7), D_{F}(8:15), D_{F}(16:23), and D_{F}(2^{4:31}). If DOWN is high, then conditional adder 1029 adds 36 (100100) to G(5:0), completing the two's complement of each of values A(3:0), B(3:0), C(3:0), and D(3:0), and adding 32, thereby calculating the number of lows present in D_{F}(0:31) instead of the number of highs. The output from conditional adder 1029, BIT(5:0), is delayed by delay 1030 and then input to error correction 1003.

Error correction 1003 includes error correct logic block 1034 and adder 1035. Error correction 1003 receives BIT(5:0) from fine decoder 1002 and DMSB(2:0) from course decoder 1001. DMSB(2:0) determines the most significant bits of the subsequent digital value (DRGB(7:0)) and BIT(5:0) determines the least significant bits. In other words, the fine decoder indicates where in one of the 8 ranges indicated by the folded signals the value of signal In lies while course decoder indicates which of the 8 ranges in which signal In lies.

Error logic block 1034 inputs the signal DOWN as well as BIT(4) and DMSB(0), the least significant bit of DMSB(2:0). As previously discussed, DMSB(0) can indicate whether the signal In lies in a rising or falling region. For example, in one embodiment, if DMSB(0) is 1 then In is in a falling region and if DMSB(0) is 0 then In is in a rising region. Error correction logic block outputs bits B1 and B2 to adder 1035. In some embodiments of the invention, bit B1 is set to 1 if DOWN is low (indicating a falling region), DMSB(0) is 1, and BIT(4) is 0 or if DOWN is high (indicating a rising region), DMSB(0) is 0, and BIT(4) is 1, otherwise B1 is 0; B2 is set to 1 if DOWN is high, DMSB(0) is 0, and BIT(4) is 1, otherwise B2 is 0. B1 is added to DMSB(1) to obtain 131T(6). The carry bit from the addition of B1 to DMSB(1), DMSB(2), and B2 are added to obtain BIT(7) and BIT(8). The value BIT(8:0) is delayed by one clock cycle in input delay 1036 and then input to range correction circuit 1004.

Range correction 1004 receives the value BIT(8:0) from error correction circuit 1003 and outputs the digitized value DRGB(7:0). Range correction 1004 includes a range detect 1037 and a range correct 1038. Range detect 1037 inputs signals D_{C}(1) and D_{C}(5) four clock cycles by delays 1039, 1040, 1041 and 1042 coupled in series, labeled C_{D}(1) and C_{D}(S), respectively, and BIT(7) (which has also been delayed by four clock cycles from the receipt of signals D_{C}(0:6) and D_{F}(0:31) to digital encoder 408. An over range condition, indicated by signal ORNG, is indicated if CD(5) is high, indicating a high value of signal In, and BIT(7) is low. In this case, the digital value indicated by BIT(7:0) is too low. An under range condition, indicated by signal URNG, is indicated if C_{D}(1) is low and BIT(7:0) is high. In this case, the digital value indicated by BIT(7:0) is too high. If either of ORNG or URNG is set, then signal LIM is set indicating an out of range condition.

Range correct 1038 receives digital value BIT(7:0) and signals ORNG, URNG and LIM. If LIM indicates that digital value BIT(7:0) is not out of range, then BIT(7:0) is output from range correct 1038 unaltered. If LIM is set and ORNG is set, then BIT(7:0) is set such that all bits are high. If LIM is set and URNG is set, then BIT(7:0) is set such that all bits are low. BIT(7:0) is delayed by one clock cycle in delay 1043 and then output from digital encoder 408 as digital value DRGB(7:0).

Signal DRGB(7:0) is the digitized value indicating the analog signal RGB that was originally presented to analog-to-digital converter 253 (FIG. 2b). Microfiche Appendix A, herein incorporated by reference in its entirety, discloses a particular embodiment of a graphics digitizer having a phase-locked-loop, a timing generator, and an analog-to-digital converter according to the present invention.

One skilled in the art will recognize many variations that, although not specifically pointed out in the disclosure, are within the scope of this disclosure. The embodiments described above are exemplary only and should not be considered limiting. As such, the invention is limited only by the following claims.

We claim:

1. An analog-to-digital converter, comprising:
a sample and hold circuit that receives an analog input signal and outputs a differential input signal in response to a sampling clock signal;
a reference generator that receives a reference voltage and generates a set of differential reference signals;
a pre-amp bank that receives the differential input signal from the sample and hold circuit and the set of differential reference signals from the reference generator and outputs a set of differential output signals indicative of a comparison between the differential input signal and the set of differential reference signals, the pre-amp bank including an array of differential pre-amps, each differential pre-amp of the array of differential pre-amp being offset canceled and reset in response to an HSYNC signal indicating the end of a video line.
a folding and interpolation circuit that receives the set of differential output signals and generates a set of differential folded signals;
a course pre-amp that receives selected ones of the set of differential output signals and outputs a set of differential course output signals;
a comparator bank that receives the set of differential folded signals and the set of differential course output signals and outputs a set of digitized fine signals and a set of digitized course signals; and
a digital encoder that receives the set of digitized fine signals and the set of digitized course signals and outputs a digital signal indicative of the analog input signal.

2. The converter according to claim 1, wherein the folding and interpolating circuit includes a first folding circuit coupled to a second folding circuit, the first folding circuit including active voltage averaging of the set of differential output signals and resistive interpolation.

3. The converter according to claim 2, wherein the first folding circuit includes a set of first folding sub-blocks, each sub-block of the set of first folding sub-blocks including at least one amplifier section having a number of differential amplifiers having coupled output terminals, each of the number of coupled differential amplifiers coupled to receive one of the differential output signals to provide active voltage averaging.

4. The converter according to claim 3, wherein each sub-block of the set of first folding sub-blocks includes three amplifier sections having three differential amplifiers each, each of the three amplifier sections receiving sequential ones of the differential output signals with differential output signals received by different ones of the three amplifier sections separated over the set of differential output signals.

5. The converter according to claim 3, wherein a number of resistive outputs coupled to the output terminals provides resistive interpolation.

6. The converter according to claim 5, wherein each sub-block provides four differential output signals.

7. The converter according to claim 3, wherein the first folding circuit includes 12 coupled sub-blocks.

8. The converter according to claim 2, wherein the second folding circuit includes a number of second folding sub-blocks coupled together, each sub-block of the number of second folding sub-blocks including a number of differential amplifiers having coupled output terminals, each of the number of differential amplifiers coupled to receive signals from the first folding circuit.

9. The converter according to claim 8, wherein each sub-block includes resistive outputs coupled to the output terminals that provide resistive interpolation.

10. The converter according to claim 9, wherein each sub-block includes three differential amplifier and provides two output signals to the set of differential folded signals.

11. The converter according to claim 10, wherein the second folding circuit includes sixteen second folding sub-blocks.

12. The converter according to claim 1, wherein the comparator bank includes
an array of fine comparators, each comparator of the array of fine comparators coupled to an RS latch, each comparator in the array of fine comparators receiving one of the set of differential folded signals and outputting a binary digit and a complementary binary digit indicating whether the one of the set of differential folded signals is positive or negative to the RS latch, and
an array of course comparators, each comparator of the array of course comparators coupled to an RS latch, the array of course comparators receiving one of the set of course differential signals and outputting a binary digit and a complementary binary digit indicating whether the one of the set of course differential signals is positive or negative,
wherein the set of digitized fine signals and the set of digitized course signals correspond to outputs of the RS latch coupled to each comparator of the array of fine comparators and the outputs of the RS latch coupled to each comparator of the array of course comparators, respectively.

13. The converter according to claim 1, wherein the digital encoder includes
a fine decoder that converts the set of digitized fine signals into the least significant bits of the digital signal by determining a number corresponding to the number of the set of digitized fine signals having a first logic level and setting the least significant bits equal to the number, and
a course decoder that converts the set of digitized course signals to the most significant bits of the digital signal by determining a course number indicating the number of the set of digitized course signals having a second logic level.

14. The converter of claim 13, wherein whether the first logic level is the same or opposite the second logic level is determined by a voting circuit, the voting circuit determining if a region corresponding to the analog input signal is in a rising or falling section.

15. The converter of claim 13, wherein whether the first logic level is the same or opposite the second logic level is determined by the course number.

16. The converter of claim 14, wherein the voting circuit inputs one digit from a first extreme of the set of digitized fine signals and two digits from a second extreme opposite the first extreme of the set of digitized fine signals and determines whether the region is a rising or falling section by ⅔ majority vote.

17. The converter of claim 13, wherein the digital decoder further includes an error correction circuit.

18. The converter of claim 17, wherein the error correction circuit inputs a determination of whether a region corresponding to the analog input signal is in a rising or falling section, the least significant bit of the course number, and the next to most significant bit of the fine number, determines if there is an agreement of whether the region is a rising or falling section, and adjusts the course number if there is no agreement.

19. The converter of claim 13, wherein the digital decoder further includes a range correction circuit.

20. The converter of claim 19, wherein the range correction circuit inputs a first signal of the set of digitized fine signals and a second signal of the set of digitized fine signals, the first signal and the second signal being chosen to be near end points of a range of allowed differential input signals, and the most significant bit of the digital signal, the range correction circuit sets the digital signal at a high extreme value if the first signal indicates a high value of the analog input signal and the most significant bit of the digital signal is not one and sets the digital signal at a low extreme value if the second signal indicates a low value of the analog input signal and the most significant bit of the digital signal is not 0.

21. The converter of claim 1, wherein the set of differential reference signals includes 32 reference signals and the set of differential output signals includes 32 output signals.

22. The converter of claim 21, wherein the set of differential folded signals includes 32 differential folded signals.

23. The converter of claim 22, wherein the set of differential course output signals includes 7 differential course output signals.

24. The converter of claim 23, wherein the digitized signal includes 8 bits.

25. An analog-to-digital converter, comprising:
a sample and hold circuit that receives an analog input signal and outputs a differential input signal in response to a sampling clock signal;
a reference generator that receives a reference voltage and generates a set of differential reference signals;
a pre-amp bank that receives the differential input signal from the sample and hold circuit and the set of differential reference signals from the reference generator and outputs a set of differential output signals indicative of a comparison between the differential input signal and the set of differential reference signals, the pre-amp bank including an array of differential pre-amps, each differential pre-amp of the array of differential pre-amps being offset canceled and reset in response to a random number generated by a random number generator;
a folding and interpolation circuit that receives the set of differential output signals and generates a set of differential folded signals;
a course pre-amp that receives selected ones of the set of differential output signals and outputs a set of differential course output signals;
a comparator bank that receives the set of differential folded signals and the set of differential course output signals and outputs a set of digitized fine signals and a set of digitized course signals; and
a digital encoder that receives the set of digitized fine signals and the set of digitized course signals and outputs a digital signal indicative of the analog input signal.

26. The converter according to claim 25, wherein each differential pre-amp of the array of differential pre-amps is a member of a set of pre-amp groups wherein corresponding members of each of the pre-amp groups are offset canceled and reset simultaneously.

27. The converter according to claim 25, wherein differential output signals from each of the array of differential pre-amps are input to a multiplexer circuit, the multiplexer circuit outputting the set of differential output signals having those differential output signals from those pre-amps in the array of differential pre-amps that are not being offset canceled and reset.

28. The converter according to claim 25, wherein the folding and interpolating circuit includes a first folding circuit coupled to a second folding circuit, the first folding circuit including active voltage averaging of the set of differential output signals and resistive interpolation.

29. The converter according to claim 28, wherein the first folding circuit includes a set of first folding sub-blocks, each sub-block of the set of first folding sub-blocks including at least one amplifier section having a number of differential amplifiers having coupled output terminals, each of the number of coupled differential amplifiers coupled to receive one of the differential output signals to provide active voltage averaging.

30. The converter according to claim 29, wherein each sub-block of the set of first folding sub-blocks includes three amplifier sections having three differential amplifiers each, each of the three amplifier sections receiving sequential ones of the differential output signals with differential output signals received by different ones of the three amplifier sections separated over the set of differential output signals.

31. The converter according to claim 29, wherein a number of resistive outputs coupled to the output terminals provides resistive interpolation.

32. The converter according to claim 31, wherein each sub-block provides four differential output signals.

33. The converter according to claim 29, wherein the first folding circuit includes 12 coupled sub-blocks.

34. The converter according to claim 28, wherein the second folding circuit includes a number of second folding sub-blocks coupled together, each sub-block of the number of second folding sub-blocks including a number of differential amplifiers having coupled output terminals, each of the number of differential amplifiers coupled to receive signals from the first folding circuit.

35. The converter according to claim 36, wherein each sub-block includes resistive outputs coupled to the output terminals that provide resistive interpolation.

36. The converter according to claim 35, wherein each sub-block includes three differential amplifier and provides two output signals to the set of differential folded signals.

37. The converter according to claim 36, wherein the second folding circuit includes sixteen second folding sub-blocks.

38. The converter according to claim 25, wherein the comparator bank includes
an array of fine comparators, each comparator of the array of fine comparators coupled to an RS latch, each comparator in the array of fine comparators receiving one of the set of differential folded signals and outputting a binary digit and a complementary binary digit indicating whether the one of the set of differential folded signals is positive or negative to the RS latch, and
an array of course comparators, each comparator of the array of course comparators coupled to an RS latch, the array of course comparators receiving one of the set of course differential signals and outputting a binary digit and a complementary binary digit indicating whether the one of the set of course differential signals is positive or negative,
wherein the set of digitized fine signals and the set of digitized course signals correspond to outputs of the RS latch coupled to each comparator of the array of fine comparators and the outputs of the RS latch coupled to each comparator of the array of course comparators, respectively.

39. The converter according to claim 25, wherein the digital encoder includes
a fine decoder that converts the set of digitized fine signals into the least significant bits of the digital signal by determining a number corresponding to the number of the set of digitized fine signals having a first logic level and setting the least significant bits equal to the number, and
a course decoder that converts the set of digitized course signals to the most significant bits of the digital signal by determining a course number indicating the number of the set of digitized course signals having a second logic level.

40. The converter of claim 39, wherein whether the first logic level is the same or opposite the second logic level is determined by a voting circuit, the voting circuit determining if a region corresponding to the analog input signal is in a rising or falling section.

41. The converter of claim 40, wherein the voting circuit inputs one digit from a first extreme of the set of digitized fine signals and two digits from a second extreme opposite the first extreme of the set of digitized fine signals and determines whether the region is a rising or falling section by ⅔ majority vote.

42. The converter of claim 39, wherein whether the first logic level is the same or opposite the second logic level is determined by the course number.

43. The converter of claim 39, wherein the digital decoder further includes an error correction circuit.

44. The converter of claim 43, wherein the error correction circuit inputs a determination of whether a region corresponding to the analog input signal is in a rising or falling section, the least significant bit of the course number, and the next to most significant bit of the fine number, determines if there is an agreement of whether the region is a rising or falling section, and adjusts the course number if there is no agreement.

45. The converter of claim 39, wherein the digital decoder further includes a range correction circuit.

46. The converter of claim 45, wherein the range correction circuit inputs a first signal of the set of digitized fine signals and a second signal of the set of digitized fine signals, the first signal and the second signal being chosen to be near end points of a range of allowed differential input signals, and the most significant bit of the digital signal, the range correction circuit sets the digital signal at a high extreme value if the first signal indicates a high value of the analog input signal and the most significant bit of the digital signal is not one and sets the digital signal at a low extreme value if the second signal indicates a low value of the analog input signal and the most significant bit of the digital signal is not 0.

47. The converter of claim 25, wherein the set of differential reference signals includes 32 reference signals and the set of differential output signals includes 32 output signals.

48. The converter of claim 25, wherein the set of differential folded signals includes 32 differential folded signals.

49. The converter of claim 25, wherein the set of differential course output signals includes 7 differential course output signals.

50. The converter of claim 25, wherein the digitized signal includes 8 bits.

51. An analog-to-digital converter, comprising:
a sample and hold circuit that receives an analog input signal and outputs a differential input signal in response to a sampling clock signal;
a reference generator that receives a reference voltage and generates a set of differential reference signals;
a pre-amp bank that receives the differential input signal from the sample and hold circuit and the set of differential reference signals from the reference generator and outputs a set of differential output signals indicative of a comparison between the differential input signal and the set of differential reference signals;
a folding and interpolation circuit that receives the set of differential output signals and generates a set of differential folded signals, the folding and interpolating circuit having a first folding circuit coupled to a second folding circuit, the first folding circuit including active voltage averaging of the set of differential output signals and resistive interpolation;
a course pre-amp that receives selected ones of the set of differential output signals and outputs a set of differential course output signals;
a comparator bank that receives the set of differential folded signals and the set of differential course output signals and outputs a set of digitized fine signals and a set of digitized course signals; and
a digital encoder that receives the set of digitized fine signals and the set of digitized course signals and outputs a digital signal indicative of the analog input signal.

52. The converter according to claim 51, wherein the pre-amp bank includes an array of differential pre-amps, each differential pre-amp of the array of differential pre-amp being offset canceled and reset in response to an HSYNC signal indicating the end of a video line.

53. The converter according to claim 51, wherein the pre-amp bank includes an array of differential pre-amps, each differential pre-amp of the array of differential pre-amps being offset canceled and reset in response to a random number generated by a random number generator.

54. The converter according to claim 53, wherein each differential pre-amp of the array of differential pre-amps is a member of a set of pre-amp groups wherein corresponding members of each of the pre-amp groups are offset canceled and reset simultaneously.

55. The converter according to claim 53, wherein differential output signals from each of the array of differential pre-amps are input to a multiplexer circuit, the multiplexer circuit outputting the set of differential output signals having those differential output signals from those pre-amps in the array of differential pre-amps that are not being offset canceled and reset.

56. The converter according to claim 51, wherein the first folding circuit includes a set of first folding sub-blocks, each sub-block of the set of first folding sub-blocks including at least one amplifier section having a number of differential amplifiers having coupled output terminals, each of the number of coupled differential amplifiers coupled to receive one of the differential output signals to provide active voltage averaging.

57. The converter according to claim 56, wherein each sub-block of the set of first folding sub-blocks includes three amplifier sections having three differential amplifiers each, each of the three amplifier sections receiving sequential ones of the differential output signals with differential output signals received by different ones of the three amplifier sections separated over the set of differential output signals.

58. The converter according to claim 56, wherein a number of resistive outputs coupled to the output terminals provides resistive interpolation.

59. The converter according to claim 58, wherein each sub-block provides four differential output signals.

60. The converter according to claim 56, wherein the first folding circuit includes 12 coupled sub-blocks.

61. The converter according to claim 55, wherein the second folding circuit includes a number of second folding sub-blocks coupled together, each sub-block of the number of second folding sub-blocks including a number of differential amplifiers having coupled output terminals, each of the number of differential amplifiers coupled to receive signals from the first folding circuit.

62. The converter according to claim 61, wherein each sub-block includes resistive outputs coupled to the output terminals that provide resistive interpolation.

63. The converter according to claim 62, wherein each sub-block includes three differential amplifier and provides two output signals to the set of differential folded signals.

64. The converter according to claim 63, wherein the second folding circuit includes sixteen second folding sub-blocks.

65. The converter according to claim 51, wherein the comparator bank includes
an array of fine comparators, each comparator of the array of fine comparators coupled to an RS latch, each comparator in the array of fine comparators receiving one of the set of differential folded signals and outputting a binary digit and a complementary binary digit indicating whether the one of the set of differential folded signals is positive or negative to the RS latch, and
an array of course comparators, each comparator of the array of course comparators coupled to an RS latch, the array of course comparators receiving one of the set of course differential signals and outputting a binary digit and a complementary binary digit indicating whether the one of the set of course differential signals is positive or negative,
wherein the set of digitized fine signals and the set of digitized course signals correspond to outputs of the RS latch coupled to each comparator of the array of fine comparators and the outputs of the RS latch coupled to each comparator of the array of course comparators, respectively.

66. The converter according to claim 51, wherein the digital encoder includes
a fine decoder that converts the set of digitized fine signals into the least significant bits of the digital signal by determining a number corresponding to the number of the set of digitized fine signals having a first logic level and setting the least significant bits equal to the number, and
a course decoder that converts the set of digitized course signals to the most significant bits of the digital signal by determining a course number indicating the number of the set of digitized course signals having a second logic level.

67. The converter of claim 66, wherein whether the first logic level is the same or opposite the second logic level is determined by a voting circuit, the voting circuit determining if a region corresponding to the analog input signal is in a rising or falling section.

68. The converter of claim 67, wherein the voting circuit inputs one digit from a first extreme of the set of digitized fine signals and two digits from a second extreme opposite the first extreme of the set of digitized fine signals and determines whether the region is a rising or falling section by ⅔ majority vote.

69. The converter of claim 66, wherein whether the first logic level is the same or opposite the second logic level is determined by the course number.

70. The converter of claim 66, wherein the digital decoder further includes an error correction circuit.

71. The converter of claim 70, wherein the error correction circuit inputs a determination of whether a region corresponding to the analog input signal is in a rising or falling section, the least significant bit of the course number, and the next to most significant bit of the fine number, determines if there is an agreement of whether the region is a rising or falling section, and adjusts the course number if there is no agreement.

72. The converter of claim 66, wherein the digital decoder further includes a range correction circuit.

73. The converter of claim 72, wherein the range correction circuit inputs a first signal of the set of digitized fine signals and a second signal of the set of digitized fine signals, the first signal and the second signal being chosen to be near end points of a range of allowed differential input signals, and the most significant bit of the digital signal, the range correction circuit sets the digital signal at a high extreme value if the first signal indicates a high value of the analog input signal and the most significant bit of the digital signal is not one and sets the digital signal at a low extreme value if the second signal indicates a low value of the analog input signal and the most significant bit of the digital signal is not 0.

74. The converter of claim 51, wherein the set of differential reference signals includes 32 reference signals and the set of differential output signals includes 32 output signals.

75. The converter of claim 74, wherein the set of differential folded signals includes 32 differential folded signals.

76. The converter of claim 75, wherein the set of differential course output signals includes 7 differential course output signals.

77. The converter of claim 76, wherein the digitized signal includes 8 bits.

78. An analog-to-digital converter, comprising:
a sample and hold circuit that receives an analog input signal and outputs a differential input signal in response to a sampling clock signal;
a reference generator that receives a reference voltage and generates a set of differential reference signals;
a pre-amp bank that receives the differential input signal from the sample and hold circuit and the set of differential reference signals from the reference generator and outputs a set of differential output signals indicative of a comparison between the differential input signal and the set of differential reference signals;
a folding and interpolation circuit that receives the set of differential output signals and generates a set of differential folded signals;
a course pre-amp that receives selected ones of the set of differential output signals and outputs a set of differential course output signals;
a comparator bank that receives the set of differential folded signals and the set of differential course output signals and outputs a set of digitized fine signals and a set of digitized course signals, the comparator bank including
an array of fine comparators, each comparator of the array of fine comparators coupled to an RS latch, each comparator in the array of fine comparators receiving one of the set of differential folded signals and outputting a binary digit and a complementary binary digit indicating whether the one of the set of differential folded signals is positive or negative to the RS latch, and
an array of course comparators, each comparator of the array of course comparators coupled to an RS latch, the array of course comparators receiving one of the set of course differential signals and outputting a binary digit and a complementary binary digit indicating whether the one of the set of course differential signals is positive or negative,
wherein the set of digitized fine signals and the set of digitized course signals correspond to outputs of the RS latch coupled to each comparator of the array of fine comparators and the outputs of the RS latch coupled to each comparator of the array of course comparators, respectively; and
a digital encoder that receives the set of digitized fine signals and the set of digitized course signals and outputs a digital signal indicative of the analog input signal.

79. The converter according to claim 78, wherein the pre-amp bank includes an array of differential pre-amps, each differential pre-amp of the array of differential pre-amp being offset canceled and reset in response to an HSYNC signal indicating the end of a video line.

80. The converter according to claim 78, wherein the pre-amp bank includes an array of differential pre-amps, each differential pre-amp of the array of differential pre-amps being offset canceled and reset in response to a random number generated by a random number generator.

81. The converter according to claim 80, wherein each differential pre-amp of the array of differential pre-amps is a member of a set of pre-amp groups wherein corresponding members of each of the pre-amp groups are offset canceled and reset simultaneously.

82. The converter according to claim 80, wherein differential output signals from each of the array of differential pre-amps are input to a multiplexer circuit, the multiplexer circuit outputting the set of differential output signals having those differential output signals from those pre-amps in the array of differential pre-amps that are not being offset canceled and reset.

83. The converter according to claim 78, wherein the folding and interpolating circuit includes a first folding circuit coupled to a second folding circuit, the first folding circuit including active voltage averaging of the set of differential output signals and resistive interpolation.

84. The converter according to claim 83, wherein the first folding circuit includes a set of first folding sub-blocks, each sub-block of the set of first folding sub-blocks including at least one amplifier section having a number of differential amplifiers having coupled output terminals, each of the number of coupled differential amplifiers coupled to receive one of the differential output signals to provide active voltage averaging.

85. The converter according to claim 84, wherein each sub-block of the set of first folding sub-blocks includes three amplifier sections having three differential amplifiers each, each of the three amplifier sections receiving sequential ones of the differential output signals with differential output signals received by different ones of the three amplifier sections separated over the set of differential output signals.

86. The converter according to claim 84, wherein a number of resistive outputs coupled to the output terminals provides resistive interpolation.

87. The converter according to claim 86, wherein each sub-block provides four differential output signals.

88. The converter according to claim 84, wherein the first folding circuit includes 12 coupled sub-blocks.

89. The converter according to claim 83, wherein the second folding circuit includes a number of second folding sub-blocks coupled together, each sub-block of the number of second folding sub-blocks including a number of differential amplifiers having coupled output terminals, each of the number of differential amplifiers coupled to receive signals from the first folding circuit.

90. The converter according to claim 89, wherein each sub-block includes resistive outputs coupled to the output terminals that provide resistive interpolation.

91. The converter according to claim 90, wherein each sub-block includes three differential amplifier and provides two output signals to the set of differential folded signals.

92. The converter according to claim 91, wherein the second folding circuit includes sixteen second folding sub-blocks.

93. The converter according to claim 78, wherein the digital encoder includes
a fine decoder that converts the set of digitized fine signals into the least significant bits of the digital signal by determining a number corresponding to the number of the set of digitized fine signals having a first logic level and setting the least significant bits equal to the number, and
a course decoder that converts the set of digitized course signals to the most significant bits of the digital signal by determining a course number indicating the number of the set of digitized course signals having a second logic level.

94. The converter of claim 93, wherein whether the first logic level is the same or opposite the second logic level is determined by a voting circuit, the voting circuit determining if a region corresponding to the analog input signal is in a rising or falling section.

95. The converter of claim 94, wherein the voting circuit inputs one digit from a first extreme of the set of digitized fine signals and two digits from a second extreme opposite the first extreme of the set of digitized fine signals and determines whether the region is a rising or falling section by ⅔ majority vote.

96. The converter of claim 93, wherein whether the first logic level is the same or opposite the second logic level is determined by the course number.

97. The converter of claim 93, wherein the digital decoder further includes an error correction circuit.

98. The converter of claim 97, wherein the error correction circuit inputs a determination of whether a region corresponding to the analog input signal is in a rising or falling section, the least significant bit of the course number, and the next to most significant bit of the fine number, determines if there is an agreement of whether the region is a rising or falling section, and adjusts the course number if there is no agreement.

99. The converter of claim 93, wherein the digital decoder further includes a range correction circuit.

100. The converter of claim 99, wherein the range correction circuit inputs a first signal of the set of digitized fine signals and a second signal of the set of digitized fine signals, the first signal and the second signal being chosen to be near end points of a range of allowed differential input signals, and the most significant bit of the digital signal, the range correction circuit sets the digital signal at a high extreme value if the first signal indicates a high value of the analog input signal and the most significant bit of the digital signal is not one and sets the digital signal at a low extreme value if the second signal indicates a low value of the analog input signal and the most significant bit of the digital signal is not 0.

101. The converter of claim 78, wherein the set of differential reference signals includes 32 reference signals and the set of differential output signals includes 32 output signals.

102. The converter of claim 101, wherein the set of differential folded signals includes 32 differential folded signals.

103. The converter of claim 102, wherein the set of differential course output signals includes 7 differential course output signals.

104. The converter of claim 103, wherein the digitized signal includes 8 bits.

105. An analog-to-digital converter, comprising:
a sample and hold circuit that receives an analog input signal and outputs a differential input signal in response to a sampling clock signal;
a reference generator that receives a reference voltage and generates a set of differential reference signals;
a pre-amp bank that receives the differential input signal from the sample and hold circuit and the set of differential reference signals from the reference generator and outputs a set of differential output signals indicative of a comparison between the differential input signal and the set of differential reference signals;
a folding and interpolation circuit that receives the set of differential output signals and generates a set of differential folded signals;
a course pre-amp that receives selected ones of the set of differential output signals and outputs a set of differential course output signals;
a comparator bank that receives the set of differential folded signals and the set of differential course output signals and outputs a set of digitized fine signals and a set of digitized course signals; and
a digital encoder that receives the set of digitized fine signals and the set of digitized course signals and outputs a digital signal indicative of the analog input signal, the digital encoder including
a fine decoder that converts the set of digitized fine signals into the least significant bits of the digital signal by determining a number corresponding to the number of the set of digitized fine signals having a first logic level and setting the least significant bits equal to the number, and
a course decoder that converts the set of digitized course signals to the most significant bits of the digital signal by determining a course number indicating the number of the set of digitized course signals having a second logic level.

106. The converter according to claim 105, wherein the pre-amp bank includes an array of differential pre-amps, each differential pre-amp of the array of differential pre-amp being offset canceled and reset in response to an HSYNC signal indicating the end of a video line.

107. The converter according to claim 105, wherein the pre-amp bank includes an array of differential pre-amps, each differential pre-amp of the array of differential pre-amps being offset canceled and reset in response to a random number generated by a random number generator.

108. The converter according to claim 107, wherein each differential pre-amp of the array of differential pre-amps is a member of a set of pre-amp groups wherein corresponding members of each of the pre-amp groups are offset canceled and reset simultaneously.

109. The converter according to claim 107; wherein differential output signals from each of the array of differential pre-amps are input to a multiplexer circuit, the multiplexer circuit outputting the set of differential output signals having those differential output signals from those pre-amps in the array of differential pre-amps that are not being offset canceled and reset.

110. The converter according to claim 105, wherein the folding and interpolating circuit includes a first folding circuit coupled to a second folding circuit, the first folding circuit including active voltage averaging of the set of differential output signals and resistive interpolation.

111. The converter according to claim 110, wherein the first folding circuit includes a set of first folding sub-blocks, each sub-block of the set of first folding sub-blocks including at least one amplifier section having a number of differential amplifiers having coupled output terminals, each of the number of coupled differential amplifiers coupled to receive one of the differential output signals to provide active voltage averaging.

112. The converter according to claim 111, wherein each sub-block of the set of first folding sub-blocks includes three amplifier sections having three differential amplifiers each, each of the three amplifier sections receiving sequential ones of the differential output signals with differential output signals received by different ones of the three amplifier sections separated over the set of differential output signals.

113. The converter according to claim 111, wherein a number of resistive outputs coupled to the output terminals provides resistive interpolation.

114. The converter according to claim 113, wherein each sub-block provides four differential output signals.

115. The converter according to claim 111, wherein the first folding circuit includes 12 coupled sub-blocks.

116. The converter according to claim 110, wherein the second folding circuit includes a number of second folding sub-blocks coupled together, each sub-block of the number of second folding sub-blocks including a number of differential amplifiers having coupled output terminals, each of the number of differential amplifiers coupled to receive signals from the first folding circuit.

117. The converter according to claim 116, wherein each sub-block includes resistive outputs coupled to the output terminals that provide resistive interpolation.

118. The converter according to claim 117, wherein each sub-block includes three differential amplifier and provides two output signals to the set of differential folded signals.

119. The converter according to claim 118, wherein the second folding circuit includes sixteen second folding sub-blocks.

120. The converter according to claim 105, wherein the comparator bank includes
an array of fine comparators, each comparator of the array of fine comparators coupled to an RS latch, each comparator in the array of fine comparators receiving one of the set of differential folded signals and outputting a binary digit and a complementary binary digit indicating whether the one of the set of differential folded signals is positive or negative to the RS latch, and
an array of course comparators, each comparator of the array of course comparators coupled to an RS latch, the array of course comparators receiving one of the set of course differential signals and outputting a binary digit and a complementary binary digit indicating whether the one of the set of course differential signals is positive or negative,
wherein the set of digitized fine signals and the set of digitized course signals correspond to outputs of the RS latch coupled to each comparator of the array of fine comparators and the outputs of the RS latch coupled to each comparator of the array of course comparators, respectively.

121. The converter of claim 105, wherein whether the first logic level is the same or opposite the second logic level is determined by a voting circuit, the voting circuit determining if a region corresponding to the analog input signal is in a rising or falling section.

122. The converter of claim 121, wherein the voting circuit inputs one digit from a first extreme of the set of digitized fine signals and two digits from a second extreme opposite the first extreme of the set of digitized fine signals and determines whether the region is a rising or falling section by ⅔ majority vote.

123. The converter of claim 120, wherein whether the first logic level is the same or opposite the second logic level is determined by the course number.

124. The converter of claim 120, wherein the digital decoder further includes an error correction circuit.

125. The converter of claim 124, wherein the error correction circuit inputs a determination of whether a region corresponding to the analog input signal is in a rising or falling section, the least significant bit of the course number, and the next to most significant bit of the fine number, determines if there is an agreement of whether the region is a rising or falling section, and adjusts the course number if there is no agreement.

126. The converter of claim 120, wherein the digital decoder further includes a range correction circuit.

127. The converter of claim 126, wherein the range correction circuit inputs a first signal of the set of digitized fine signals and a second signal of the set of digitized fine signals, the first signal and the second signal being chosen to be near end points of a range of allowed differential input signals, and the most significant bit of the digital signal, the range correction circuit sets the digital signal at a high extreme value if the first signal indicates a high value of the analog input signal and the most significant bit of the digital signal is not one and sets the digital signal at a low extreme value if the second signal indicates a low value of the analog input signal and the most significant bit of the digital signal is not 0.

128. The converter of claim 105, wherein the set of differential reference signals includes 32 reference signals and the set of differential output signals includes 32 output signals.

129. The converter of claim 128, wherein the set of differential folded signals includes 32 differential folded signals.

130. The converter of claim 129, wherein the set of differential course output signals includes 7 differential course output signals.

131. The converter of claim 130, wherein the digitized signal includes 8 bits.

132. A phase-locked-loop, comprising:
a phase detector coupled to receive a reference signal having a frequency and a comparison signal, the phase detector providing a phase detection signal in response to a comparison between the reference signal and the comparison signal;
a reference generator coupled to receive the phase detection signal from the phase detector, the reference generator providing an output signal having a frequency related to the phase detection signal; and
a programmable Div/N circuit coupled to receive the output signal, the programmable Div/N circuit generating the comparison signal in response to the output signal, the frequency of the comparison signal being related to the frequency of the output signal by a factor related to a value stored in a storage register.

133. The phase-locked-loop of claim 132, wherein the programmable Div/N circuit includes a counter coupled to the storage register so that a count value stored in the counter is initialized with the value when a zero signal indicates that the counter value is zero, the count value being decremented on each cycle of the output signal;
a decode circuit coupled to the counter to receive the count value, the decode circuit detecting when the count value is zero; and
a flip-flop coupled to the decode circuit so that the flip-flop outputs a logic high whenever the decode circuit detects that the count value is zero, the output signal from the flip-flop providing the comparison signal and the zero signal.

134. A reference and bias voltage generator, comprising:
a digital-to-analog converter coupled to receive a reference value from a gain register and a band-gap voltage, the digital-to-analog converter outputting a scaled bandgap voltage relative to the band-gap voltage in response to the reference value;
a current digital-to-analog converter coupled to receive the scaled bandgap voltage from the digital-to-analog converter, the current digital-to-analog converter outputting a bias voltage signal relative to the voltage reference signal and an offset value from an offset register.

135. The generator of claim 134, wherein the digital-to-analog converter includes an amplifier coupled to receive the band-gap voltage, a current circuit coupled to the amplifier to convert the band-gap voltage to a current signal, and an array of current mirrors coupled to mirror the current signal, each current mirror of the array of current mirrors coupled to a multiplexer which routs the current signal to a resistor ladder or to a ground voltage based on individual bits of the reference value stored in the gain register, the resistor ladder supplying the scaled bandgap voltage.

136. The generator of claim 135, wherein the scaled bandgap voltage supplies a voltage reference signal.

137. The generator of claim 134, wherein the current digital-to-analog converter includes an amplifier coupled to receive the scaled bandgap voltage from the digital-to-analog converter, a current circuit coupled to the amplifier to convert the band-gap voltage to a current signal, and an array of current mirrors coupled to mirror the current signal, each current mirror of the array of current mirrors coupled to a multiplexer which routs the current signal to a resistor ladder or to a ground voltage based on individual bits of the offset value stored in the offset register.

138. The generator of claim 137, wherein the current digital-to-analog converter includes a separate current mirror to produce the voltage reference signal within the current digital-to-analog converter.

139. A graphics digitizer, comprising:
at least one channel, each of the at least one channel inputs an analog video signal and outputs a digital video signal;
a phase-locked-loop coupled to a horizontal sync signal, the phase-locked-loop providing a sampling clock frequency to the at least one channel; and
a timing generator circuit that receives the horizontal sync signal and the sampling clock frequency and outputs a synchronized horizontal sync signal consistent with the sampling clock frequency and the digital video signal,
wherein the phase-locked-loop, comprises:
a phase detector coupled to receive a reference signal having a frequency and a comparison signal, the phase detector providing a phase detection signal in response to a comparison between the reference signal and the comparison signal;
a reference generator coupled to receive the phase detection signal from the phase detector, the reference generator providing an output signal having a frequency related to the phase detection signal; and
a programmable Div/N circuit coupled to receive the output signal, the programmable Div/N circuit generating the comparison signal in response to the output signal, the frequency of the comparison signal being related to the frequency of the output signal by a factor related to a value stored in a storage register.

140. The digitizer according to claim 139, wherein the programmable Div/N circuit includes:
a counter coupled to the storage register so that a count value stored in the counter is initialized with the value when a zero signal indicates that the counter value is zero, the count value being decremented on each cycle of the output signal;
a decode circuit coupled to the counter to receive the count value, the decode circuit detecting when the count value is zero; and
a flip-flop coupled to the decode circuit so that the flip-flop outputs a logic high whenever the decode circuit detects that the count value is zero, the output signal from the flip-flop providing the comparison signal and the zero signal.

141. A graphics digitizer, comprising:
at least one channel, each of the at least one channel inputs an analog video signal and outputs a digital video signal;
a phase-locked-loop coupled to a horizontal sync signal, the phase-locked-loop providing a sampling clock frequency to the at least one channel; and
a timing generator circuit that receives the horizontal sync signal and the sampling clock frequency and outputs a synchronized horizontal sync signal consistent with the sampling clock frequency and the digital video signal,
wherein each of the at least one channel includes a reference and bias voltage generator, the reference and bias voltage generator, comprising:
a digital-to-analog converter coupled to receive a reference value from a gain register and a band-gap voltage, the digital-to-analog converter outputting a scaled bandgap voltage relative to the band-gap voltage in response to the reference value;
a current digital-to-analog converter coupled to receive the scaled bandgap voltage from the digital-to-analog converter, the current digital-to-analog converter outputting a bias voltage signal relative to the voltage reference signal and an offset value from an offset register.

142. The digitizer of claim 141, wherein the digital-to-analog converter includes an amplifier coupled to receive the band-gap voltage, a current circuit coupled to the amplifier to convert the band-gap voltage to a current signal, and an array of current mirrors coupled to mirror the current signal, each current mirror of the array of current mirrors coupled to a multiplexer which routs the current signal to a resistor ladder or to a ground voltage based on individual bits of the reference value stored in the gain register, the resistor ladder supplying the scaled bandgap voltage.

143. The digitizer of claim 142, wherein the scaled bandgap voltage supplies a voltage reference signal.

144. The digitizer of claim 141, wherein the current digital-to-analog converter includes an amplifier coupled to receive the scaled bandgap voltage from the digital-to-analog converter, a current circuit coupled to the amplifier to convert the band-gap voltage to a current signal, and an array of current mirrors coupled to mirror the current signal, each current mirror of the array of current mirrors coupled to a multiplexer which routs the current signal to a resistor ladder or to a ground voltage based on individual bits of the offset value stored in the offset register.

145. The generator of claim 144, wherein the current digital-to-analog converter includes a separate current mirror to produce the voltage reference signal within the current digital-to-analog converter.

146. A graphics digitizer, comprising:
at least one channel, each of the at least one channel inputs an analog video signal and outputs a digital video signal;
a phase-locked-loop coupled to a horizontal sync signal, the phase-locked-loop providing a sampling clock frequency to the at least one channel; and
a timing generator circuit that receives the horizontal sync signal and the sampling clock frequency and outputs a synchronized horizontal sync signal consistent with the sampling clock frequency and the digital video signal,
wherein a phase between the sampling clock frequency and the horizontal sync signal is controlled by a phase value stored in a phase register and the timing generator circuit includes a phase adapter circuit that controls the sampling of the horizontal sync signal.

147. The digitizer according to claim 146, wherein the timing generator circuit further includes:
a first circuit to sample the horizontal sync signal with a phase-zero signal to form a local horizontal sync signal;
a second circuit to sample the local horizontal sync signal with an adapted signal from the phase adapter circuit; and
an output circuit coupled to generate the synchronized horizontal sync signal.

148. The digitizer according to claim 147, wherein the phase adapter circuit includes a logic circuit that samples the phase value stored in the phase register and determines if a sampling phase is in a first and fourth quadrant or a second and third quadrant with respect to the horizontal sync signal and setting the adapted signal to the same phase as the sampling clock signal or to the complementary phase as the sampling clock signal accordingly.

149. A graphics digitizer, comprising:
at least one channel, each of the at least one channel inputs an analog video signal and outputs a digital video signal;
a phase-locked-loop coupled to a horizontal sync signal, the phase-locked-loop providing a sampling clock frequency to the at least one channel; and
a timing generator circuit that receives the horizontal sync signal and the sampling clock frequency and outputs a synchronized horizontal sync signal consistent with the sampling clock frequency and the digital video signal,
wherein each of the at least one channel includes an analog-to-digital converter coupled to receive the analog video signal, the analog-to-digital converter comprising:
a sample and hold circuit that receives an analog input signal and outputs a differential input signal in response to a sampling clock signal;
a reference generator that receives a reference voltage and generates a set of differential reference signals;
a pre-amp bank that receives the differential input signal from the sample and hold circuit and the set of differential reference signals from the reference generator and outputs a set of differential output signals indicative of a comparison between the differential input signal and the set of differential reference signals;
a folding and interpolation circuit that receives the set of differential output signals and generates a set of differential folded signals;
a course pre-amp that receives selected ones of the set of differential output signals and outputs a set of differential course output signals;
a comparator bank that receives the set of differential folded signals and the set of differential course output signals and outputs a set of digitized fine signals and a set of digitized course signals; and
a digital encoder that receives the set of digitized fine signals and the set of digitized course signals and outputs a digital signal indicative of the analog input signal,
wherein the pre-amp bank includes an array of differential pre-amps, each differential pre-amp of the array of differential pre-amp being offset canceled and reset in response to an HSYNC signal indicating the end of a video line.

150. A graphics digitizer, comprising:
at least one channel, each of the at least one channel inputs an analog video signal and outputs a digital video signal;
a phase-locked-loop coupled to a horizontal sync signal, the phase-locked-loop providing a sampling clock frequency to the at least one channel; and
a timing generator circuit that receives the horizontal sync signal and the sampling clock frequency and outputs a synchronized horizontal sync signal consistent with the sampling clock frequency and the digital video signal,
wherein each of the at least one channel includes an analog-to-digital converter coupled to receive the analog video signal, the analog-to-digital converter comprising:
a sample and hold circuit that receives an analog input signal and outputs a differential input signal in response to a sampling clock signal;
a reference generator that receives a reference voltage and generates a set of differential reference signals;
a pre-amp bank that receives the differential input signal from the sample and hold circuit and the set of differential reference signals from the reference generator and outputs a set of differential output signals indicative of a comparison between the differential input signal and the set of differential reference signals;
a folding and interpolation circuit that receives the set of differential output signals and generates a set of differential folded signals;
a course pre-amp that receives selected ones of the set of differential output signals and outputs a set of differential course output signals;
a comparator bank that receives the set of differential folded signals and the set of differential course output signals and outputs a set of digitized fine signals and a set of digitized course signals; and
a digital encoder that receives the set of digitized fine signals and the set of digitized course signals and outputs a digital signal indicative of the analog input signal,
wherein the pre-amp bank includes an array of differential pre-amps, each differential pre-amp of the array of differential pre-amps being offset canceled and reset in response to a random number generated by a random number generator.

151. The digitizer according to claim 150, wherein each differential pre-amp of the array of differential pre-amps is a member of a set of pre-amp groups wherein corresponding members of each of the pre-amp groups are offset canceled and reset simultaneously.

152. The digitizer according to claim 150, wherein differential output signals from each of the array of differential pre-amps are input to a multiplexer circuit, the multiplexer circuit outputting the set of differential output signals having those differential output signals from those pre-amps in the array of differential pre-amps that are not being offset canceled and reset.

153. A graphics digitizer, comprising:
at least one channel, each of the at least one channel inputs an analog video signal and outputs a digital video signal;
a phase-locked-loop coupled to a horizontal sync signal, the phase-locked-loop providing a sampling clock frequency to the at least one channel; and
a timing generator circuit that receives the horizontal sync signal and the sampling clock frequency and outputs a synchronized horizontal sync signal consistent with the sampling clock frequency and the digital video signal,
wherein each of the at least one channel includes an analog-to-digital converter coupled to receive the analog video signal, the analog-to-digital converter comprising:
a sample and hold circuit that receives an analog input signal and outputs a differential input signal in response to a sampling clock signal;
a reference generator that receives a reference voltage and generates a set of differential reference signals;
a pre-amp bank that receives the differential input signal from the sample and hold circuit and the set of differential reference signals from the reference generator and outputs a set of differential output signals indicative of a comparison between the differential input signal and the set of differential reference signals;
a folding and interpolation circuit that receives the set of differential output signals and generates a set of differential folded signals;
a course pre-amp that receives selected ones of the set of differential output signals and outputs a set of differential course output signals;
a comparator bank that receives the set of differential folded signals and the set of differential course output signals and outputs a set of digitized fine signals and a set of digitized course signals; and
a digital encoder that receives the set of digitized fine signals and the set of digitized course signals and outputs a digital signal indicative of the analog input signal,
wherein the folding and interpolating circuit includes a first folding circuit coupled to a second folding circuit, the first folding circuit including active voltage averaging of the set of differential output signals and resistive interpolation.

154. The digitizer according to claim 153, wherein the first folding circuit includes a set of first folding sub-blocks, each sub-block of the set of first folding sub-blocks including at least one amplifier section having a number of differential amplifiers having coupled output terminals, each of the number of coupled differential amplifiers coupled to receive one of the differential output signals to provide active voltage averaging.

155. The digitizer according to claim 154, wherein each sub-block of the set of first folding sub-blocks includes three amplifier sections having three differential amplifiers each, each of the three amplifier sections receiving sequential ones of the differential output signals with differential output signals received by different ones of the three amplifier sections separated over the set of differential output signals.

156. The digitizer according to claim 154, wherein a number of resistive outputs coupled to the output terminals provides resistive interpolation.

157. The digitizer according to claim 156, wherein each sub-block provides four differential output signals.

158. The digitizer according to claim 154, wherein the first folding circuit includes 12 coupled sub-blocks.

159. The digitizer according to claim 153, wherein the second folding circuit includes a number of second folding sub-blocks coupled together, each sub-block of the number of second folding sub-blocks including a number of differential amplifiers having coupled output terminals, each of the number of differential amplifiers coupled to receive signals from the first folding circuit.

160. The digitizer according to claim 159, wherein each sub-block includes resistive outputs coupled to the output terminals that provide resistive interpolation.

161. The digitizer according to claim 160, wherein each sub-block includes three differential amplifier and provides two output signals to the set of differential folded signals.

162. The digitizer according to claim 160, wherein the second folding circuit includes sixteen second folding sub-blocks.

163. A graphics digitizer, comprising:
at least one channel, each of the at least one channel inputs an analog video signal and outputs a digital video signal;
a phase-locked-loop coupled to a horizontal sync signal, the phase-locked-loop providing a sampling clock frequency to the at least one channel; and
a timing generator circuit that receives the horizontal sync signal and the sampling clock frequency and outputs a synchronized horizontal sync signal consistent with the sampling clock frequency and the digital video signal,
wherein each of the at least one channel includes an analog-to-digital converter coupled to receive the analog video signal, the analog-to-digital converter comprising:
a sample and hold circuit that receives an analog input signal and outputs a differential input signal in response to a sampling clock signal;
a reference generator that receives a reference voltage and generates a set of differential reference signals;
a pre-amp bank that receives the differential input signal from the sample and hold circuit and the set of differential reference signals from the reference generator and outputs a set of differential output signals indicative of a comparison between the differential input signal and the set of differential reference signals;
a folding and interpolation circuit that receives the set of differential output signals and generates a set of differential folded signals;
a course pre-amp that receives selected ones of the set of differential output signals and outputs a set of differential course output signals;
a comparator bank that receives the set of differential folded signals and the set of differential course output signals and outputs a set of digitized fine signals and a set of digitized course signals; and
a digital encoder that receives the set of digitized fine signals and the set of digitized course signals and outputs a digital signal indicative of the analog input signal,
wherein the comparator bank includes
an array of fine comparators, each comparator of the array of fine comparators coupled to an RS latch, each comparator in the array of fine comparators receiving one of the set of differential folded signals and outputting a binary digit and a complementary binary digit indicating whether the one of the set of differential folded signals is positive or negative to the RS latch, and
an array of course comparators, each comparator of the array of course comparators coupled to an RS latch, the array of course comparators receiving one of the set of course differential signals and outputting a binary digit and a complementary binary digit indicating whether the one of the set of course differential signals is positive or negative,
wherein the set of digitized fine signals and the set of digitized course signals correspond to outputs of the RS latch coupled to each comparator of the array of fine comparators and the outputs of the RS latch coupled to each comparator of the array of course comparators, respectively.

164. A graphics digitizer, comprising:
at least one channel, each of the at least one channel inputs an analog video signal and outputs a digital video signal;
a phase-locked-loop coupled to a horizontal sync signal, the phase-locked-loop providing a sampling clock frequency to the at least one channel; and
a timing generator circuit that receives the horizontal sync signal and the sampling clock frequency and outputs a synchronized horizontal sync signal consistent with the sampling clock frequency and the digital video signal,
wherein each of the at least one channel includes an analog-to-digital converter coupled to receive the analog video signal, the analog-to-digital converter comprising:
a sample and hold circuit that receives an analog input signal and outputs a differential input signal in response to a sampling clock signal;
a reference generator that receives a reference voltage and generates a set of differential reference signals;
a pre-amp bank that receives the differential input signal from the sample and hold circuit and the set of differential reference signals from the reference generator and outputs a set of differential output signals indicative of a comparison between the differential input signal and the set of differential reference signals;
a folding and interpolation circuit that receives the set of differential output signals and generates a set of differential folded signals;
a course pre-amp that receives selected ones of the set of differential output signals and outputs a set of differential course output signals;
a comparator bank that receives the set of differential folded signals and the set of differential course output signals and outputs a set of digitized fine signals and a set of digitized course signals; and
a digital encoder that receives the set of digitized fine signals and the set of digitized course signals and outputs a digital signal indicative of the analog input signal,
wherein the digital encoder includes
a fine decoder that converts the set of digitized fine signals into the least significant bits of the digital signal by determining a number corresponding to the number of the set of digitized fine signals having a first logic level and setting the least significant bits equal to the number, and
a course decoder that converts the set of digitized course signals to the most significant bits of the digital signal by determining a course number indicating the number of the set of digitized course signals having a second logic level.

165. The digitizer of claim 164, wherein whether the first logic level is the same or opposite the second logic level is determined by a voting circuit, the voting circuit determining if a region corresponding to the analog input signal is in a rising or falling section.

166. The digitizer of claim 165, wherein the voting circuit inputs one digit from a first extreme of the set of digitized fine signals and two digits from a second extreme opposite the first extreme of the set of digitized fine signals and determines whether the region is a rising or falling section by ⅔ majority vote.

167. The digitizer of claim 164, wherein whether the first logic level is the same or opposite the second logic level is determined by the course number.

168. The digitizer of claim 164, wherein the digital decoder further includes an error correction circuit.

169. The digitizer of claim 168, wherein the error correction circuit inputs a determination of whether a region corresponding to the analog input signal is in a rising or falling section, the least significant bit of the course number, and the next to most significant bit of the fine number, determines if there is an agreement of whether the region is a rising or falling section, and adjusts the course number if there is no agreement.

170. The digitizer of claim 164, wherein the digital decoder further includes a range correction circuit.

171. The digitizer of claim 170, wherein the range correction circuit inputs a first signal of the set of digitized fine signals and a second signal of the set of digitized fine signals, the first signal and the second signal being chosen to be near end points of a range of allowed differential input signals, and the most significant bit of the digital signal, the range correction circuit sets the digital signal at a high extreme value if the first signal indicates a high value of the analog input signal and the most significant bit of the digital signal is not one and sets the digital signal at a low extreme value if the second signal indicates a low value of the analog input signal and the most significant bit of the digital signal is not 0.

172. A graphics digitizer, comprising:
at least one channel, each of the at least one channel inputs an analog video signal and outputs a digital video signal;
a phase-locked-loop coupled to a horizontal sync signal, the phase-locked-loop providing a sampling clock frequency to the at least one channel; and
a timing generator circuit that receives the horizontal sync signal and the sampling clock frequency and outputs a synchronized horizontal sync signal consistent with the sampling clock frequency and the digital video signal,
wherein each of the at least one channel includes an analog-to-digital converter coupled to receive the analog video signal, the analog-to-digital converter comprising:
a sample and hold circuit that receives an analog input signal and outputs a differential input signal in response to a sampling clock signal;
a reference generator that receives a reference voltage and generates a set of differential reference signals;
a pre-amp bank that receives the differential input signal from the sample and hold circuit and the set of differential reference signals from the reference generator and outputs a set of differential output signals indicative of a comparison between the differential input signal and the set of differential reference signals;
a folding and interpolation circuit that receives the set of differential output signals and generates a set of differential folded signals;
a course pre-amp that receives selected ones of the set of differential output signals and outputs a set of differential course output signals;
a comparator bank that receives the set of differential folded signals and the set of differential course output signals and outputs a set of digitized fine signals and a set of digitized course signals; and
a digital encoder that receives the set of digitized fine signals and the set of digitized course signals and outputs a digital signal indicative of the analog input signal,
wherein the set of differential reference signals includes 32 reference signals and the set of differential output signals includes 32 output signals.

173. The digitizer of claim 172, wherein the set of differential folded signals includes 32 differential folded signals.

174. The digitizer of claim 173, wherein the set of differential course output signals includes 7 differential course output signals.

175. The digitizer of claim 174, wherein the digitized signal includes 8 bits.

176. A digital display unit, comprising:
an array of pixels;
a digital pixel controller coupled to the array of pixels, the digital pixel controller capable of turning on pixels in the array of pixels in response to a set of digital video signals; and
a graphics digitizer coupled to the digital pixel controller, the graphics digitizer supplying the set of digital video signals in response to a set of analog video signals, the graphics digitizer including
at least one channel, each of the at least one channel inputs an analog video signal and outputs a digital video signal;
a phase-locked-loop coupled to a horizontal sync signal, the phase-locked-loop providing a sampling clock frequency to the at least one channel; and
a timing generator circuit that receives the horizontal sync signal and the sampling clock frequency and outputs a synchronized horizontal sync signal consistent with the sampling clock frequency and the digital video signal,
wherein the phase-locked-loop, comprises:
a phase detector coupled to receive a reference signal having a frequency and a comparison signal, the phase detector providing a phase detection signal in response to a comparison between the reference signal and the comparison signal;
a reference generator coupled to receive the phase detection signal from the phase detector, the reference generator providing an output signal having a frequency related to the phase detection signal; and
a programmable Div/N circuit coupled to receive the output signal, the programmable Div/N circuit generating the comparison signal in response to the output signal, the frequency of the comparison signal being related to the frequency of the output signal by a factor related to a value stored in a storage register.

177. The digital display unit according to claim 176, wherein the programmable Div/N circuit includes:
a counter coupled to the storage register so that a count value stored in the counter is initialized with the value when a zero signal indicates that the counter value is zero, the count value being decremented on each cycle of the output signal;
a decode circuit coupled to the counter to receive the count value, the decode circuit detecting when the count value is zero; and
a flip-flop coupled to the decode circuit so that the flip-flop outputs a logic high whenever the decode circuit detects that the count value is zero, the output signal from the flip-flop providing the comparison signal and the zero signal.

178. A digital display unit, comprising:
an array of pixels;
a digital pixel controller coupled to the array of pixels, the digital pixel controller capable of turning on pixels in the array of pixels in response to a set of digital video signals; and
a graphics digitizer coupled to the digital pixel controller, the graphics digitizer supplying the set of digital video signals in response to a set of analog video signals, the graphics digitizer including
at least one channel, each of the at least one channel inputs an analog video signal and outputs a digital video signal;
a phase-locked-loop coupled to a horizontal sync signal, the phase-locked-loop providing a sampling clock frequency to the at least one channel; and
a timing generator circuit that receives the horizontal sync signal and the sampling clock frequency and outputs a synchronized horizontal sync signal consistent with the sampling clock frequency and the digital video signal,
wherein each of the at least one channel includes a reference and bias voltage generator, the reference and bias voltage generator, comprising:
a digital-to-analog converter coupled to receive a reference value from a gain register and a band-gap voltage, the digital-to-analog converter outputting a scaled bandgap voltage relative to the band-gap voltage in response to the reference value;
a current digital-to-analog converter coupled to receive the scaled bandgap voltage from the digital-to-analog converter, the current digital-to-analog converter outputting a bias voltage signal relative to the voltage reference signal and an offset value from an offset register.

179. The digital display unit of claim 178, wherein the digital-to-analog converter includes an amplifier coupled to receive the band-gap voltage, a current circuit coupled to the amplifier to convert the band-gap voltage to a current signal, and an array of current mirrors coupled to mirror the current signal, each current mirror of the array of current mirrors coupled to a multiplexer which routs the current signal to a resistor ladder or to a ground voltage based on individual bits of the reference value stored in the gain register, the resistor ladder supplying the scaled bandgap voltage.

180. The digital display unit of claim 179, wherein the scaled bandgap voltage supplies a voltage reference signal.

181. The digital display unit of claim 178, wherein the current digital-to-analog converter includes an amplifier coupled to receive the scaled bandgap voltage from the digital-to-analog converter, a current circuit coupled to the amplifier to convert the band-gap voltage to a current signal, and an array of current mirrors coupled to mirror the current signal, each current mirror of the array of current mirrors coupled to a multiplexer which routs the current signal to a resistor ladder or to a ground voltage based on individual bits of the offset value stored in the offset register.

182. The digital display unit of claim 181, wherein the current digital-to-analog converter includes a separate current mirror to produce the voltage reference signal within the current digital-to-analog converter.

183. A digital display unit, comprising:
an array of pixels;
a digital pixel controller coupled to the array of pixels, the digital pixel controller capable of turning on pixels in the array of pixels in response to a set of digital video signals; and
a graphics digitizer coupled to the digital pixel controller, the graphics digitizer supplying the set of digital video signals in response to a set of analog video signals, the graphics digitizer including
at least one channel, each of the at least one channel inputs an analog video signal and outputs a digital video signal;
a phase-locked-loop coupled to a horizontal sync signal, the phase-locked-loop providing a sampling clock frequency to the at least one channel; and
a timing generator circuit that receives the horizontal sync signal and the sampling clock frequency and outputs a synchronized horizontal sync signal consistent with the sampling clock frequency and the digital video signal,
wherein a phase between the sampling clock frequency and the horizontal sync signal is controlled by a phase value stored in a phase register and the timing generator circuit includes a phase adapter circuit that controls the sampling of the horizontal sync signal.

184. The digital display unit according to claim 183, wherein the timing generator circuit further includes:
a first circuit to sample the horizontal sync signal with a phase-zero signal to form a local horizontal sync signal;
a second circuit to sample the local horizontal sync signal with an adapted signal from the phase adapter circuit; and
an output circuit coupled to generate the synchronized horizontal sync signal.

185. The digital display unit according to claim 184, wherein the phase adapter circuit includes a logic circuit that samples the phase value stored in the phase register and determines if a sampling phase is in a first and fourth quadrant or a second and third quadrant with respect to the horizontal sync signal and setting the adapted signal to the same phase as the sampling clock signal or to the complementary phase as the sampling clock signal accordingly.

186. A digital display unit, comprising:
an array of pixels;
a digital pixel controller coupled to the array of pixels, the digital pixel controller capable of turning on pixels in the array of pixels in response to a set of digital video signals; and
a graphics digitizer coupled to the digital pixel controller, the graphics digitizer supplying the set of digital video signals in response to a set of analog video signals, the graphics digitizer including
at least one channel, each of the at least one channel inputs an analog video signal and outputs a digital video signal;
a phase-locked-loop coupled to a horizontal sync signal, the phase-locked-loop providing a sampling clock frequency to the at least one channel; and
a timing generator circuit that receives the horizontal sync signal and the sampling clock frequency and outputs a synchronized horizontal sync signal consistent with the sampling clock frequency and the digital video signal,
wherein each of the at least one channel includes an analog-to-digital converter coupled to receive the analog video signal, the analog-to-digital converter comprising:
a sample and hold circuit that receives an analog input signal and outputs a differential input signal in response to a sampling clock signal;
a reference generator that receives a reference voltage and generates a set of differential reference signals;
a pre-amp bank that receives the differential input signal from the sample and hold circuit and the set of differential reference signals from the reference generator and outputs a set of differential output signals indicative of a comparison between the differential input signal and the set of differential reference signals;
a folding and interpolation circuit that receives the set of differential output signals and generates a set of differential folded signals;
a course pre-amp that receives selected ones of the set of differential output signals and outputs a set of differential course output signals;
a comparator bank that receives the set of differential folded signals and the set of differential course output signals and outputs a set of digitized fine signals and a set of digitized course signals; and
a digital encoder that receives the set of digitized fine signals and the set of digitized course signals and outputs a digital signal indicative of the analog input signal,
wherein the pre-amp bank includes an array of differential pre-amps, each differential pre-amp of the array of differential pre-amp being offset canceled and reset in response to an HSYNC signal indicating the end of a video line.

187. A digital display unit, comprising:
an array of pixels;
a digital pixel controller coupled to the array of pixels, the digital pixel controller capable of turning on pixels in the array of pixels in response to a set of digital video signals; and
a graphics digitizer coupled to the digital pixel controller, the graphics digitizer supplying the set of digital video signals in response to a set of analog video signals, the graphics digitizer including
at least one channel, each of the at least one channel inputs an analog video signal and outputs a digital video signal;
a phase-locked-loop coupled to a horizontal sync signal, the phase-locked-loop providing a sampling clock frequency to the at least one channel; and
a timing generator circuit that receives the horizontal sync signal and the sampling clock frequency and outputs a synchronized horizontal sync signal consistent with the sampling clock frequency and the digital video signal,
wherein each of the at least one channel includes an analog-to-digital converter coupled to receive the analog video signal, the analog-to-digital converter comprising:
a sample and hold circuit that receives an analog input signal and outputs a differential input signal in response to a sampling clock signal;
a reference generator that receives a reference voltage and generates a set of differential reference signals;
a pre-amp bank that receives the differential input signal from the sample and hold circuit and the set of differential reference signals from the reference generator and outputs a set of differential output signals indicative of a comparison between the differential input signal and the set of differential reference signals;
a folding and interpolation circuit that receives the set of differential output signals and generates a set of differential folded signals;
a course pre-amp that receives selected ones of the set of differential output signals and outputs a set of differential course output signals;
a comparator bank that receives the set of differential folded signals and the set of differential course output signals and outputs a set of digitized fine signals and a set of digitized course signals; and
a digital encoder that receives the set of digitized fine signals and the set of digitized course signals and outputs a digital signal indicative of the analog input signal,
wherein the pre-amp bank includes an array of differential pre-amps, each differential pre-amp of the array of differential pre-amps being offset canceled and reset in response to a random number generated by a random number generator.

188. The digital display unit according to claim 187, wherein each differential pre-amp of the array of differential pre-amps is a member of a set of pre-amp groups wherein corresponding members of each of the pre-amp groups are offset canceled and reset simultaneously.

189. The digital display unit according to claim 187, wherein differential output signals from each of the array of differential pre-amps are input to a multiplexer circuit, the multiplexer circuit outputting the set of differential output signals having those differential output signals from those pre-amps in the array of differential pre-amps that are not being offset canceled and reset.

190. A digital display unit, comprising:
an array of pixels;
a digital pixel controller coupled to the array of pixels, the digital pixel controller capable of turning on pixels in the array of pixels in response to a set of digital video signals; and
a graphics digitizer coupled to the digital pixel controller, the graphics digitizer supplying the set of digital video signals in response to a set of analog video signals, the graphics digitizer including
at least one channel, each of the at least one channel inputs an analog video signal and outputs a digital video signal;
a phase-locked-loop coupled to a horizontal sync signal, the phase-locked-loop providing a sampling clock frequency to the at least one channel; and
a timing generator circuit that receives the horizontal sync signal and the sampling clock frequency and outputs a synchronized horizontal sync signal consistent with the sampling clock frequency and the digital video signal,
wherein each of the at least one channel includes an analog-to-digital converter coupled to receive the analog video signal, the analog-to-digital converter comprising:
a sample and hold circuit that receives an analog input signal and outputs a differential input signal in response to a sampling clock signal;
a reference generator that receives a reference voltage and generates a set of differential reference signals;
a pre-amp bank that receives the differential input signal from the sample and hold circuit and the set of differential reference signals from the reference generator and outputs a set of differential output signals indicative of a comparison between the differential input signal and the set of differential reference signals;
a folding and interpolation circuit that receives the set of differential output signals and generates a set of differential folded signals;
a course pre-amp that receives selected ones of the set of differential output signals and outputs a set of differential course output signals;
a comparator bank that receives the set of differential folded signals and the set of differential course output signals and outputs a set of digitized fine signals and a set of digitized course signals; and
a digital encoder that receives the set of digitized fine signals and the set of digitized course signals and outputs a digital signal indicative of the analog input signal,
wherein the folding and interpolating circuit includes a first folding circuit coupled to a second folding circuit, the first folding circuit including active voltage averaging of the set of differential output signals and resistive interpolation.

191. The digital display unit according to claim 190, wherein the first folding circuit includes a set of first folding sub-blocks, each sub-block of the set of first folding sub-blocks including at least one amplifier section having a number of differential amplifiers having coupled output terminals, each of the number of coupled differential amplifiers coupled to receive one of the differential output signals to provide active voltage averaging.

192. The digital display unit according to claim 191, wherein each sub-block of the set of first folding sub-blocks includes three amplifier sections having three differential amplifiers each, each of the three amplifier sections receiving sequential ones of the differential output signals with differential output signals received by different ones of the three amplifier sections separated over the set of differential output signals.

193. The digital display unit according to claim 191, wherein a number of resistive outputs coupled to the output terminals provides resistive interpolation.

194. The digital display unit according to claim 193, wherein each sub-block provides four differential output signals.

195. The digital display unit according to claim 191, wherein the first folding circuit includes 12 coupled sub-blocks.

196. The digital display unit according to claim 190, wherein the second folding circuit includes a number of second folding sub-blocks coupled together, each sub-block of the number of second folding sub-blocks including a number of differential amplifiers having coupled output terminals, each of the number of differential amplifiers coupled to receive signals from the first folding circuit.

197. The digital display unit according to claim 196, wherein each sub-block includes resistive outputs coupled to the output terminals that provide resistive interpolation.

198. The digital display unit according to claim 197, wherein each sub-block includes three differential amplifier and provides two output signals to the set of differential folded signals.

199. The digital display unit according to claim 197, wherein the second folding circuit includes sixteen second folding sub-blocks.

200. A digital display unit, comprising:
an array of pixels;
a digital pixel controller coupled to the array of pixels, the digital pixel controller capable of turning on pixels in the array of pixels in response to a set of digital video signals; and
a graphics digitizer coupled to the digital pixel controller, the graphics digitizer supplying the set of digital video signals in response to a set of analog video signals, the graphics digitizer including
at least one channel, each of the at least one channel inputs an analog video signal and outputs a digital video signal;
a phase-locked-loop coupled to a horizontal sync signal, the phase-locked-loop providing a sampling clock frequency to the at least one channel; and
a timing generator circuit that receives the horizontal sync signal and the sampling clock frequency and outputs a synchronized horizontal sync signal consistent with the sampling clock frequency and the digital video signal,
wherein each of the at least one channel includes an analog-to-digital converter coupled to receive the analog video signal, the analog-to-digital converter comprising:
a sample and hold circuit that receives an analog input signal and outputs a differential input signal in response to a sampling clock signal;
a reference generator that receives a reference voltage and generates a set of differential reference signals;
a pre-amp bank that receives the differential input signal from the sample and hold circuit and the set of differential reference signals from the reference generator and outputs a set of differential output signals indicative of a comparison between the differential input signal and the set of differential reference signals;
a folding and interpolation circuit that receives the set of differential output signals and generates a set of differential folded signals;
a course pre-amp that receives selected ones of the set of differential output signals and outputs a set of differential course output signals;
a comparator bank that receives the set of differential folded signals and the set of differential course output signals and outputs a set of digitized fine signals and a set of digitized course signals; and
a digital encoder that receives the set of digitized fine signals and the set of digitized course signals and outputs a digital signal indicative of the analog input signal,
wherein the comparator bank includes
an array of fine comparators, each comparator of the array of fine comparators coupled to an RS latch, each comparator in the array of fine comparators receiving one of the set of differential folded signals and outputting a binary digit and a complementary binary digit indicating whether the one of the set of differential folded signals is positive or negative to the RS latch, and
an array of course comparators, each comparator of the array of course comparators coupled to an RS latch, the array of course comparators receiving one of the set of course differential signals and outputting a binary digit and a complementary binary digit indicating whether the one of the set of course differential signals is positive or negative,
wherein the set of digitized fine signals and the set of digitized course signals correspond to outputs of the RS latch coupled to each comparator of the array of fine comparators and the outputs of the RS latch coupled to each comparator of the array of course comparators, respectively.

201. A digital display unit, comprising:
an array of pixels;
a digital pixel controller coupled to the array of pixels, the digital pixel controller capable of turning on pixels in the array of pixels in response to a set of digital video signals; and
a graphics digitizer coupled to the digital pixel controller, the graphics digitizer supplying the set of digital video signals in response to a set of analog video signals, the graphics digitizer including
at least one channel, each of the at least one channel inputs an analog video signal and outputs a digital video signal;
a phase-locked-loop coupled to a horizontal sync signal, the phase-locked-loop providing a sampling clock frequency to the at least one channel; and
a timing generator circuit that receives the horizontal sync signal and the sampling clock frequency and outputs a synchronized horizontal sync signal consistent with the sampling clock frequency and the digital video signal,
wherein each of the at least one channel includes an analog-to-digital converter coupled to receive the analog video signal, the analog-to-digital converter comprising:
a sample and hold circuit that receives an analog input signal and outputs a differential input signal in response to a sampling clock signal;
a reference generator that receives a reference voltage and generates a set of differential reference signals;
a pre-amp bank that receives the differential input signal from the sample and hold circuit and the set of differential reference signals from the reference generator and outputs a set of differential output signals indicative of a comparison between the differential input signal and the set of differential reference signals;
a folding and interpolation circuit that receives the set of differential output signals and generates a set of differential folded signals;
a course pre-amp that receives selected ones of the set of differential output signals and outputs a set of differential course output signals;
a comparator bank that receives the set of differential folded signals and the set of differential course output signals and outputs a set of digitized fine signals and a set of digitized course signals; and
a digital encoder that receives the set of digitized fine signals and the set of digitized course signals and outputs a digital signal indicative of the analog input signal,
wherein the digital encoder includes
a fine decoder that converts the set of digitized fine signals into the least significant bits of the digital signal by determining a number corresponding to the number of the set of digitized fine signals having a first logic level and setting the least significant bits equal to the number, and
a course decoder that converts the set of digitized course signals to the most significant bits of the digital signal by determining a course number indicating the number of the set of digitized course signals having a second logic level.

202. The digital display unit of claim 201, wherein whether the first logic level is the same or opposite the second logic level is determined by a voting circuit, the voting circuit determining if a region corresponding to the analog input signal is in a rising or falling section.

203. The digital display unit of claim 202, wherein the voting circuit inputs one digit from a first extreme of the set of digitized fine signals and two digits from a second extreme opposite the first extreme of the set of digitized fine signals and determines whether the region is a rising or falling section by ⅔ majority vote.

204. The digital display unit of claim 201, wherein whether the first logic level is the same or opposite the second logic level is determined by the course number.

205. The digital display unit of claim 201, wherein the digital decoder further includes an error correction circuit.

206. The digital display unit of claim 205, wherein the error correction circuit inputs a determination of whether a region corresponding to the analog input signal is in a rising or falling section, the least significant bit of the course number, and the next to most significant bit of the fine number, determines if there is an agreement of whether the region is a rising or falling section, and adjusts the course number if there is no agreement.

207. The digital display unit of claim 201, wherein the digital decoder further includes a range correction circuit.

208. The digital display unit of claim 207, wherein the range correction circuit inputs a first signal of the set of digitized fine signals and a second signal of the set of digitized fine signals, the first signal and the second signal being chosen to be near end points of a range of allowed differential input signals, and the most significant bit of the digital signal, the range correction circuit sets the digital signal at a high extreme value if the first signal indicates a high value of the analog input signal and the most significant bit of the digital signal is not one and sets the digital signal at a low extreme value if the second signal indicates a low value of the analog input signal and the most significant bit of the digital signal is not 0.

209. A digital display unit, comprising:
an array of pixels;
a digital pixel controller coupled to the array of pixels, the digital pixel controller capable of turning on pixels in the array of pixels in response to a set of digital video signals; and
a graphics digitizer coupled to the digital pixel controller, the graphics digitizer supplying the set of digital video signals in response to a set of analog video signals, the graphics digitizer including
at least one channel, each of the at least one channel inputs an analog video signal and outputs a digital video signal;
a phase-locked-loop coupled to a horizontal sync signal, the phase-locked-loop providing a sampling clock frequency to the at least one channel; and
a timing generator circuit that receives the horizontal sync signal and the sampling clock frequency and outputs a synchronized horizontal sync signal consistent with the sampling clock frequency and the digital video signal,
wherein each of the at least one channel includes an analog-to-digital converter coupled to receive the analog video signal, the analog-to-digital converter comprising:
a sample and hold circuit that receives an analog input signal and outputs a differential input signal in response to a sampling clock signal;
a reference generator that receives a reference voltage and generates a set of differential reference signals;
a pre-amp bank that receives the differential input signal from the sample and hold circuit and the set of differential reference signals from the reference generator and outputs a set of differential output signals indicative of a comparison between the differential input signal and the set of differential reference signals;
a folding and interpolation circuit that receives the set of differential output signals and generates a set of differential folded signals;
a course pre-amp that receives selected ones of the set of differential output signals and outputs a set of differential course output signals;
a comparator bank that receives the set of differential folded signals and the set of differential course output signals and outputs a set of digitized fine signals and a set of digitized course signals; and
a digital encoder that receives the set of digitized fine signals and the set of digitized course signals and outputs a digital signal indicative of the analog input signal,
wherein the set of differential reference signals includes 32 reference signals and the set of differential output signals includes 32 output signals.

210. The digital display unit of claim 209, wherein the set of differential folded signals includes 32 differential folded signals.

211. The digital display unit of claim 210, wherein the set of differential course output signals includes 7 differential course output signals.

212. The digital display unit of claim 211, wherein the digitized signal includes 8 bits.

213. A method of generating a programmable sampling clock frequency, comprising:
receiving a reference signal;
comparing the phase of the reference signal with a comparison signal and generating a control signal;
generating the programmable sampling clock frequency in response to the control signal;
generating the comparison signal in a programmable Div/N circuit, the frequency of the comparison signal being the programmable sampling clock frequency divided by a programmable number.

214. A method of generating a synchronized horizontal sync signal in a graphics digitizer, comprising:
sampling a horizontal sync signal with a phase-0 signal to form a local horizontal sync signal;
determining whether a programmable phase is within half a sampling clock cycle from the phase-0 signal;
sampling the local horizontal sync signal with sampling clock signal or with the complement of the sampling clock signal depending on whether the programmable phase is within half a sampling clock cycle from the phase-0 signal.

215. A method of generating a reference signal and a bias signal for an analog-to-digital converter, comprising:
generating a reference voltage proportional to a bandgap voltage in response to a reference value stored in a reference register;
generating a bias voltage proportional to the reverence value in response to an offset value stored in an offset register.

216. A method of offset canceling and resetting differential amplifiers in a pre-amp bank of an analog-to-digital converter, comprising coupling inputs of each differential amplifier of the pre-amp bank to a respective one of a set of reference voltage at the end of each video line.

217. A method of offset canceling and resetting differential amplifiers in a pre-amp bank of an analog-to-digital converter, comprising
selecting a set of differential amplifiers to be offset canceled and reset during a clock cycle; and
coupling inputs of the set differential amplifiers of the pre-amp bank to respective ones of a set of reference voltage.

218. A method of folding and interpolating a set of differential signals in an analog-to-digital converter, comprising:
actively averaging selected ones of a set of differential signals at the inputs of a first folding circuit and resistively interpolating to provide folded output signals; and
resistively interpolating in a second folding circuit that receives the folded output signals of the first folding circuit to provide a set of folded output signals.
